(19) United States
(12) Patent Application Publication
(10) Pub. No.: US 2019/0370915 A1
(43) Pub. Date: Dec. 5, 2019

(54) FARM AND MOBILE MANUFACTURING

(71) Applicant: Zume, Inc., Mountain View, CA (US)

(72) Inventors: Alexander John Garden, Tiburon, CA (US); Joshua Gouled Goldberg, San Bruno, CA (US); Vaibhav Goel, Santa Clara, CA (US)

(21) Appl. No.: 16/431,005

(22) Filed: Jun. 4, 2019

Related U.S. Application Data
(60) Provisional application No. 62/680,427, filed on Jun. 4, 2018.
(60) Provisional application No. 62/701,385, filed on Jul. 20, 2018.
(60) Provisional application No. 62/701,094, filed on Jul. 20, 2018.
(60) Provisional application No. 62/701,190, filed on Jul. 20, 2018.
(60) Provisional application No. 62/701,192, filed on Jul. 20, 2018.
(60) Provisional application No. 62/701,186, filed on Jul. 20, 2018.
(60) Provisional application No. 62/701,312, filed on Jul. 20, 2018.
(60) Provisional application No. 62/701,303, filed on Jul. 20, 2018.
(60) Provisional application No. 62/701,319, filed on Jul. 20, 2018.
(60) Provisional application No. 62/701,378, filed on Jul. 20, 2018.
(60) Provisional application No. 62/701,188, filed on Jul. 20, 2018.
(60) Provisional application No. 62/701,220, filed on Jul. 20, 2018.
(60) Provisional application No. 62/701,327, filed on Jul. 20, 2018.
(60) Provisional application No. 62/701,326, filed on Jul. 20, 2018.

(51) Int. Cl. G06Q 50/12; G06N 20/00; G06N 5/04; G06Q 10/06; G06Q 10/10

(52) U.S. Cl. CPC G06Q 50/12; G06N 20/00; G06Q 10/1097; G06Q 10/06315; G06N 5/04

(57) ABSTRACT

The present technology relates to systems and methods for utilizing machine learning systems to improve farming and manufacturing in the food industry. For example, a method of the technology includes receiving, by the computational system, historical order information representative of a plurality of instances of historical orders for one or more prepared food items. The method also includes training a machine learning system based at least in part on the received historical order information. In addition, the method includes, for prepared food items, predicting, via the trained machine learning system of the computational system, an amount of future supply need of one or more ingredients for the prepared food items for a defined period of time in the future.

### RELATED APPLICATIONS

This application claims the benefit of the following United States Provisional Patent Applications:
U.S. Provisional Application No. 62/680,427, filed Jun. 4, 2018, entitled “SHORT SUPPLY CHAIN PROVISIONING VIA IMPLEMENTATION OF MACHINE LEARNING SYSTEMS”;
U.S. Provisional Application No. 62/701,385, filed Jul. 20, 2018, entitled “SHORT SUPPLY CHAIN PROVISIONING BASED ON PREDICTION”;
U.S. Provisional Application No. 62/701,094, filed Jul. 20, 2018, entitled “PREDICTING SUPPLY NEED FOR INGREDIENTS BASED ON HISTORICAL CUSTOMER ORDERS”;
U.S. Provisional Application No. 62/701,190, filed Jul. 20, 2018, entitled “PREDICTING SUPPLY NEED FOR INGREDIENTS BASED ON MARKETING ACTIVITIES AND LOCAL EVENTS”;
U.S. Provisional Application No. 62/701,192, filed Jul. 20, 2018, entitled “PREDICTING SUPPLY NEED FOR INGREDIENTS BASED ON ECONOMIC INDICATORS”;
U.S. Provisional Application No. 62/701,186, filed Jul. 20, 2018, entitled “PREDICTING DEMAND FOR INGREDIENTS USING MACHINE LEARNING”;
U.S. Provisional Application No. 62/701,312, filed Jul. 20, 2018, entitled “SCHEDULING INGREDIENT PRODUCTION BASED ON PREDICTED SUPPLY NEED FOR INGREDIENTS”;
U.S. Provisional Application No. 62/701,303, filed Jul. 20, 2018, entitled “DETERMINING QUANTITY AND TIMING OF SEED/STARTS ORDERING BASED ON PREDICTED SUPPLY NEED FOR INGREDIENTS”;
U.S. Provisional Application No. 62/701,319, filed Jul. 20, 2018, entitled “DETERMINING LENGTH OF PLANTING/GROWING TIME”;
U.S. Provisional Application No. 62/701,326, filed Jul. 20, 2018, entitled “HARVESTING BASED ON PREDICTED SUPPLY NEED FOR INGREDIENTS”;
U.S. Provisional Application No. 62/701,378, filed Jul. 20, 2018, entitled “INGREDIENT PRODUCTION AND DELIVERY BASED ON DIFFERENT LONG AND SHORT NOTICE PREDICTIONS OF SUPPLY NEED FOR INGREDIENTS”;
U.S. Provisional Application No. 62/701,188, filed Jul. 20, 2018, entitled “DELIVERY SCHEDULING BASED ON SHORT NOTICE PREDICTIONS OF SUPPLY NEED FOR INGREDIENTS”;
U.S. Provisional Application No. 62/701,220, filed Jul. 20, 2018, entitled “AUTONOMOUS DELIVERY OF FOOD ITEMS BASED ON PREDICTIONS OF SUPPLY NEED FOR INGREDIENTS”; and
U.S. Provisional Application No. 62/701,327, filed Jul. 20, 2018, entitled “DELIVERY SCHEDULING BASED ON PROCESSING INGREDIENTS IN-TRANSIT”.
   The disclosures of each of the foregoing applications are incorporated by reference herein in their entireties, and to the extent appropriate, priority is claimed to each of the above applications.

### INTRODUCTION

This description generally relates to the use of computational systems comprising one or more machine learnings generate information related to the future supply need of prepared food items and ingredients thereof.

### Farm and Mobile Manufacturing

In an aspect, the technology relates to a method of operation of a computational system that implements at least one machine learning system to facilitate logistics. The method includes receiving, by the computational system, historical order information representative of a plurality of instances of historical orders for one or more prepared food items either placed or fulfilled during a defined period of time in the past associated with a past particular marketing activity or event for at least a first service area. The method also includes training the at least one machine learning system based at least in part on the received historical order information representative of the plurality of instances of historical orders for the one or more prepared food items either placed or fulfilled during the defined period of time in the past associated with the particular marketing activity or event for at least the first service area. The method also includes or one or more of the one or more prepared food items, predicting, via the trained at least one machine learning system of the computational system, an amount of future supply need of one or more ingredients for the one or more prepared food items for a defined period of time in the future associated with a future particular marketing activity or event related to the past particular marketing activity or event for at least the first service area based on the historical order information.

In an aspect, the technology relates to a computational system that implements at least one machine learning system to facilitate logistics, the system comprising one or more processors and memory storing a set of instructions that, as a result of execution by the one or more processors, cause the system to perform a set of operations. The operations include receive historical order information representative of a plurality of instances of historical orders for one or more prepared food items either placed or fulfilled during a defined period of time in the past associated with a past particular marketing activity or event for at least a first service area. The operations also include train the at least one machine learning system based at least in part on the received historical order information representative of the plurality of instances of historical orders for the one or more prepared food items either placed or fulfilled during the defined period of time in the past associated with the particular marketing activity or event for at least the first service area. The operations also include for one or more of the one or more prepared food items, predict, via the trained at least one machine learning system of the computational system, an amount of future supply need of one or more ingredients for the one or more prepared food items for a defined period of time in the future associated with a future particular marketing activity or event related to the past particular marketing activity or event for at least the first service area based on the historical order information.

In an aspect, the technology relates to a method of operation of a computational system that implements at least one machine learning system to facilitate logistics. The method includes receiving, by the computational system, historical information related to use of one or more ingredients used in preparation of one or more prepared food items for a defined period of time in the past for at least a first service area. The method also includes training the at least one machine learning system based at least in part on the received historical information related to use of one or more ingredients used in preparation of the one or more prepared food items during the defined period of time in the past and data representing one or more economic indicators regarding the defined period of time in the past for at least the first service area. The method also includes for one or more of the one or more prepared food items, predicting, via the trained at least one machine learning system of the computational system, an amount of future supply need of one or more ingredients for the one or more prepared food items for a defined period of time in the future based on an updated economic indicator related to at least one of the one or more one or more economic indicators correlated to the received historical information related to use of the one or more ingredients for at least the first service area.

In an aspect, the technology relates to a method of operation of a computational system that implements at least one machine learning system to facilitate logistics. The method includes receiving, by the computational system, information indicative of an amount of time that production takes, from planting to delivery, of one or more ingredients for one or more prepared food items for at least a first service area. The method also includes or one or more of the one or more prepared food items, predicting, via the at least one machine learning system of the computational system, an amount of future supply need of the one or more ingredients for the one or more prepared food items for a defined period of time in the future for at least the first service area based on historical information related to use of one or more ingredients. The method also includes scheduling, by the computational system, the production, from planting to delivery, of the one or more ingredients for the one or more prepared food items based on the information indicative of the amount of time that production takes, from planting to delivery, of one or more ingredients for the one or more prepared food items and the amount of future supply need of the one or more ingredients for the one or more prepared food items for the defined period of time in the future.

In an aspect, the technology relates to a computational system that implements at least one machine learning system to facilitate logistics, the system comprising: one or more processors; and memory storing a set of instructions that, as a result of execution by the one or more processors, cause the system to perform a set of operations. The operations include receive historical information related to use of one or more ingredients used in preparation of one or more prepared food items for a defined period of time in the past for at least a first service area. The operations also include train the at least one machine learning system based at least in part on the received historical information related to use of one or more ingredients used in preparation of the one or more prepared food items during the defined period of time in the past and data regarding one or more factors attributed to affecting, predicting or being related to demand for the one or more ingredients used in preparation of one or more prepared food items for the defined period of time in the past for at least the first service area. The operations also include for one or more of the one or more prepared food items, predict, via the trained at least one machine learning system of the computational system, an amount of future supply need of one or more ingredients for the one or more prepared food items for a defined period of time in the future based on updated data regarding the one or more factors attributed to affecting, predicting or being related to demand for the one or more ingredients used in preparation of one or more prepared food items, the one or more factors attributed to affecting, predicting or being related to demand correlated to the received historical information related to use of the one or more ingredients for at least the first service area.

In an aspect, the technology relates to a method of operation of a computational system that facilitates logistics. The method includes receiving, by the computational system, information representative of historical delivery data for food items previously delivered in at least a first service area. The method also includes generating, by the computational system, a delivery schedule for food items to be delivered in one or more of the first service area and a second service area based on the information representative of historical delivery data for food items previously delivered in at least the first service area.

In an aspect, the technology relates to a method of operation of a computational system that implements at least one machine learning system to facilitate logistics. The method includes receiving, by the computational system, historical order information representative of a plurality of instances of historical orders for one or more prepared food items for at least a first service area. The method also includes training the at least one machine learning system based at least in part on the received historical order information representative of the plurality of instances of historical orders for the one or more prepared food items for at least the first service area. The method also includes for one or more of the one or more prepared food items, predicting, via the trained at least one machine learning system of the computational system, a predicted number of instances of future orders for respective ones of the one or more prepared food items predicted to be received during a defined period of time in the future for at least the first service area.

In an aspect, the technology relates to a method of operation of a computational system that implements at least one machine learning system to facilitate logistics. The method includes receiving, by the computational system, historical information related to use of one or more ingredients used in preparation of one or more prepared food items for a defined period of time in the past for at least a first service area. The method also includes training the at least one machine learning system based at least in part on the received historical information related to use of one or more ingredients used in preparation of the one or more prepared food items during the defined period of time in the past and data regarding one or more factors attributed to affecting, predicting or being related to demand for the one or more ingredients used in preparation of one or more prepared food items for the defined period of time in the past for at least the first service area. The method also includes for one or more of the one or more prepared food items, predicting, via the trained at least one machine learning system of the computational system, an amount of future supply need of one or more ingredients for the one or more prepared food items for a defined period of time in the future based on updated data regarding the one or more factors attributed to affecting, predicting or being related to demand for the one or more ingredients used in preparation of one or more prepared food items, the one or more factors attributed to affecting, predicting or being related to demand correlated to the received historical information related to use of the one or more ingredients for at least the first service area.

In an aspect, the technology relates to a method of operation of a computational system that facilitates logistics. The method includes receiving, by the computational system, information representative of historical delivery data for food items previously delivered in at least a first service area. The method also includes generating, by the computational system, a delivery schedule for food items to be delivered in one or more of the first service area and a second service area based on the information representative of historical delivery data for food items previously delivered in at least the first service area.

In an aspect, the technology relates to a method of operation of a computational system that implements at least one machine learning system to facilitate logistics. The method includes receiving, by the computational system, historical order information representative of a plurality of instances of historical orders for one or more prepared food items for at least a first service area. The method also includes training the at least one machine learning system based at least in part on the received historical order information representative of the plurality of instances of historical orders for the one or more prepared food items for at least the first service area. The method also includes for one or more of the one or more prepared food items, predicting, via the trained at least one machine learning system of the computational system, a predicted number of instances of future orders for respective ones of the one or more prepared food items predicted to be received during a defined period of time in the future for at least the first service area.

In an aspect, the technology relates to a method of operation of a computational system that implements at least one machine learning system to facilitate logistics. The method includes receiving, by the computational system, historical information related to use of one or more ingredients used in preparation of one or more prepared food items for a defined period of time in the past for at least a first service area. The method also includes training the at least one machine learning system based at least in part on the received historical information related to use of one or more ingredients used in preparation of the one or more prepared food items during the defined period of time in the past and data regarding one or more factors attributed to affecting, predicting or being related to demand for the one or more ingredients used in preparation of one or more prepared food items for the defined period of time in the past for at least the first service area. The method also includes for one or more of the one or more prepared food items, predicting, via the trained at least one machine learning system of the computational system, an amount of future supply need of one or more ingredients for the one or more prepared food items for a defined period of time in the future based on updated data regarding the one or more factors attributed to affecting, predicting or being related to demand for the one or more ingredients used in preparation of one or more prepared food items, the one or more factors attributed to affecting, predicting or being related to demand correlated to the received historical information related to use of the one or more ingredients for at least the first service area.

In an aspect, the technology relates to a method of operation of a computational system that implements at least one machine learning system to facilitate logistics. The method includes receiving, by the computational system, information indicative of an amount of time that production takes, from planting to delivery, of one or more ingredients for one or more prepared food items for at least a first service area. The method also includes for one or more of the one or more prepared food items, predicting, via the at least one machine learning system of the computational system, an amount of future supply need of the one or more ingredients for the one or more prepared food items for a defined period of time in the future for at least the first service area based on historical information related to use of one or more ingredients. The method also includes determining, by the computational system, an amount of one or more of plant starts and seed to order to meet the predicted amount of future supply need of the one or more ingredients for the one or more prepared food items for the defined period of time in the future. The method also includes determining, by the computational system, scheduling of one or more of ordering and delivering of one or more of plant starts and seed for the one or more ingredients based on the information indicative of the amount of time that production takes, from planting to delivery, of the one or more ingredients for the one or more prepared food items to meet the predicted amount of future supply need of the one or more ingredients for the one or more prepared food items for the defined period of time in the future.

In an aspect, the technology relates to a method of operation of a computational system that implements at least one machine learning system to facilitate logistics. The method also includes determining, by the computational system, an amount of time that planting and growing takes of one or more ingredients for one or more prepared food items for at least a first service area. The method also includes determining, by the computational system, when to plant one or more of plant starts and seed for the one or more ingredients to meet a predicted amount of future supply need of the one or more ingredients for the one or more prepared food items for a defined period of time in the future based on the determined amount of time that planting and growing takes of the one or more ingredients for the one or more prepared food items for at least the first service area.

In an aspect, the technology relates to a method of operation of a computational system that implements at least one machine learning system to facilitate logistics. The method includes determining, by the computational system, an amount of time that harvesting takes of plants that supply one or more ingredients for one or more prepared food items for at least a first service area. The method also includes determining, by the computational system, when to harvest the plants that supply the one or more ingredients to meet a predicted amount of future supply need of the one or more ingredients for the one or more prepared food items for a defined period of time in the future based on the determined amount of time that harvesting takes of the plants that supply the one or more ingredients for the one or more prepared food items for at least the first service area.

In an aspect, the technology relates to a method of operation of a computational system that implements at least one machine learning system to facilitate logistics. The method includes determining, by the computational system, an amount of time that production takes of one or more food items for at least a first service area. The method also includes determining, by the computational system, scheduling of delivery of the one or more food items for at least the first service area to meet a predicted amount of future supply need of the one or more food items for a defined period of time in the future based on the determined amount of time that production takes of the one or more food items for at least the first service area.

In an aspect, the technology relates to a method of operation of a computational system that implements at least one machine learning system to facilitate logistics. The method includes receiving, by the computational system, information representative of historical delivery data for food items previously delivered by at least one unmanned delivery vehicle in at least a first service area. The method also includes training, by the computational system, the at least one machine learning system based at least in part on the received information representative of historical delivery data for food items delivered by the at least one unmanned delivery vehicle in at least the first service area. The method also includes generating, by the computational system, a delivery schedule for food items to be delivered by at least one unmanned delivery vehicle in at least a second service area via the trained at least one machine learning system.

In an aspect, the technology relates to a method of operation of a computational system that implements at least one machine learning system to facilitate logistics. The method includes receiving, by the computational system, information representative of historical processing and delivery data for food items previously delivered by at least one process-in-transit vehicle in at least a first service area, at least some of the food items at least partially processed in transit by the at least one process-in-transit vehicle. The method also includes training, by the computational system, the at least one machine learning system based at least in part on the received information representative of historical processing and delivery data for food items delivered by the at least one process-in-transit vehicle in at least the first service area. The method also includes generating, by the computational system, a processing and delivery schedule for food items to be processed and delivered by at least one process-in-transit vehicle in at least a second service area via the trained at least one machine learning system.

### BRIEF DESCRIPTION OF THE DRAWINGS

FIG. 1 is a schematic diagram of an illustrative networked environment for facilitating logistics via implementation of machine learning systems.

FIG. 2 is a second schematic diagram of an illustrative networked environment for facilitating logistics via implementation of machine learning systems.

FIG. 3 is a schematic diagram of an illustrative networked environment in which a machine learning system is trained to generate predictive information for facilitating logistics for the production of ingredients of food items.

FIG. 4A is a schematic diagram of an illustrative networked environment in which a machine learning system is trained at a first time.

FIG. 4B is a schematic diagram of an illustrative networked environment in which future supply need is predicted, via the trained machine learning system, to facilitate logistics.

FIG. 5 is a method for predicting a future supply need of one or more ingredients for prepared food items for a service area.

FIG. 6A is a method for fulfilling the predicted future supply need for the one or more ingredients.

FIG. 6B is a method associated with predicting a number of instances of future orders for respective food items predicted to be received during a defined period of time in the future for the service area.

FIG. 7A is a networked environment in which a machine learning system is trained at a first time to predict a number of instances of future orders of respective ones of the food items predicted to be received during a defined period of time in the future for a service area.

FIG. 7B is a networked environment in which, at a second time, a number of instances of future orders for respective ones of one or more prepared food items is predicted to be received during a defined period of time in the future for the service area.

FIG. 8A is a method for predicting an amount of future supply need of one or more ingredients for one or more prepared food items for a defined period of time in the future associated with a future particular marketing activity or event.

FIG. 8B is a method for predicting supply need for ingredients based on economic indicators.

FIG. 8C is a method for predicting demand for ingredients using machine learning.

FIG. 9 is a method for scheduling the production, from planting to delivery, of one or more ingredients for one or more prepared food items according to another embodiment.

FIG. 10 is a method for scheduling the production, from planting to delivery, of one or more ingredients for one or more prepared food items.

FIG. 11 is a method of growing and transporting one or more ingredients to fulfill a predicted future supply need.

FIG. 12A is a method of determining when to plant one or more of plant starts and seed for the one or more ingredients to meet a predicted amount of future supply need.

FIG. 12B is a method for determining when to harvest plants that supply the one or more ingredients to meet a predicted amount of future supply need.

FIG. 13 is a method of scheduling and revising a schedule of delivery of one or more food items to meet an updated predicted amount of future supply need.

FIG. 14A is a method of generating and updating a delivery schedule for one or more food items to meet short notice predictions of supply need according to one or more implementations.

FIG. 14B is a method of autonomous delivery of food items based on a predicted supply need according to one or more implementations.

FIG. 14C shows a method of scheduling delivery for food items based on processing ingredients in-transit according to one or more implementations.

FIG. 15 is a method of receiving information representative of historical delivery data for food items previously delivered in at least a first service area.

FIG. 16A is a method of generating a delivery schedule for the food items.

FIG. 16B is a method of generating a delivery schedule for food items to be delivered by at least one unmanned delivery vehicle in at least one second service area according to one or more implementations.

FIG. 16C is a method of generating a processing and delivery schedule for food items to be processed and delivered by at least one process-in-transit vehicle in at least a service area.

FIG. 16D is a method of generating a delivery schedule for the food items according to another embodiment.

FIG. 17 is a method for predicting a number of instances of future orders for respective ones of one or more prepared food items predicted to be received during a defined period of time in the future for at least the service area.

FIG. 18 is a method involving determining a variance between an estimated historical ingredient usage and actual historical ingredient usage.

FIG. 19 shows a method 1900 of training at least one machine learning system 106 according to one or more implementations.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In some instances, structures and methods associated with the cultivation, harvesting, processing, preparation, cooking, transport, and delivery of food ingredients of prepared food items have not been shown or described in detail to avoid unnecessarily obscuring descriptions of the embodiments.

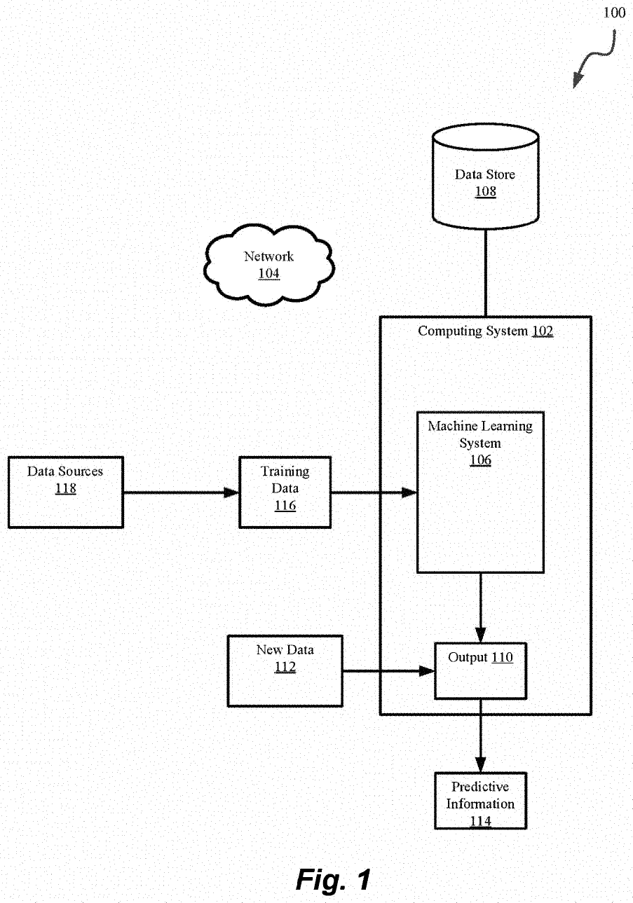

FIG. 1 shows a processor-based networked environment 100 in which one or more artificial machine learnings are implemented that interact with a set of subsystems to generate predictive information regarding one or more food items. The environment 100 comprises a computational system 102 that communicates over a network 104 with other entities in the environment 100. The computational system 102 comprises software and hardware including one or more processors coupled to memory storing a set of executable instructions that, as a result of execution by the one or more processors, cause the computational system 102 to perform one or more operations described herein. The computational system 102 may include additional components to fulfill the operations described herein, such as a communication interface for communicating over the network 104. The network 104 may include public and private networks, such as cellular telephone networks, the internet, local area networks, and wide area networks, by way of non-limiting example.

The environment 100 further comprises a machine learning system 106 that includes one or more machine learning layers between input and output layers thereof and that can model complex non-linear relationships. Machine learning systems generate compositional models where the object is expressed as a layered composition of primitives. The extra layers enable composition of features from lower layers, potentially modeling complex data with fewer units than a similarly performing shallow network. The machine learning system 106 may be implemented by executing a set of executable instructions stored in memory of the environment 100 that, as a result of execution by one or more processors, cause performance of one or more operations described herein. The machine learning system 106 may be part of the computational system 102 (e.g., common memory and/or processors) or may be implemented using one or more components common to the computational system 102 and the machine learning system 106. The machine learning system 106 may process training data 116 obtained from one or more other entities of the environment 100 to generate an output that is useable to predict information about one or more aspects of the food products in the future. The training data 116 may be stored in a non-transitory data store 108 communicatively coupled to the machine learning system 106.

The machine learning system 106 may obtain training data 116 from system entities and use that data to generate an output that predicts or forecasts circumstances that will exist in the environment 100 in the future given a set of inputs. The machine learning system 106 may be trained using supervised or unsupervised learning, or may perform supervised or unsupervised learning during operation. Supervised learning is the machine learning task of inferring a function from labeled training data 116 and unsupervised learning is a type of machine learning algorithm used to draw inferences from datasets consisting of input data without labeled responses. Unsupervised learning is a type of machine learning algorithm used to draw inferences from datasets consisting of input data without labeled responses. An output 110 generated by the machine learning system 106 is useable generate predictive information 114 based at least in part on new or current data 112 obtained from the system entities and machine learning training.

The predictive information 114 provided using the output 110 of the machine learning system 106 may be predictive of one or more supply need aspects of the food products, or other aspects described herein. As one example, the machine learning system 106 may obtain food product ordering data indicating a number of a particular food product ordered over a period of time in a given region and associated data (e.g., social event data and weather data for the time and region), and use the food product ordering data and associated data to generate an output 110 useable to predict supply need at a future time for the food product or ingredients thereof using new data. As another example, the machine learning system 106 may obtain ingredient supply data regarding a set of ingredients used to make food products (e.g., the amount of ingredients produced in a period of time) and associated data (e.g., weather data and data regarding the farms at which the ingredients were grown), and process the ingredient supply data and associated data to generate an output 110 useable to predict supply of one or more of the set of ingredients at a future time using new data. The output 110 generated and the training data 116 used for generation of the output may involve various aspects of the supply chain, including growth, harvesting, processing, transport, preparing, cooking, delivery, and sales, by way of non-limiting example.

The output of the machine learning system 106 provides efficiencies and optimizations that were not previously provided in at least some food product supply chains. The output 110 may process new information 112 obtained from farms, stores, social media, etc. to provide predictive information 114 that system entities in the environment 100 may use to determine predicted supply need information and/or supply information for ingredients. Using the predicted supply need information, stores may coordinate with suppliers and logistics providers to ensure that an appropriate amount of ingredients is provided. The predictive information indicates to farmers that a certain amount of each ingredient will need to be produced. Moreover, the predictive information may specify conditions sufficient to satisfy supply need while optimizing production—for example, when, where, and how much of an ingredient should be planted. The predictive information may indicate when an ingredient should be harvested and loaded onto a truck for shipping to optimize ripeness of the ingredient upon delivery. The predictive information may indicate how product should be loaded onto a truck to achieve stability of the ingredients during transit, and the route which the truck should take to deliver to help optimize the ripeness of the ingredients. Further, based on the predictive information provided, food products can be prepared while on the truck using the ingredients so that cooking of the food products is completed just as the delivery truck arrives at a customer destination. Other benefits provided according to the instant disclosure include reduced waste of ingredients, elimination of middlemen, improved variety of ingredients, and improved freshness and quality of food products and the ingredients thereof. Those of ordinary skill in the art will appreciate these and other benefits according to the instant disclosure.

The training data 116 is obtained from a plurality of sources within the environment 100 including sources providing data regarding one or more of the following aspects: supply need and sales for food products and the ingredients thereof, supply of ingredients (e.g., amounts of ingredients provided, sufficiency of ingredients, quality of ingredients), weather, events, economic and/or financial indicators, transit, traffic, farming, scheduling, production time, and geography and/or location data. Individual sources may provide training data fitting into one or more of the above-categories, or other data described herein. In some implementations, the sources of the training data 116 may provide the training data 116 with a label associated with a corresponding data input object such that the machine learning system 106 may be trained at least in part according to supervised machine learning principles. In some implementations, the training data 116 may be labelled by an entity (e.g., control subsystem 102) after being provided by the source. In at least some of those implementations, the data may be labelled based on identification information associated with the data—for example, based on an identifier provided with the data. In some implementations, one or more of the sources may provide the data without a label such that the machine learning system 106 may be trained at least in part according to unsupervised machine learning principles.

The training data 116 is obtained from a variety of data sources 118 in the environment 100 and provided to the machine learning system 106. Illustrative examples of the sources of the training data 116 are as follows:

Sources 118 include sources of data regarding historical use of ingredients used thereof include physical supply locations (e.g., brick and mortar stores, restaurants, commissaries, dark kitchens, kiosks), online sellers, vending machines, and vehicles equipped to prepare and/or provide food products to consumers. The data regarding historical use of ingredients for food products may include order information regarding one or more orders placed by physical suppliers or for automated production delivery vehicles, such as an amount of food products ordered or an amount of one or more ingredients used to prepare the food product ordered. The sources may provide the data in response to each sale or as a result of accumulating data regarding a number of sales.

Sources of data regarding supply of ingredients include farms, butchers and meat producers, and food processing entities (for obtaining cheese, flour, tortillas, etc.). The data regarding supply of ingredients includes supply information indicating an amount of ingredients supplied by the respective sources over periods of time. Supply information provided by farms may indicate one or more of the following: amounts of ingredients planted, amounts of ingredients harvested, attrition of planted ingredients, amounts of livestock born, attrition of livestock, and information regarding livestock sold to butchers and meat producers (e.g., age, weight, gender, health, quantity sold). Farms may provide other information for which associations may be created with supply data, including soil type, feed used for livestock, crop rotation information, chemicals used (e.g., pesticides, fungicides), occurrences of infestations, and types and amounts of farming equipment possessed for use in connection with farming operations (e.g., tractors and attachments thereto). The supply data provided by butchers and meat producers may indicate one or more of the following: information regarding livestock received (e.g., age, weight, gender, health, quantity purchased), equipment possessed (e.g., meat grinders, packaging devices, sausage stuffers), and information about meat products produced (e.g., types of products, quality of meat, wasted product, amounts of product produced, weights of packaged items). Food processing entities may process ingredients purchased from suppliers (e.g., farmers, wholesalers) to produce processed foods, such as cheese, flour, and bread. Supply information provided by food processing entities indicates one or more of the following: amounts and types of ingredients obtained to make food, equipment possessed, amounts and type of product produced using the ingredients obtained, and time taken to produce the product.

In some implementations, equipment of the supply data sources 118 may be equipped or associated with sensing devices that measure production characteristics, such as an amount of a product produced by the equipment or an amount of ingredient used to produce the product. For instance, a tractor may include sensor devices or subsystems that detect an amount of produce produced relative to the area or distance travelled. Data collected by various sensor devices or subsystems may be aggregated and provided to the control subsystem 102 or other entity in the environment 100. Individual ones of the supply data sources 118 may provide the supply information on a periodic basis or in response to a request to provide the information.

The environment 100 may include event data sources from which data may be obtained regarding marketing activities or public or private events in one or more geographic areas. Events are activities and events occurring at a scheduled time, date, and location for a designated purpose. Examples of event and activities include concerts, sporting events, political rallies, protests, theatrical events, holiday events (e.g., events celebrating New Year's Eve, Halloween, July 4th), conferences, and/or marketing sales or promotions programs. Sources for providing the data regarding event activities obtain data regarding the events and provide the data to the machine learning system 106 directly or indirectly. The event data sources may include hardware and software comprising one or more sets of instructions stored in memory that, as a result of execution by one or more processors, cause performance of operations described herein.

Obtaining event data from the event data sources may involve using automated agents or bots that scrape or crawl websites, social media, calendars, and applications to identify and extract data regarding the marketing events and activities. For instance, the event data sources may crawl websites of concert artists, venues, or ticketing websites to identify information about upcoming and past music concerts in a geographic area. The data sources may extract information from the websites, such as time, date, and location of the concerts, as well as other data, such as venue capacity and ticket sale information. Obtaining the event data from the event data sources may involve performing one or more database queries searching for data regarding marketing events or activities in a geographic region for one or more periods of time. The data sources may provide marketing event and activity data for future as well as past events. Past marketing event and activity data may be used as training data for the machine learning system 106. For instance, past marketing event and activity data may be processed in association with historical order information of orders contemporaneous and proximate to the time and location of the event or activity. The machine learning system 106 may process future marketing event and activity data to generate predictive information 114 indicating supply need of one or more ingredients.

The environment 100 further include sources of economic indicator data from which data may be obtained regarding one or more economic indicators that indicate trends in a local, regional, and/or national economy. Examples of economic indicators include retail sales, employment and labor market statistics, current stage of economic cycle, personal income, home sale rates and values, Gross Domestic Product (GDP), Money Supply (M2), Consumer Price Index (CPI), Producer Price Index (PPI) and Consumer Confidence Surveys. The sources of economic indicator data may include public agencies, departments, and bureaus responsible for maintaining economic data and statistics (e.g., U.S. Bureau of Labor Statistics, U.S. Treasury, U.S. Department of Commerce, Federal Deposit Insurance Corporation, U.S. Bureau of Economic Analysis, U.S. Federal Reserve and or any other state or regional or city agency); private companies and firms providing and maintaining records of economic data and statistics; and specialized associations and organizations (e.g., The Conference Board, Organization for Economic Cooperation and Development). Obtaining economic indicator data from the sources of economic indicator data may include accessing a database or website from which the economic indicator data is obtained—for example, by performing a database query for the economic indicator data or downloading a collection of data objects comprising economic indicator data. Obtaining the economic indicator information may involve using automated agents or bots that scrape or crawl websites to identify and extract economic indicator data. The training data 116 may include past economic indicator data used in association with historical order information to train the machine learning system 106. Accordingly, the output 110 of the machine learning system 106 may generate predictive information regarding at least a future supply need of one or more of the ingredients of food products in a future period of time.

The environment 100 may include sources providing meteorological data and/or astronomical event data. Meteorological data is data regarding weather events, conditions, and characteristics, and may include data regarding past, current, and predicted indications of precipitation, temperature, wind, and atmospheric pressure, by way of non-limiting example. Astronomical event data is data relating to the sun and the moon, and includes data regarding sunrise events, sunset events, moonrise events, moonset events, moon phase, solar flares, tides, and sun angle. The meteorological data and/or astronomical data obtained may be associated with other data, such as temporal data indicating a date and/or time corresponding to the data, and geographical data indicating a geographical region corresponding to the data. The meteorological data and/or astronomical data may be obtained from websites or databases maintained by public or private entities, such as the National Oceanic and Atmospheric Administration, the National Weather Service, and the National Climatic Data Center. Current or contemporaneous meteorological data and/or astronomical data may be obtained from one or more sensors (e.g., photosensors, wind sensors, precipitation sensors, thermal sensors) located within one or more geographical regions, and may be associated with temporal data and location data corresponding to the time, date, and/or place at which the data was collected. The data collected may be stored for use as training data 116 in the data store 108.

The environment 100 may also include sources of ingredient production information that provide information regarding the production of an ingredient. The ingredient production information includes information regarding the time it takes for an ingredient to be produced, from inception to delivery. Such information regarding production includes an amount of time that an ingredient takes from inception to delivery, and may include information regarding production events from inception to delivery, such as a time and location at which each production event occurs (e.g., when and where a plant was harvested). The term “inception” as used herein refers to the event initiating the formation of an ingredient. In the context of flora (e.g., plants, fungus), inception may refer to the germination or planting of one or more flora. In the context of fauna, such as farm animals used for meat production, inception may refer to the successful impregnation an animal. In the context of ingredients that are generated by processing one or more other constituent ingredients (e.g., flour, pepperoni, cheese), inception refers to the point at which at least one of the constituent ingredients is harvested, gathered, slaughtered, or otherwise obtained. In the case of cheese, for instance, inception refers to the point at which the milk is obtained from an animal to begin production of the cheese. In the case of flour, inception refers to the point at which the grain or plant matter is harvested.

The sources of ingredient production information may also provide information relating to the ordering and delivery of seeds or starter plants used to produce the food ingredients. Information relating to ordering and delivery indicates an amount of time between when an order for seeds, starter plants, or other constituent is placed, and when the order is actually delivered or made available for pickup. The information relating to ordering and delivery may also indicate a supplier of the seeds or starter plants, distance between the source and destination, delivery progress throughout the shipment, information about the delivery vehicles involved in the transport, and condition information regarding internal and external conditions of the transport vehicle(s). Other constituent ingredients for which such information related to ordering and delivery include other units of floral reproduction, such as spores and root starters.

The sources of ingredient production information may also provide time information indicating an amount of time that it takes to plant and grow the seeds or starter plants into plants that can be used to provide the ingredients. For instance, the information amount of time in which it takes an herb seed to grow into an herb plant from which herbs may be harvested, or the amount of time in which it takes a tomato seed to grow into a tomato plant bearing ripe tomatoes. The information indicating the amount of time may further indicate times that it takes the seed or starter plants into other stages of growth (e.g., vegetative stage, budding stage, flowering stage). The sources of ingredient production information may also provide related information to the time information, such as farming conditions (e.g., method of growth, whether grown indoors/outdoors), types of plants grown, equipment used, time/date at which the seed or starter plant is grown, and other variables or factors that may affect plant growth, as described below.

The sources of ingredient production information also provide harvesting information indicating an amount of time that it takes to harvest the plants. The harvesting information may indicate a time and date at which harvesting of the plants produced by the seeds or starter plants began, and a time and date at which harvesting of the plants ended. Harvesting information may include information regarding the equipment used to harvest the plants, types of plants harvested, space or resources available based on harvesting schedule, and other information affecting harvesting discussed herein. Harvesting may correspond to removal of the entire plant from the soil, or removal of a part or portion of the plant. Postharvest information may also be provided relating to the postharvest processing of plant matter after it has been removed from the ground and before it is loaded onto a vehicle for shipment. Postharvest processing information may include information regarding the postharvest processing, cleaning, trimming, sorting, packing, or drying processes of the plant matter after harvesting and before loading, and may include information indicating an amount of time taken in postharvest processing and the type of crop processed.

The sources of training data also include sources of food item production information that provide information regarding the production of food items. The food item production information includes information regarding the time it takes for a food item to be produced, from the point of inception of an earliest ingredient to the point when the food item is delivered or ready for presentation to a customer. The food item production information may include information regarding one or more intermediate events in production or time periods in the production, such as a time at which an order for a food item is placed relative to when the food item is ready for delivery, or a time at which all ingredients sufficient to prepare a food item are delivered relative to when the order for the ingredients was placed. The sources of food item production information may include one or more of physical brick-and-mortar stores in which the food items are assembled; automated devices (e.g., robots) that prepare, assemble, and cook the ingredients to create the food item; shipping intermediaries; and farms that grow the ingredients.

The machine learning system 106 or the computing system 102 may be trained as a result of least processing the training data 116 from the sources described herein. Training the machine learning system 106 may, in some instances, cause the machine learning system 106 or the computing system 102 to perform one or more operations described herein as a result of processing the training data 116. In at least some implementations, the trained machine learning system 106 or the computing system 102 generate predictive information 114 regarding conditions that will be present in the environment 100 at a future time or period of time. In some implementations, the output 110 may generate or modify a set of instructions stored in the computing system 102, which may be a set of executable instructions (e.g., program, application), or modifications to an existing set of executable instructions. In some implementations, the set of instructions may be part of the machine learning system 106 or the computational system 102. In some implementations, the set of instructions may correspond to an application or program separate from the machine learning system 106 or the computational system 102.

The machine learning system 106 implements one or more machine learning models (e.g., machine learning algorithms) to generate the output 110 using the training data 116 provided. The one or more machine learning models implemented by the machine learning system 106 include regression machine learning models in which the output of a value is provided based on new information 112 received. Examples of regression machine learning models include linear regression, multivariate regression Least Absolute Selection Shrinkage Operator, logistic regression, random forest, learning vector quantization, support vector, k-nearest neighbor, and multivariate regression algorithms, by way of non-limiting example. The machine learning system 106 may implement multi-level or hierarchal approaches in which relationships between parameters in the training data 116 are determined in connection with generating the output 110—for example, Deep Learning models, machine learnings (e.g., Convolutional Neural Networks, Deep Neural Networks), and hierarchal Bayesian models. Those of ordinary skill in the art will appreciate that numerous machine learning models are applicable to generate the output 110 described herein without departing from the scope of the instant disclosure. The machine learning system 106 provides predictive information regarding one or more aspects of the environment 100 to facilitate a short, inside-out supply chain (“SIOSC”) in which ingredients are collected at a source and processed in transit to optimize freshness and quality at the time of delivery. In an SIOSC, ingredients for the food items are grown and ready just-in-time to be loaded onto a transport vehicle for shipment. The transport vehicles are equipped with automated robotics for processing a specific set of ingredients into a product. For example, the automated robotics prepare and cook tomatoes, basil, garlic, and onions into a tomato sauce during transit from the farm to another location. The transport vehicles are also equipped with environmental controlled storage (controlling for, e.g., temperature, moisture, light) to optimize the ripeness of the ingredients at destination delivery. The ingredients and/or product produced in the transport vehicle may be transferred to a delivery vehicle, which may prepare and deliver food items in transit to one or more destinations. Using preparation and delivery of a pizza as an example, the autonomous robotics in the delivery vehicle may slice pepperoni, toss a crust, place the requisite ingredients on the crust, and cook the pizza so that the pizza is ready as the delivery vehicle arrives at the delivery destination. In some implementations, the transit vehicle and delivery vehicle may be the same vehicle. In some implementations, there may be more than one transport vehicle.

At various points during the aforementioned SIOSC, training data 116 is provided to train the machine learning system 106 regarding scheduling, transport, preparation, harvesting, growing, and other aspects of the environment 100. As a result of this machine learning SIOSC, the ingredients go from farm to customer in a much shorter period of time than it typically takes in a national or regional distribution chain. The ingredients are picked so that they will be optimally ripe when used to prepare a food item and food wastage is reduced. The machine learning aspects disclosed herein predict or forecast supply need of a food provider based on numerous factors and provide predictive information to entities in the environment 100 related to, e.g., scheduling, growing, transporting, and preparing the ingredients. This reduces the time and distance between the farm and customer's mouth, eliminates warehousing, reduces packaging and food waste, and improves freshness and quality of the food using machine learning to guide the process. Those of ordinary skill in the art will appreciate these and other benefits resulting from the systems and method disclosed herein.

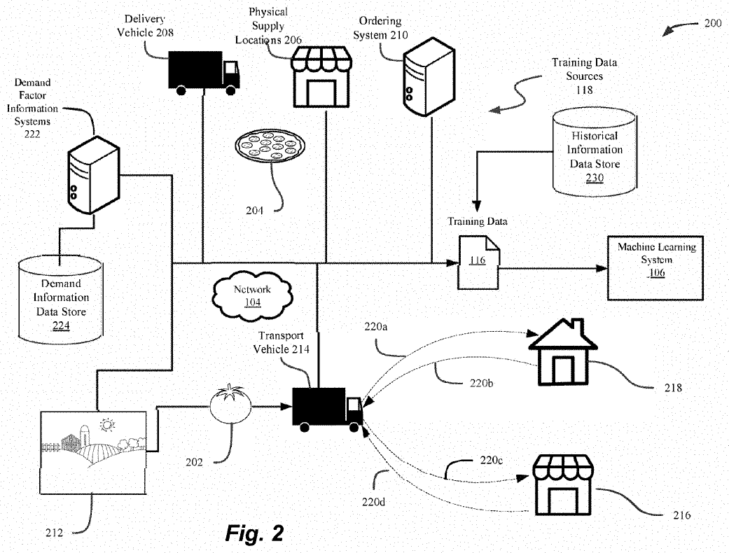

FIG. 2 shows an illustrative environment 200 in which the machine learning system 106 is trained using training data 116 at a first point in time. The training data 116 is generated by a plurality of training data sources 118 and provided to the machine learning system 106. The machine learning system 106 processes the training data 116 according to one or more machine learning methods to generate the output 110. Historical information regarding events, economic indicators, etc. may be obtained and provided to the machine learning system 106, which may generate the output 110 at least in part using the historical information.

The training data sources 118 provide various information related to the production, transport, preparation, processing, and utilization of ingredients and food items for a specified service area. The training data sources 118 include physical supply entities 206, delivery vehicles 208, electronic ordering systems 210, ingredient producers 212, and transport vehicles 214 associated with the specified service area.

Physical supply entities 206 are any physical location at which food items are prepared or made available to a customer for collection. The physical supply entities 206 include brick-and-mortar stores and restaurants, kiosks, vending machines, commissaries, dark kitchens, and other stationary locations to which a customer can order or even come to obtain food items 204. The physical supply entities 206 at least in part produce the food items 204, either automatically (i.e., via automated robotics) or manually, using the ingredients 202.

The physical supply entities 206 track information regarding use of the ingredients 202 in preparing the food items, such as an amount (e.g., weight, volume, quantity) of each ingredient 202 used to prepare each food items 204. The information may correlate the amount of each ingredient 202 used with a corresponding food item 204 prepared, or may correlate the amount of ingredients 202 used for a plurality of food item 204 prepared. In either case, the amount of ingredient 202 used is associated with a particular type of food item 204, such as the amount of cheese used to prepare a pizza.

The training data 116 provided by the physical supply entities 206 includes information representative of use of the ingredients 202 used in preparation of the food items 204, including information indicating an amount of the ingredients 202 used for preparation of each food item 204. The training data 116 may include information regarding an amount of time the food items 204 took to prepare. Additional information may be included or associated with information provided by the physical supply entities 206, such as whether the entity preparing the food items 204 is human or robotic. The physical supply entities 206 may be coupled to an inventory control or enterprise business system such that the supply and use of the ingredients 202 is tracked. Equipment in the physical supply entities 206 may include sensors or tracking devices (e.g., radio-frequency identification devices) for tracking the use and supply of the ingredients 202 in connection with producing the food items 204.

Delivery vehicles 208 are vehicles that deliver food items 204 to a location specified by the customer. Delivery vehicles 208 providing the training data 116 as discussed herein include production delivery vehicles and standard delivery vehicles. Standard delivery vehicles 208 are delivery vehicles in which prepared food items 204 (e.g., cooked) are loaded and delivered to a customer specified location. Automated delivery vehicles are equipped with automated preparation systems comprising hardware and software that at least in part prepares or cooks the food items 204, which may occur during transit or may be prepared and transferred to another delivery vehicle. For example, a production delivery vehicle may automatically cook a pizza during transit to the customer specified location without a human specifying or controlling a cooking temperature or cooking time of the pizza, based on the expected delivery time which may be by the vehicle itself and/or by a separate delivery vehicle. Production delivery vehicles may implement automated driving systems (i.e., self-driving cars) in which a human does not control navigation of the delivery vehicle 208 during transit, and non-automated vehicles in which a human controls navigation of the delivery vehicle 208. In some implementations, the delivery vehicles 208 are also the transport vehicles 214 that transport ingredients 202 from an ingredient producer 212 to a physical supply location 206 or a customer-specified location. In such implementations, the transport vehicles 214 may be production delivery vehicles 208 that are part of a farm-to-table delivery system in which the ingredients 202 are loaded onto the production vehicle at an ingredient producer 212 location, and the production vehicle prepares the food items 204 in transit so that the food item 204 finishes cooking just as the production vehicle arrives at the customer-specified location.

The training data 116 provided from the delivery vehicles 208, in some implementations, includes information regarding delivery of the food items 204. Such information indicates the time the delivery vehicle 208 to deliver food items. The delivery vehicles 208 may also provide time information regarding when delivery of the food item(s) 204 began and was completed, location information indicating their location along a delivery route at various times (e.g., global positioning system information), and the route taken. Traffic condition data indicating traffic conditions along one or more delivery routes may be obtained and associated with the training data 116 provided by the delivery vehicles 208. In implementations where the delivery vehicle 208 is a production delivery vehicle, the delivery vehicle 208 may provide training data 116 representative of the use of one or more ingredients used in preparation of the food items 204, and may further be representative of an amount of time taken to respectively prepare and cook the food item 204.

The electronic ordering system 210 is a processor-based system that tracks customer order information of food item 204 orders placed by customers. Such order information may include information indicating what food items 204 were ordered, date and time the food items 204 were ordered, the location where possession of the ordered food items 204 was transferred to the customer, etc. The order information may specify, for each respective food item 204 of a number of available food items, a total number of instances of orders for a respective type of prepared food item 204 in a defined period of time for the service area. The information regarding order instances may be for orders placed or orders fulfilled within the defined period of time. The ordering system 210 may be part of or interface with an online ordering system in which customers may place orders for food items 204 through a Website or application. The ordering system 210 may be part of or interface with a point-of-sale ordering system via which a food service company tracks orders placed. The training data 116 provided by the electronic ordering system 210 may be representative of order information tracked.

The ingredient producers 212 are entities (e.g., farms) that produce one or more ingredients 202 for a defined service area. The ingredient producers 212 include farms that plant, grow, or otherwise produce vegetables, meats, dairy, fruits, fungi, grains, etc. that are to be used in making food items 204 for a service area. Such farms may employ various methods The ingredient producers 212 may also include entities that process one or more of the ingredients 202 produced by a farm to make the ingredient 202 directly useable to produce a food item 204. Ingredient producers 212 may, for instance, include butchers that slaughter, dress, clean or otherwise prepare meat prior to being loaded onto the transit vehicles 214 so that the meat can be used to prepare the food items 204 while in transit. For instance, a butcher may clean and dress a pig carcass and provide the appropriate meat for loading onto the transit vehicle 214 where the pork may be ground and packaged into sausage. As another example, ingredient producers 212 may include cheese producers that make cheese using milk (and other necessary ingredients) procured from farmers.

The training data 116 provided by the ingredient producers 212 may include information regarding production of the ingredients 202. Such training data 116 may include information representative of an amount of time that a crop takes to grow, from inception (e.g., when a seed is planted, when a plant starter is planted, when an animal is impregnated) to harvest (e.g., when fruit/vegetable is ripe and picked, when an animal is born). The ingredient producers 212 also provide information regarding the crop produced (e.g., type of crop), information regarding the yield of a crop planted (e.g., amount of seed planted versus amount of crop harvested); farming techniques to be used for plants that supply the one or more ingredients; farming methods (e.g., standard soil, hydroponic, aeroponics, indoor planting, outdoor planting); location of the farm; space available to farm plants that supply the one or more ingredients; equipment to be used to farm plants that supply the one or more ingredients; growth rates of plants that supply the one or more ingredients; a season during which plants that supply the one or more ingredients are to be grown; and variables that affect growth of plants that supply the one or more ingredients.

The ingredient producers 212 may also provide information regarding one or more controlled or uncontrolled factors related to growth of one or more crops that supply the ingredients. In some implementations, the ingredient producers 212 may have facilities that can control factors related to conditions affecting growth of the crops that farmers using, for example, environmental control systems, irrigation control systems, lighting control systems, films placed on window panels, etc. . . . . The controlled factors related to an amount of oxygen, an amount of carbon dioxide, an amount of water, a type of watering system, an amount of nutrients provided to the crops, concentration of nutrients provided to the crops, pH level of the nutrients and/or water provided, how nutrients are delivered, amount of light intensity, spectrum of light, intervals of light, amount of humidity, amount of fertilizers, temperature, and amount of ventilation. In some implementations, growth of the crops that supply the ingredients 202 may be subject to one or more factors that are not controlled by the ingredient producers 212. Such uncontrolled factors may be related to one or more of an amount of oxygen supplied to the crops, an amount of carbon dioxide supplied to the crops, an amount of water supplied to the crops, amount of nutrients supplied to the crops, concentration of nutrients supplied to the crops, nutrient pH level, amount of light intensity, spectrum of light; intervals of light, amount of humidity, and temperature.

The training data 116 provided by the ingredient producers 212 may also include information regarding harvesting of the crops that supply the ingredients 202. The information regarding harvesting may indicate amounts of time that the plants comprising a crop take to harvest. For instance, when a crop of plants in one or more fields is ripe, the information regarding harvesting may indicate an amount of total time taken to harvest an entire crop from beginning to end, or amounts of time that each of the one or more fields growing the plants takes to harvest. This information may specify or be associated with information regarding the area of the field(s), the equipment used to harvest the crop, area covered to harvest the plants, conditions during harvest (e.g., weather conditions, temperature) and other pertinent information regarding the harvesting procedure. The information regarding harvesting may indicate different amounts of time that harvesting takes for different amounts of plants that supply the ingredients. The ingredient producers 212 may further provide information regarding post-harvest processing of crops after being removed from the ground, tree, root, etc. and before being loaded onto the transport vehicle 214 for shipment. Such postharvest processes include cleaning, trimming, sorting, packaging, or drying processes of plant matter after harvesting. The postharvest information may include information indicating an amount of total time taken for the postharvest processes and an indication of the crop being processed.

The transit vehicles 214 are vehicles (e.g., trucks, vans) onto which crop is loaded from the ingredient producers 212 and taken to another location, such as a location 216 providing one or more food items 204 (e.g., store, vending machine, kiosk) or a yet as to be identified customer delivery location 218. The transit vehicles 214 may be vehicles equipped to process one or more ingredients 202 in transit to a destination such that the form of the ingredients 202 has changed or one or more food items 204 is prepared therefrom. For instance, ingredients 202 may be loaded onto a transit vehicle 214 at one or more ingredient producer 212 locations and, during transit, the ingredients 202 may be processed and cooked into a pizza that is delivered to a customer delivery location 218 just as it finishes cooking. As another example, ingredients 202 may be processed and cooked in transit to produce a supply of tomato sauce that is delivered to a location providing one or more food items 216. Processing of the ingredients 202 during transit may include cleaning, sorting, preparing (e.g., slicing, peeling), packaging, grinding, and dressing, by way of non-limiting example. The transit vehicles 214 may be equipped with environmental controls controlling one or more environmental factors such as temperature, light, humidity, etc. In some implementations, however, the transit vehicles 214 may be standard shipping vehicles equipped to transport the ingredients 202.

Training data 116 provided by or in connection with the transit vehicles 214 includes information regarding transit between an ingredient producer 212 and a location to which the ingredients 202 or food items 204 are delivered (e.g., location 216 providing food items 204, customer delivery location 218). The information regarding transit includes transit time information representative of an amount of time taken in transit between the ingredient producer 212 location and the delivery location. The information regarding transit may also include route information representative of routes taken between the ingredient producer 212 location and the delivery location. The route information may include sequential ordering of roads and turns taken throughout the transit or information indicating a time (e.g., time of day, time travelled) for each road or turn. Condition information may be obtained (e.g., by computing system 102) and correlated with the information regarding transit in connection with the route information, the condition information indicating traffic conditions, weather conditions, and construction encountered in transit. The condition information may be obtained from a third-party via, for example, an application programming interface through which such information is made available (e.g., Google® Maps, Accuweather®).

Training data 116 provided by the transit vehicles 214 may include ingredient processing information regarding pre-processing of the ingredients 202 or at least partial preparation of the food items 204 performed by the transit vehicles 214 during transit. Such information is representative of an amount of the ingredients 202 pre-processed (e.g., washed, sliced), an amount of food items 204 prepared, and/or the amount of ingredients 202 used to at least partially prepare the food items 204. The ingredient processing information may also include information representative of an amount of time taken to pre-process the ingredients 202 and/or at least partially prepared food items 204.

One or more demand factor information systems 222 may provide information representative of conditions present contemporaneous to the provisioning of training data 116 by the training data sources 118. The demand factor information systems 222 may obtain and store marketing event or activity information obtained from one or more event information systems, economic indicator information obtained from one or more economic indicator systems, as well as other information related to demand factors attributed to affecting, predicting or being related to demand for food items 204 (e.g., weather information, traffic information, geographical information). Such information obtained may be stored in a demand information data store 224, which may be a relational data store in which demand information obtained is stored in association with other relevant information. Obtaining the demand factor information from the sources may involve using automated agents or bots that scrape or crawl web sites to identify and extract relevant information regarding economic indicators, events, the service area, etc.; performing one or more database queries searching for data regarding marketing events or activities in a geographic region for one or more periods of time; or performing one or more database queries regarding economic indicators for one or more periods of time. These methods, however, are merely illustrative and other automated or manual methods of obtaining historical information are considered as being within the scope of the instant disclosure. The event information is representative of events or activities occurring in or around a service area for a designated purpose. Events or activities include sporting events, concerts, protests, festivals, holidays, theatrical events, political rallies, conferences, marketing or promotional advertisement programs, and the like. Events or activities for which historical information may be obtained are those of sufficient scope, either individually or in aggregate, to affect supply need of ingredients 202 or food items 204 or delivery of food items 204 or ingredients 202. The event information obtained may include information regarding a purpose of the event, time and location(s) of the event, attendance expected, an attendance recorded, and/or other information specific to the event (e.g., score of sporting event, concert artists). The event information may be correlated with training data 116 received—for instance, events and information associated therewith may be correlated with information representative of order information for food items 204 received for a service are contemporaneous to an event.

The demand factor information systems 222 may be network connected processor-based systems that obtain and store event information for one or more service areas in the demand factor information data store 224. The event information systems may be websites, social media sites, databases, applications, or other similar location or entity storing or providing event information. For instance, event information regarding music concerts in or around a service area may be obtained from concert venue or artist websites or social media pages.

The economic indicator information is representative of indicators of economic trends. Examples of economic indicators include retail sales, employment and labor market statistics, current stage of economic cycle, personal income, Gross Domestic Product (GDP), Money Supply (M2), Consumer Price Index (CPI), Producer Price Index (PPI), home sales and/or prices, and Consumer Confidence Surveys. The economic indicators may be for or associated with a defined time period in the past or present. The economic indicators may be indicative of economic trends for a defined location or area, such as economic indicators for county, city, regional, national, foreign, or international economies. In at least some implementations, the economic indicators may be correlated to a particular service area. Further, the economic indicators may be correlated with training data 116 received—for instance, economic indicator information may be correlated with information representative of historical use of one or more ingredients 202. The demand factor information systems 222 may obtain the economic indicator information from public agencies, departments, and bureaus responsible for maintaining economic data and statistics (e.g., U.S. Bureau of Labor Statistics, U.S. Treasury, U.S. Department of Commerce, Federal Deposit Insurance Corporation, U.S. Bureau of Economic Analysis, U.S. Federal Reserve and/or appropriate local, regional and/or state agencies); private companies and firms providing and maintaining records of economic data and statistics; and specialized associations and organizations (e.g., The Conference Board, Organization for Economic Cooperation and Development).

The demand information obtained may be correlated in data storage with training data 116 corresponding to the period of time, service area, or other parameter to which the information pertains. For instance, historical use information of ingredients 202 or food items 204 for a service area may be correlated with marketing event information of events in and around the service area for a defined period of time. As another example, historical use information of ingredients 202 or food items 204 for a service area may be correlated with economic indicators for a defined period of time.

Training data 116 received from one or more of the training data sources 118 may be used to train the machine learning system 106 according to various appropriate models and methods. The training data 116 may be provided to the machine learning system 106 directly via the network 104, or may be collected by an intermediary and provided to the machine learning system 106. Such machine learning training may involve supervised, unsupervised, or semi-supervised methods in which the training data 116 is respectively labeled, unlabeled, or comprises both labelled and unlabeled data. The machine learning system 106 may be trained according to one or more machine learning models or systems, including decision tree learning models or system, artificial machine learning models or systems, support vector machine models or systems, clustering models or systems, Bayesian network models or systems. Training the machine learning system 106 may include modifying executable instructions of the machine learning system 106 itself, executable instructions of the computing system 102, or generating or modifying the output 110 comprising a set of computer-executable instructions (e.g., application, program).

The training data 116 may comprise data obtained or provided from a historical information data store 230 comprising historical information regarding the historical use of one or more ingredients 202 at time periods in the past in at least the service area, and historical order information regarding orders placed for one or more food items at time periods in the past in at least the service area. The training data 116 may be obtained or provided by the computational system 102 and provided to the machine learning system 106 for training, as described herein.

The machine learning system 106 is trained to predict various future conditions regarding a service area using the training data 116. A machine learning system 106 may be assigned to a corresponding individual service area. Each machine learning system 106 may therefore be unique to a service area, such as a defined geographic area. Although only one machine learning system 106 is depicted, a plurality of machine learning systems 106 may be deployed each corresponding to a different service area. At least some of the training data 116 used to train the machine learning system 106 may be specific to the service area—for example, historical use information representative of an amount of ingredients 202 used in a defined period of time may be for food item providers (e.g., stores, vending machines, automated production delivery vehicles) located within or assigned to the service area. Similarly, some of the historical information used to train the machine learning system 106 in some implementations may be particular to the service area corresponding to the machine learning system 106. Training the machine learning system 106 using at least some of the training data 116 may cause the machine learning system 106 or the computing system 102 to perform one or more operations described herein, Operations performed by the machine learning system 106 or the computing system 102 may include generating information predictive of various conditions that will be present in the environment 100 at a defined future time. In some instances, the machine learning system 106 or the computing system 102 may perform various determination operations, scheduling operations, or causing performance of other operations by other entities in the environment 100.

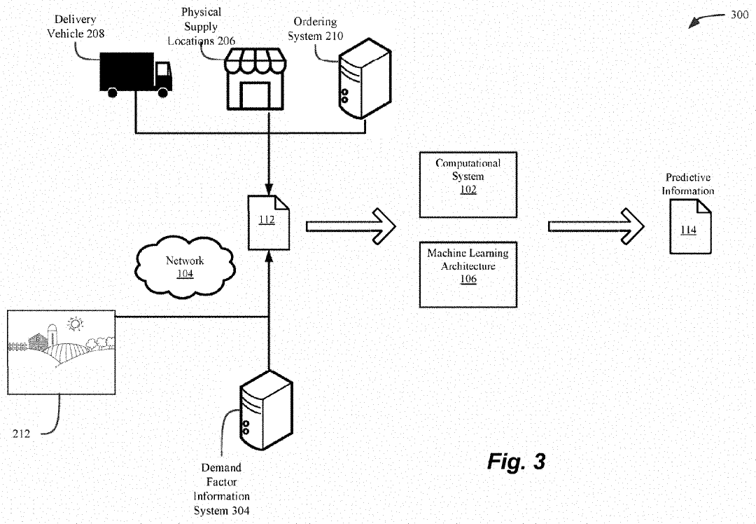

FIG. 3 shows an illustrative environment 300 in which the computational system 102 or the trained machine learning system 106 perform various operations based on new information 112 obtained. The environment 300 corresponds at least in part to the environment 200 but at a second point in time after the first point of time. The new information 112 may be obtained from sources similar or identical to the training data sources 118, sources of demand factor information, or other sources described herein as appropriate. For example, the environment 300 may include a demand factor information system 304 that obtains information representative of one or more factors affecting, predicting, or related to demand for the one or more ingredients 202 used in preparation of one or more prepared food items 204. Such factors may include events or activities, economic indicators, or one or more condition that cause demand for ingredients 202 to increase or decrease. The demand factor system 304 may crawl or scrape internet or social media sources relevant to the service area to determine such demand factor information. In some instances, the demand factor information system 304 may perform database queries for obtaining the demand factor information. Using the new information 112, the machine learning system 106 and/or the computing system 102 may generate predictive information 114 regarding conditions that will be present in the environment 100 at a future time. The predictive information 114 may then be used to facilitate logistics in the environment 100 by, for example, planting, harvesting, shipping, and processing of ingredients 202, or preparing, cooking, or delivering food items 204. Numerous illustrative examples of the operations will now be described.

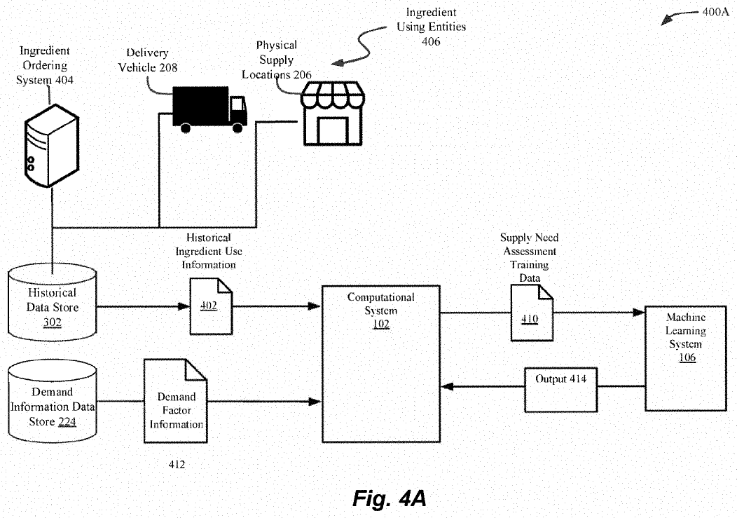

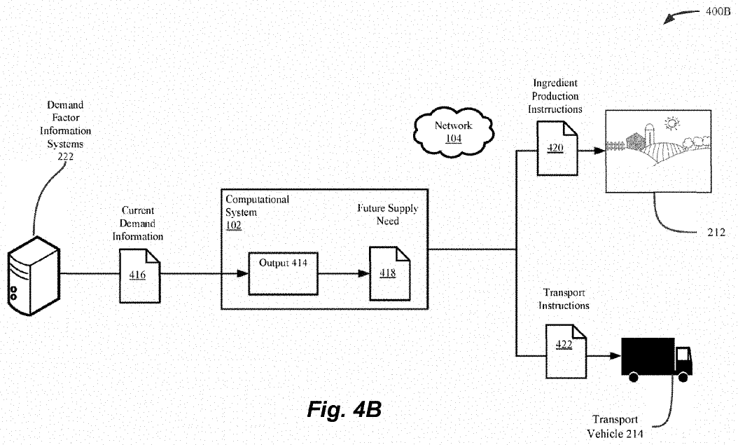

FIG. 4A shows an environment 400A in which the machine learning system 106 is trained at a first point in time to predict a future supply need for ingredients 202 based on historical use of the ingredients 202. The computing system 102, which may be an entity for managing logistics among various entities of the environment 400 depicted, obtains historical use information 402 representative of a historical use of one or more ingredients 202 used in preparation of one or more food items 204 for one or more service areas. The service area is a geographic region comprising one or more food services establishments (e.g., physical food item supply entities 206, automated production delivery vehicles 208) supplied by a logistics provider. In connection with using ingredients 202 in preparation of one or more of the food items 204, information representative of such historical use of the ingredients 202 may be generated by one or more entities using the ingredients 202 to produce food items 204.

Entities 406 using the ingredients 202 to produce the food items 204 may include one or more of automated production delivery vehicles 208, physical supply locations, ingredient ordering systems 404, or other entities using ingredients 202 to produce food items 204. The historical ingredient use information 402 is generated based on ingredient 202 usage over time. One metric of ingredient usage may be a stock of the ingredients 202 possessed by the respective entities 406 at different points in time. For instance, an entity 406 may provide information representative of respective amounts of one or more ingredients 202 possessed by the entity 406 according to the volume, number of containers, weight, etc. of the respective ingredients 202. Another metric may be an amount of the respective ingredients 202 ordered at different points in time by the entities 406. An electronic ingredient ordering system 404 may receive order communications from the automated production delivery vehicles 208 and/or the physical supply entities 206 requesting a supply of the ingredients 202 to be delivered or made available to the requesting entity. The order communications include information identifying the ingredients 202 needed, indicating amounts of respective ingredients 202 needed (e.g., weight, volume, quantity, size), and optionally a requested date by which the supply of the respective ingredients 202 should be delivered. Yet another metric may be an amount of the respective ingredients 202 used in a defined period of time.

The historical ingredient use information 402 obtained from the ingredient-using entities 406 may be stored in the historical data store 302 or provided to the computational system 102. The ingredient use information 402 provided may have a certain format, dimensionality (e.g., number of entry fields), and/or labels indicating a type of ingredient 202 and a corresponding amount of the respective ingredient 202 requested or possessed. For instance, the ingredient use information 402 may comprise one or more datasets each comprising a set of entries, wherein each entry includes information representative of ingredient 202 usage over time. Instances of the ingredient use information 402 may include or be associated with time information indicating the point in time or period of time to which the information corresponds, such as a time at which an order was placed or a time at which a supply was measured or determined. In some implementations, some or all of the historical ingredient use information 402 may be unlabeled, however. The ingredient use information 402 may be provided and/or stored in a delimiter-separated value format, such as a comma-separated value format, tab-separated value format, or semi-colon-separated format. As one example, the historical ingredient use information 402 may include a dataset arranged by column and row.

The computational system 102 may obtain demand factor information 412 for training the machine learning system 106. The demand factor information 412 may include economic indicator information, event or activity information, and/or other information representing one or more factors attributed to affecting, predicting or being related to demand for the food items 204 in the service area. The demand factor information 412 obtained may correspond to one or more defined periods of time and service areas for the historical ingredient use information 402. As one example, for a historical use entry in the historical ingredient use information 402 corresponding to a time T1 and service area A1, demand factor information 412 for a time period including or before the time T1 for the service area A1 may be included in or associated with the historical use entry. The machine learning system 106 can therefore be trained to correlate new demand factor information with a predicted future supply need for the service area.

The machine learning system 106 is trained to predict a future supply need of the ingredients 202 in the service area using supply need training data 410. The supply need assessment training data 410 is provided by the computing system 102 and comprises at least some of the historical ingredient use information 402. The supply need is a condition of a food item producer (e.g., automated production delivery vehicle 208, physical supply location 206) regarding possession of a supply of ingredients 202 sufficient to fulfill orders for food items 204. Supply need may be indicated by classification or numerical representation. In some implementations, supply need may be represented using a classification technique in which a discrete bi-class scale indicates whether a food item producer's supply of respective ingredients 202 is either “sufficient” or “insufficient,” or a multi-class scale in which the sufficiency of the food item producer's supply is indicated by degree—for example, “extremely insufficient,” “moderately insufficient”, “moderately sufficient,” and “extremely sufficient.” In some implementations, the supply need may be represented using a regression technique in which continuous numerical values indicate the sufficiency of a food item producer's supply need. For instance, a positive numerical value may indicate that a food item producer's supply of an ingredient is sufficient, and the numerical value may indicate the supply surplus, in units (e.g., weight, volume, quantity), of the ingredient 202. By contrast, a negative numerical value may indicate that a food item producer's supply of an ingredient is insufficient, and the numerical value may indicate the supply deficiency, in units, of the ingredient 202.

The computing system 102 may train the machine learning system 106 using one or more machine learning models provided or otherwise specified by the computing system 102. Some of the machine learning models may be classification models via which a set of inputs is mapped to a corresponding discrete output or classification regarding a supply need of one or more of the food item 204 producers. Some of the machine learning models may be regression models via which a set of inputs is mapped to a numeric value corresponding to a supply need of one or more of the food item 204 producers. Examples of such models include decision tree learning systems, support vector machine systems, artificial neural network systems, clustering systems, and Bayesian network system models. These examples are, however, intended to be non-limiting, and those of ordinary skill in the art will appreciate that other machine learning models may be suitable to appropriately train the machine learning system 106.

As one example of training, the machine learning system 106 may be trained using a training set 51 containing historical ingredient use information 402 and demand factor information 412 for a specific service area A1 and defined period of time T1. The machine learning system 106 may be trained to optimize the accuracy and precision of predicting future supply need 418. The machine learning system 106 may initially set weights and biases for parameters of a learning model to predetermined or random values. Such parameters correspond to events, economic indicators, dates, times, weather conditions, or other demand factors attributed to affecting, predicting or being related to the demand for prepared food items 204, as described herein. Via optimization methods (e.g., gradient descent algorithms), the machine learning system 106 may optimize the model by iteratively reducing error in weights and biases for the parameters using test cases included in the supply need assessment training data 410, such as test cases for the historical ingredient use information 402. After the initial training of the machine learning system 106 to predict future supply need, the machine learning system 106 may receive further training using updated historical ingredient use information 402 and updated demand factor information 412. The accuracy and precision of the future supply need 418 predicted may therefore be further improved or adjusted over time according to changing demand factors for the service area.

As a result of being trained, the machine learning system 106 may predict, or generate an output 414 useable to predict, a future supply need of one or more ingredients 202 for prepared food items 204 for the service area. FIG. 4B shows an environment 400B in which a future supply need of one or more ingredients 202 is predicted via the machine learning system 106 at a second point in time after the first point in time depicted and described with respect to FIG. 4A. The future supply need for the service area is determined by the computational system 102 using current demand information 416 obtained from physical supply entities 206, automated production delivery vehicles 208, and/or ingredient ordering systems 404 for the service area. The current demand information 416 represents one or more demand factors attributed to affecting, predicting or being related to demand for one or more food items 204 for the service area. The current demand information 416 may be indicative of demand for one or more of the food items 204 in the service area based at least in part on current or recent conditions related to the service area. The factors attributed to affecting, predicting, or being related to demand for the one or more food items 204 include one or more of: a particular time of day, a particular time of week, a particular time of month, a particular time of year; a particular day of week, a particular day of month, a particular day of year, a particular week of month, particular week of year, a particular month of year, a particular event, a particular holiday, a concert, a festival, a particular recurring event, a particular recurring sporting event, a particular recurring community event, a particular season, one or more economic indicators, retail sales, employment and labor market statistics, current stage of economic cycle, personal income, demographics, home sales and/or prices, Gross Domestic Product (GDP), Money Supply (M2), Consumer Price Index (CPI), Producer Price Index (PPI) and Consumer Confidence Survey, one or more factors specific to the service area, or one or more factors attributed to affecting or predicting demand specifically in the service area. It is noted that training the machine learning system 106 to predict future supply need 418 for a particular service area is beneficial at least because a set of demand factors that affect or are useful in predictions for one service area may not be as accurate or precise as a second set of demand factors for another service area. In other words, a trained machine learning system 106 for one service area may not be as effective at predicting future supply need 418 for another service area at least because certain demand factors may affect some service areas more than others. Accordingly, training machine learning systems 106 for specific service areas, as described herein, allows for more accurate and precise future supply need 418 prediction.

The current demand information 416 may be obtained from sources of economic indicator data for the service area, sources of macroeconomic indicator data, sources of event or activity data for the service area (e.g., in and around the service area), or other information specific to the service area. Such other information specific to the service area may be demand factors determined by the machine learning system 106 as being relevant to the future supply need for the service area. The service area represents an area serviced or defined by one or more of logistics suppliers, processors, trucking companies, shipping companies, wholesalers, resellers, supply chains managers, producers, farms, agricultural cooperatives, plantations, agricultural areas, markets, sales regions, distributors, retailers, importers, exporters, restaurants, restaurant chains, commissaries, grocery stores, co-ops, farmers markets, snack stands, concession stands, food trucks, food carts, vending kiosks, locker kiosks, hot dog carts, pop-up restaurants, supper clubs, temporary restaurants, venues, festivals, concerts, neighborhoods, boroughs, camps, community centers, cities, towns, counties, states, commonwealths, provinces, parishes, municipalities, districts, regions, countries and governments.

The computational system 102, using the current demand information 416 obtained, predicts the future ingredient supply need 418 of one or more ingredients 202 used in preparation of the food items 204 for the service area. The future ingredient supply need 418 is predicted using the output 414, which may be a new set of instructions or a modification to an existing set of instructions of the machine learning system 106 or the computational system 102. For instance, the trained machine learning system 106 may receive the current demand information 416 as input and process the current demand information 416 to predict the future ingredient supply need 418. The future ingredient supply need 418 may include information representative of an amount of one or more of the food items 204 that will be ordered in the service area for a defined future period of time. The amount of one or more food items 204 may be represented by an indication of quantity, volume, weight, or other similar metric of the one or more food items 204. The computational system 102 may then determine an amount of each ingredient 202 sufficient to produce the amount of food items 204 predicted.

The computational system 102 may obtain recipes for the one or more food items 204 to determine the amount of ingredients 202. The recipes specify an amount of each ingredient 202 sufficient to prepare each instance of the food items 204. For each type of food item 204 of the future ingredient supply need 418 predicted, the computational system 102 may multiply the amount of each ingredient 202 specified in the recipes by the amount of the respective food item 204 predicted to determine an amount of ingredient 202 sufficient to produce the amount of the respective food item 204 predicted. Then, for each ingredient 202, the computational system 102 may aggregate the amount of each respective ingredient 202 determined for each respective food item 204 to determine the total amount of each ingredient 202 that will be sufficient to satisfy the future supply need 418.

To meet the future ingredient supply need 418 predicted for the service area for the defined time in the future, the computational system 102 may cause operations to be performed to generate the corresponding amount of each ingredient 202 determined. In at least some implementations, the computational system 102 may generate and provide ingredient production instructions 420 to one or more ingredient producers 212 to produce the amount of ingredients 202 determined far enough in advance to allow the ingredients 202 to be planted, grown, harvested, processed, and delivered in time to meet the future ingredient supply need 418. A plurality of production instructions 420 may be respectively sent to different ingredient producers 212 wherein each of the plurality of production instructions 420 comprise different instructions specific to the ingredient producer 212. For instance, one of the production instructions 420 may be tailored according to attributes of the ingredient producers 212, such as soil type, water type, crops produced, equipment possessed, etc. The production instructions 420 may specify the type of ingredient 202 needed, the amount of each ingredient 202 to be produced, the time and date at which each ingredient 202 should be planted, the time and date at which the ingredients 202 should be harvested, and postharvest processing to be performed on the ingredients 202. The ingredient producers 212 accordingly plant, grow, and harvest an amount of ingredients 202 sufficient to, and at the appropriate time, to meet the future ingredient supply need 418.

The computational system 102, in at least some implementations, may generate and provide transport instructions 422 to one or more transport vehicles 214. The transport instructions 422 specify instructions regarding loading, transport, processing, and delivery of the ingredients 202 to one or more destinations. In at least some instances, at least some of the transport instructions 422 may be included in the production instructions 420 or otherwise provided to ingredient producers 212 to enable the ingredient producers 212 to anticipate and coordinate loading of ingredients 202 onto transport vehicles 214. A plurality of transport instructions 422 may be respectively sent to different transport vehicles 214 wherein each of the transport instructions 422 comprise different instructions specific to the transport vehicle 214. As one example, one of the transport instructions 422 may be tailored according to a configuration of the transport vehicle 214, such as its environmental control, fuel capacity, efficiency, or ingredient 202 processing capabilities. The transport instructions 422 may specify the date, time, and location (i.e., of an ingredient producer 212) at which one or more ingredients 202 harvested are to be loaded onto the transport vehicle 214; routes that the transport vehicles 214 are to take to the ingredient producers 212; or delivery routes 220 that the loaded transport vehicle(s) 214 are to take to a destination (e.g., service area or location therein, customer specified delivery location 218, food item provider 216) or to pick up additional ingredients 202 from other ingredient producers 212. The transport instructions 422 may include updated instructions received after the initial transport instructions 422, such as instructions received during transit that modify content of the instructions 422 as a result of, e.g., new current demand information 416.

In some implementations, the transport vehicles 214 may have equipment for pre-processing the ingredients 202 in transit, such as by washing, slicing, or portioning the ingredients 202 or preparing one or more food items 204 using the ingredients 202 loaded. In at least some of those implementations, the transport vehicles 214 may also be delivery vehicles 208 that cook prepared food items 204 in transit and arrive at a location just as cooking of the food item 204 is completed. In such implementations, the transport instructions 422 may specify the equipment that the transport vehicle 214 should be equipped with, a configuration of the equipment. The transport instructions 422 may include information specifying times or locations along a route at which various steps for preparing, processing, or cooking of ingredients 202 and food items 204 should be performed. During transit, the computing system 102 via the machine learning system 106 may update information regarding route or destination, or information regarding preparing, pre-processing, or cooking of ingredients 202 or food items 204 preparation according to updated or new demand factor information 412 obtained, or other information that may affect travel, such as weather or traffic.

In some implementations, the transport instructions 214 may specify a service area (e.g., geographic region) to which the transit vehicles 214 loaded with ingredients 202 are to travel from the ingredient producer 212, which is determined based at least in part on the future supply need 418. While transport vehicles 214 are in transit, the computational system 102 may determine more specific locations within a service area or may determine a different service area to which one or more of the transit vehicles 214 are to travel based on updated future supply need 418. For instance, while a transit vehicle 214 is in transit, the computing system 102 may receive new or updated current demand information 416 and, as a result of processing the current demand information 416 via the trained machine learning system 106, determine that there is a high likelihood that a particular region or location in the service area will experience a high demand for a food item 204 which the transit vehicle 214 is equipped to produce. The computational system 102 may then provide updated transport instructions 422 specifying an updated route or location for the transport vehicle 214.

The transport vehicle 214 transports the ingredients 202 loaded thereon along one or more routes to the service area or a location therein according to the transport instructions 422. In some implementations, the transport vehicle 214 may notify the computational system 102 of the vehicle's location upon arrival in the service area. The computational system 102 may, according to an updated future supply need 418, provide further instructions to the transport vehicle 214 instructing the transport vehicle 214 to travel to a specific region within the service area, a food item provider 216, or customer specified location 218. The transport vehicle 214 may deliver the ingredients 202, pre-processed or otherwise, or prepared or cooked food items 204 to the food item provider 216 or customer specified location 218 according to route and/or destination information included in the updated transport instructions 422.

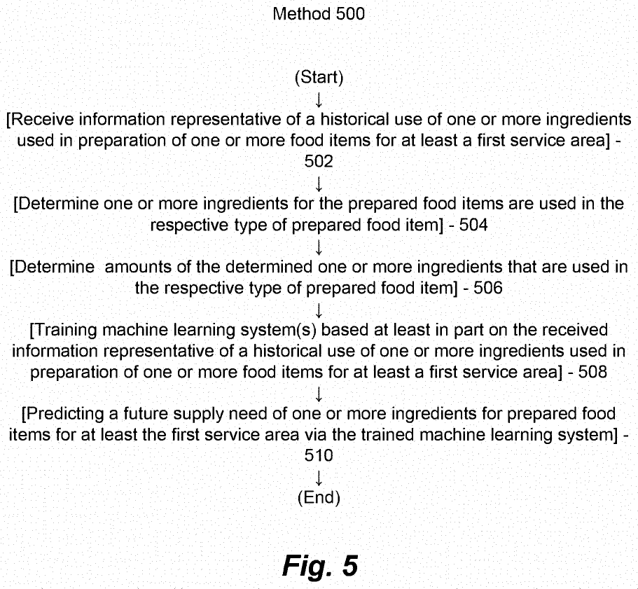

FIG. 5 shows a method 500 of predicting a future supply need of one or more ingredients 202 for prepared food items 204 for a service area according to one or more implementations. The method 500 may be performed by one or more appropriate entities described herein, such as the computational system 102 and/or the machine learning system 106. At 502, the method 500 begins by receiving information representative of a historical use of one or more ingredients 202 used in preparation of one or more food items 204 for at least a service area. The information representative of historical use may be, for example, received over the network 104 by the computational system 102. The information representative of historical use of the ingredients 202 may be based on amounts of ingredients 202 possessed by entities 406 using the ingredients 202 in the service area at different times within a given time period—for instance, the ingredient 202 usage may correspond to the difference between amounts of the ingredient 202 possessed at a first time versus a second time after the first time. The information representative of historical use may be based on amounts of ingredients 202 ordered by entities 406 at a given times within a given time period—for instance, an amount of ingredient 202 ordered at a first time and an amount of the ingredient 202 ordered at a second time after the first time. The order information may be obtained via the electronic ingredient ordering system 404.

Receiving 502 information representative of the historical use of the one or more ingredients 202 may include receiving information that, for each respective ingredient 202 of a plurality of ingredients used in preparation of one or more food items 204 for at least the service area, specifies an amount of the respective ingredient 202 used in a defined time period for at least the service area. The amount of the respective ingredient 202 used may be reflected as an indication of one or more orders placed by or on behalf of a food item producer (e.g., store, automated production delivery vehicle) for one or more of the ingredients 202. The amount of the respective ingredient 202 used may be reflected as amounts of the respective ingredients 202 possessed by the food item producer at different points in time. The amount used may be represented as an indication of weight, volume, quantity, or other metric appropriate to the respective ingredient 202.

Receiving 502 the information representative of historical use of the one or more ingredients 202 may include receiving information that, for each respective type of prepared food item 204 of a number of types of prepared food items 204, specifies a respective total number of instances of orders for the respective type of prepared food item 204 either placed or fulfilled during a defined time period for at least the service area. The information may be provided by a networked ordering system that electronically receives orders from customers over the network 104, records the order information in data storage, and provides the order information to food item producers. The ordering system may be the same as the computing system 102 or may be a distinct system therefrom. The food item orders correspond to food items 204 offered by food item providers in the service area.

The received information representative of historical use of the one or more ingredients 202 may be for a defined period of time. The information may be received from the historical data store 302 in response to a request to provide the information, such as a database query. The request may specifying the defined period of time and/or the service area for which corresponding historical use information is obtained. The received information may be provided as one or more data objects having a particular format, such as a file containing delimiter-separated values.

The method 500 may optionally include, for individual food items 204 of the respective type of prepared food items 204 either placed or fulfilled during the defined time period for at least the service area, determining 504 which of the one or more ingredients 202 for the prepared food items are used in the respective type of prepared food item 204. Determining 506 which ingredients 202 are used in the respective type of prepared food items 204 ordered may include obtaining recipe information indicating the type of ingredients 202 used in the respective food items 204. The method 500 may optionally include, for individual food items 204 of the respective type of prepared food items 204 either placed or fulfilled during the defined time period for at least the service area, determining amounts of the determined one or more ingredients 202 that are used in the respective type of prepared food items 204 ordered. Determining amounts of the respective type of prepared food items 204 may be achieved by comparing the amounts of the ingredients 202 possessed at different times, orders placed for the ingredients 202, or by calculation. Comparing amounts of the ingredients 202 possessed at different times may include comparing an amount of an ingredient 202 stocked by a food item producer at a first time at a beginning of the defined period of time with an amount of an ingredient possessed at a second time at the end of the defined period of time. Information regarding orders placed for ingredients 202 may indicate that an amount of the ingredient 202 has been used in a defined period of time, such information including an order amount (e.g., volume, quantity, weight), the ingredients 202 ordered, and order history for the ingredients 202 (e.g., when previous orders were placed, how much ingredient 202 was ordered). Calculating an amount of the determined one or more ingredients 202 may include obtaining recipe information for the one or more food items 204 indicating type and amount of ingredient 202 per unit of food item 204, and multiplying the amount of respective ingredient 202 per unit by the number of instances of food item 204 ordered in the defined period of time.

At 508, the method 500 the machine learning system 106 is trained based at least in part on the information representative of the historical use of the one or more ingredients 202 used in preparation of the one or more food items 204 for the service area. The machine learning system 106 may be trained by the computational system 102 according to one or more models for supervised machine learning, one or more models for unsupervised machine learning, or one or more models for semi-supervised machine learning. In some implementations, regression machine learning models may be used to train the machine learning system 106 to provide a numerical value based on new data. In some implementations, classification machine learning models may be used to train the machine learning system to provide a classification (e.g., binary classification, multi-modal classification) based on new data. The machine learning system 106 may be trained according to one or more of a decision tree learning system, an artificial neural network system, a support vector machine system, a clustering system, and a Bayesian network system, by way of non-limiting example. Training the machine learning system 106 may include generating a new set of executable instructions or modifying an existing set of instructions, e.g., of the computational system 102 or the machine learning system 106.

Training 508 the machine learning system 106 may include training using historical information that further represents one or more various factors attributed to affecting, predicting or being related to demand for the prepared food items 204. The historical information may correspond to demand factor information stored in the demand information data store 224 as described herein. The historical information may include information regarding, for example, a particular time of day, a particular time of week, a particular time of month, a particular time of year; a particular day of week, a particular day of month, a particular day of year, a particular week of month, particular week of year, a particular month of year, a particular event, a particular holiday, a concert, a festival, a particular recurring event, a particular recurring sporting event, a particular recurring community event, a particular season, one or more economic indicators, retail sales, employment and labor market statistics, current stage of economic cycle, personal income, demographics, home sales and/or prices, Gross Domestic Product (GDP), Money Supply (M2), Consumer Price Index (CPI), Producer Price Index (PPI) and Consumer Confidence Survey, one or more factors specific to the service area, one or more factors attributed to affecting or predicting demand specifically in the service area. Such historical information may be correlated with the information representative of the historical use of the one or more ingredients 202. For instance, information regarding an amount of one or more ingredients 202 used in a single day may be associated in memory with information regarding a sporting event or concert that also occurred during that day in the same service area (e.g., genre of music, attendance expected, size of venue). Accordingly, the machine learning system 106 may be trained to predict a future supply need of the ingredients 202 for a future defined time period in which another concert is scheduled to occur based on parameters associated with the future concert.

At 510, the future supply need of one or more of the ingredients 202 for one or more prepared food items 204 is predicted via the trained machine learning system 106 for at least the service area. Prediction of the future supply need of the one or more ingredients 202 may include obtaining current information, such as the current demand information 416 described above, indicative of one or more conditions in, around, or pertaining to a particular service area. For instance, the current information may be information representing various factors attributed to affecting, predicting, or being related to demand for prepared food items 204 in the service area. Such information may represent factors including, for example, one or more of a particular time of day, a particular time of week, a particular time of month, a particular time of year; a particular day of week, a particular day of month, a particular day of year, a particular week of month, particular week of year, a particular month of year, a particular event, a particular holiday, a concert, a festival, a particular recurring event, a particular recurring sporting event, a particular recurring community event, a particular season, one or more economic indicators, retail sales, employment and labor market statistics, current stage of economic cycle, personal income, demographics, home sales and/or prices, Gross Domestic Product (GDP), Money Supply (M2), Consumer Price Index (CPI), Producer Price Index (PPI) and Consumer Confidence Survey, one or more factors specific to the service area, one or more factors attributed to affecting or predicting demand specifically in the service area. Based on the current information representing one or more of the demand factors, the computing system 102 or the machine learning system 106 may predict the future supply need 418. The future supply need 418 may be an alphanumeric value or classification representing supply need for one or more ingredients at given times or time periods in the future. The future supply need 418 may be provided as alphanumeric text in a data object having a particular format.

Predicting 510 the future supply need 418 may include operating the trained machine learning system 106 to predict the future supply need 418 of the one or more ingredients 202 based on input including current information that represents the one or more various factors attributed to affecting, predicting or being related to demand for the prepared food items 204. For instance, the machine learning system 106 may receive, as input, current information (i.e., current demand information 416) that represents the one or more various factors attributed to affecting, predicting or being related to demand for the prepared food items 204. Continuing the example above, the current information may include information regarding a scheduled concert or sporting event in the service area. Such information may include day of the week, number of tickets sold, capacity of the venue, etc., which the trained machine learning system 106 may process to predict the future supply need 418.

The machine learning system 106 may then process the current information that represents the one or more various factors attributed to affecting, predicting or being related to demand for the prepared food items 204 to generate values indicative of corresponding amounts of each of the prepared food items 204 for at least the service area based on the current information that represents the one or more various factors attributed to affecting, predicting or being related to demand for the prepared food items. The values indicative of amounts of the food items 204 may reflect a supply of the food items 204 that will be sufficient to meet the demand arising as a result of, for example, the concert or sporting event represented by the current information. The machine learning system 106 may provide the values generated to the computational system 102, which may then generate or cause generation of corresponding total amounts of each of the one or more ingredients 202 for the prepared food items 204 to meet the future supply need 418 for at least the service area based on the generated values indicative of corresponding amounts of each of the prepared food items 204. For example, the computational system 102 may send ingredient production instructions 420 to ingredient producers 212 for the service area.

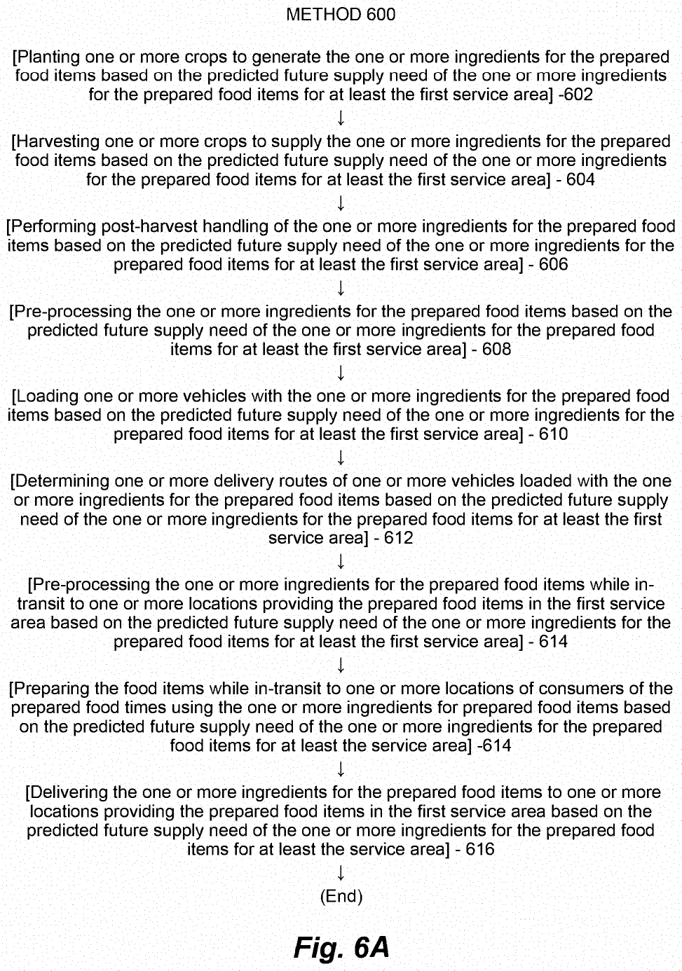

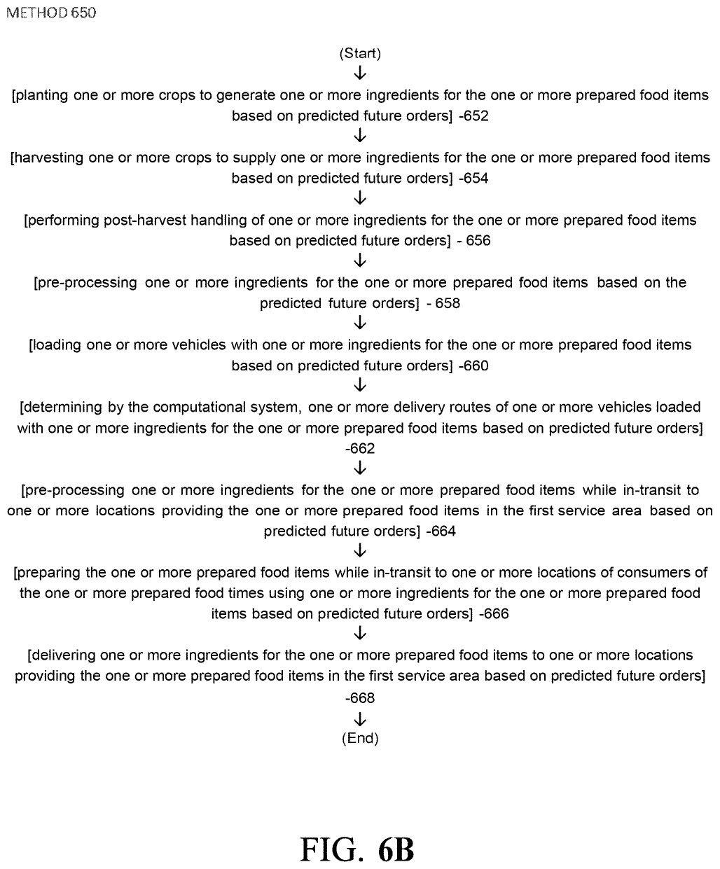

FIG. 6 shows a method 600 for fulfilling the predicted future supply need 418 for the one or more ingredients 202 according to one or more implementations. The method 600 may be performed by one or more entities of a logistics infrastructure in coordination with the computational system 102 described herein. The method 600 may be performed according to the future supply need 418 predicted for the one or more ingredients 202. Various operations performed in the method 600 may be performed as operations or sub operations of the method 500. Some of the operations described below may be omitted from performance of the method 600.

The method 600 begins by planting 602 one or more crops to generate the one or more ingredients 202 for the prepared food items 204 based on the predicted future supply need 418 of the one or more ingredients 202 for the prepared food items 204 for the service area. For instance, an amount of seeds sufficient to produce a crop satisfying the future supply need 418 may be planted in soil, water, etc. of an indoor or outdoor farm according to the production instructions 420 provided by the computational system 102. The one or more crops may be planted according to one or more parameters specified in the production instructions 420, such as parameters specifying a time and date at which the crops are to be planted. The crops may also be grown in accordance with various parameters specified in the production instructions 420, or in other instructions provided thereafter, such as instructions specifying environmental conditions (e.g., temperature conditions, watering conditions, light conditions) to which the crops are to be subjected during growth.

At 604, the one or more crops grown are harvested to supply the one or more ingredients 202 for the prepared food items 204 based on the predicted future supply need 418. The crops are harvested 604 according at least to the ingredient production instructions 420 or updated ingredient production instructions 420, which may specify types of crops to be harvested, and dates or times at which the crops are to be harvested. The method 600 may further include performing 606 post-harvest handling of the one or more ingredients 202 for the prepared food items 204 based on the predicted future supply need 418 of the one or more ingredients 202 for the prepared food items 204 for at least the service area. Post-harvest handling includes activities involving the one or more ingredients 202 after the ingredients 202 have been removed from the ground, but before being loaded onto the transport vehicle 214. Such postharvest processes include cleaning, trimming, sorting, packaging, bundling, or drying processes of plant matter after harvesting. Performance of the post-harvesting handling activities may be according to the ingredient production instructions 214, which may specify the which post-harvest processes are to be performed on which ingredients 202, duration of post-processing (e.g., for how long an ingredient should be dried), packaging instructions, cleaning processes, etc.

The method 600, at 608, may include pre-processing one or more of the ingredients 202 based on the predicted future supply need 418 of the one or more ingredients 202 for the prepared food items 204 for at least the service area. Pre-processing, if performed, is performed according to at least the ingredient production instructions 420 provided, which may specify which ingredients 202 to pre-process or the manner of pre-processing to be performed. Pre-processing may include cleaning, slicing, mincing, weighting, etc. to be performed. In some instances, pre-processing may utilize special equipment and processing techniques to convert the ingredients 202 from one form into another. For instance, milk may be processed at the ingredient producer 202 or another location using special acids or enzymes, and aged for a certain period of time (e.g., 60 days) to make cheese. In some situations, pre-processing may include packaging the ingredient 202 into containers, such as canning or bottling tomato sauce. Other such specialized pre-processing techniques and materials may be utilized to make other ingredients 202 for the food 204, such as dressing and curing meat to make pepperoni or sausage.

At 610 of the method 600, one or more of the transport vehicles 214 are loaded with ingredients 202 harvested based on the predicted future supply need 418 of the one or more ingredients 202 for the prepared food items 214 for at least the service area. The ingredients 202 may be loaded according to the ingredient production instructions 420 and/or the transports instructions 422, which may specify which ingredients 202 are to be loaded and amounts of the ingredients 202 to be loaded. In some implementations, where the transport vehicle 214 is an automated production vehicle equipped to, during transit, preprocess the ingredients 202 and/or prepare food items 204, the ingredients 202 may be loaded into containers or bins in a cargo area of the transport vehicle 214. The instructions may further specify a date and/or time at which the transport vehicle 214 loaded with ingredients 202 is to depart from the loading area of the ingredient producers 212.

The method 600 includes determining 612 one or more delivery routes 220 of one or more transport vehicles 214 loaded with the one or more ingredients 202 for the prepared food items 204 based on the predicted future supply need 418 of the one or more ingredients 202 for the prepared food items 204 for at least the service area. The one or more delivery routes 220 may be determined by the computational system 102 or the trained machine learning system 106 and included in the transport instructions 214 or as a separate set of instructions provided to the transport vehicle 214. The delivery routes 220 may be determined based on which service area the transport vehicle 214 is assigned to supply and may further be determined based on destinations within a service area to which the transport vehicle 214 is assigned to deliver. Information regarding the delivery routes 220 provided may specify a sequence of roads, turns, and maneuvers for the transport vehicle. Initial instructions based on the determination 612 are generated and provided prior to the transport vehicle 214 prior to or contemporaneous to the vehicle's departure from the ingredient producer 212 location. Instructions regarding the delivery routes 220 may be updated in transit based on current information provided to the computational system 102 and/or the machine learning system 106. For instance, the machine learning system 106 may receive location information regarding the location of the transport vehicle 214, and/or other transit vehicle for the next leg of the delivery route, in transit to the service area in connection with information regarding traffic conditions or weather conditions (or forecasts thereof), and update the information regarding delivery routes 220. In some implementations, the delivery routes 220 may be updated based on updated or current demand information 416. The updated delivery routes 220 may instruct the transport vehicle 214 to travel to a different service area according to an updated future supply need 418, or to travel along a different route.

The method 600 may further include pre-processing 614 the one or more ingredients 202 for the prepared food items 204 while in-transit to one or more locations providing the prepared food items 204 in the service area based on the predicted future supply need 418 of the one or more ingredients 202 for the prepared food items 204 for at least the service area. Transport vehicles 214 equipped as automated processing or production vehicles may pre-process the ingredients 202 during transit, such as by washing, portioning, cutting, mincing, grinding, pureeing, or otherwise performing processes that advance the ingredients 202 closer to being ready for a cooking process for preparing the food item 204. Such pre-processing may be performed based on the transport instructions 422 provided to the transport vehicle 214. Pre-processing the ingredients 202 in transit saves time and manpower that would otherwise be consumed at a different location (e.g., at the ingredient producer 212, at the food item provider 216).

The method 600 may further include preparing 616 the food items 204 while in-transit to one or more locations of consumers of the prepared food items 204 using the one or more ingredients 202 for prepared food items 204 based on the predicted future supply need 418 of the one or more ingredients 202 for the prepared food items 204 for at least the service area. The transport vehicles 214 equipped as automated production vehicles may, according to a set of instructions stored in data storage, cook assembled ingredients 202 assembled within the cargo area of the transport vehicle 214 to produce the one or more food items 204. The transport vehicles 214 may, in some implementations, assemble a plurality of ingredients 202 into an uncooked food item 204. The types and amounts of respective types of food items 204 prepared may be specified in the transport instructions 422 or updated transport instructions 422 received in transit.

Cooking parameters for cooking the food items 204 may be specified in the transport instructions 422 (or updates thereto received during transit) and in some implementations, at least some ingredients 202 may pre-processed in transit in connection with preparing the food items 204 during transit. The cooking parameters may specify a temperature, cooking methods, cooking times, ingredients 202 and amounts thereof, preparation steps, or various other information. The cooking information and parameters may be formatted or encoded such that the automated production systems of the transport vehicle 214 can process the information and perform the cooking steps with little to no human intervention. The transport instructions 422 may instruct the transport vehicle 214 regarding a specific times at which the automated production system is to begin cooking the food items 204 so that the food items 204 are ready just before or right as the delivery vehicle 214 arrives at a customer specified location.

The method 600 may further include delivering 616 the one or more ingredients 202 for the prepared food items 204 to one or more locations providing the prepared food items 204 in the service area based on the predicted future supply need 418 of the one or more ingredients 202 for the prepared food items 204 for at least the service area. Delivering the one or more ingredients 202 may be according to the one or more delivery routes 220 determined in 612. Locations providing the prepared food items 204 correspond to the physical supply locations 206 described herein. The future supply need 418 may be used to determine which of the physical supply locations 206 the food items 204 are to be delivered, types and amounts of the food items 204 delivered, as well as delivery times and/or dates for the transport vehicles 214 to arrive.

FIG. 6B shows a method 650 associated with predicting a number of instances of future orders for respective food items 204 predicted to be received during a defined period of time in the future for the service area, according to one or more implementations. The method 600 may be performed by one or more entities of a logistics infrastructure in coordination with the computational system 102 described herein. Various operations performed in the method 650 may be performed as operations or sub operations of the method 800, or otherwise in association with the method 800. Some of the operations described below may be omitted from performance of the method 650.

The method 650 begins at 652 by planting one or more crops to generate one or more ingredients 202 for the one or more prepared food items 204 based on the predicted number of instances of future orders for respective ones of the one or more prepared food items for the service area. For instance, an amount of seeds sufficient to produce a crop sufficient to fulfill the predicted number of instances of future orders may be planted in soil, water, etc. of an indoor or outdoor farm according to production instructions provided by the computational system 102, as described herein.

At 654, the one or more crops grown are harvested to supply one or more ingredients 202 for the one or more prepared food items based on the predicted number of instances of future orders for respective ones of the one or more prepared food items 204 for the service area. The crops are harvested 654 according at least to the ingredient production instructions 420 or updated ingredient production instructions 420, which may specify types of crops to be harvested, and dates or times at which the crops are to be harvested. The method 650 may further include performing 656 post-harvest handling of one or more ingredients 202 for the one or more prepared food items 204 based on the predicted number of instances of future orders for respective ones of the one or more prepared food items 204 predicted to be received during the defined period of time in the future for the service area. Performing post-harvest processing may be performed as described in connection to FIG. 6A and elsewhere herein.

The method 650, at 658, may include pre-processing the one or more ingredients 202 for the one or more prepared food items 204 based on the predicted number of instances of future orders for respective ones of the one or more prepared food items 204 predicted to be received during the defined period of time in the future for the service area. Pre-processing, if performed, is performed according to at least the ingredient production instructions 420 provided, and as described with respect to FIG. 6 and elsewhere herein. At 660 of the method 650, one or more transport vehicles 214 are loaded with one or more ingredients 202 for the one or more prepared food items 204 based on the predicted number of instances of future orders for respective ones of the one or more prepared food items 204 predicted to be received during the defined period of time in the future for the service area. Loading the one or more transport vehicles 214 may be performed according to the transport instructions 422, and as described with respect to FIG. 6A and elsewhere herein.

The method 650 may include determining 662 one or more delivery routes 220 of one or more transport vehicles 214 loaded with one or more ingredients 202 for the one or more prepared food items based on the predicted number of instances of future orders for respective ones of the one or more prepared food items 204 predicted to be received during the defined period of time in the future for the service area. Determining the one or more delivery routes 220 for the one or more transport vehicles 214 may be performed as described above with respect to FIG. 6A and elsewhere herein. Next, the method 650 may include pre-processing 664 one or more ingredients 202 for the one or more prepared food items 204 while the transport vehicles 214 in-transit to one or more locations providing the one or more prepared food items 204 in the service area based on the predicted number of instances of future orders for respective ones of the one or more prepared food items 204 predicted to be received during the defined period of time in the future for the service area. Pre-processing may be performed according to the transport instructions 422 provided to the transport vehicles 214, and as described with respect to FIG. 6A and elsewhere herein.

The method proceeds at 666 by preparing the one or more food items 204 while in-transit to one or more locations of consumers of the one or more prepared food items 204 using one or more ingredients 202 for the one or more prepared food items 204 based on the predicted number of instances of future orders for respective ones of the one or more prepared food items 204 predicted to be received during the defined period of time in the future for at least the first service area. Preparing the one or more food items 204 while in-transit may be performed by automated production robotics and machinery installed on the transit vehicles 214, and as described above with respect to FIG. 6A and elsewhere herein.

The method 650 may further comprise delivering 668 the one or more ingredients 202 for the one or more prepared food items 204 to one or more locations (e.g., physical supply locations 206, customer specified delivery locations 208) based on the predicted number of instances of future orders for respective ones of the one or more prepared food items 204 predicted to be received during the defined period of time in the future for the service area. Delivery 668 may be performed as described above with respect to FIG. 6A or elsewhere herein.

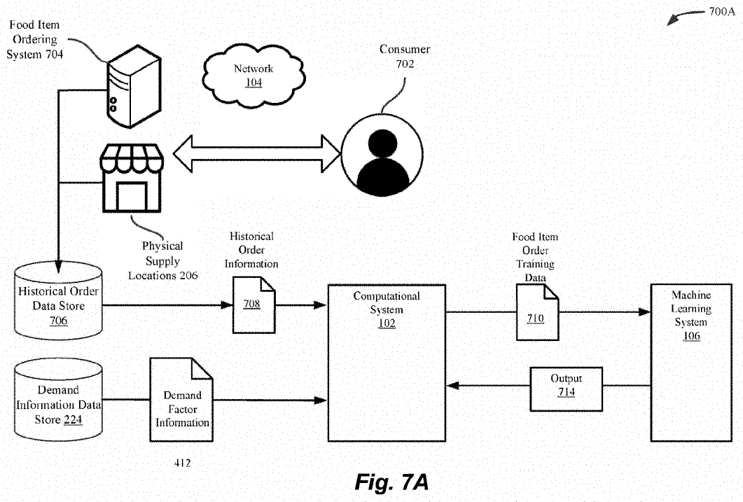

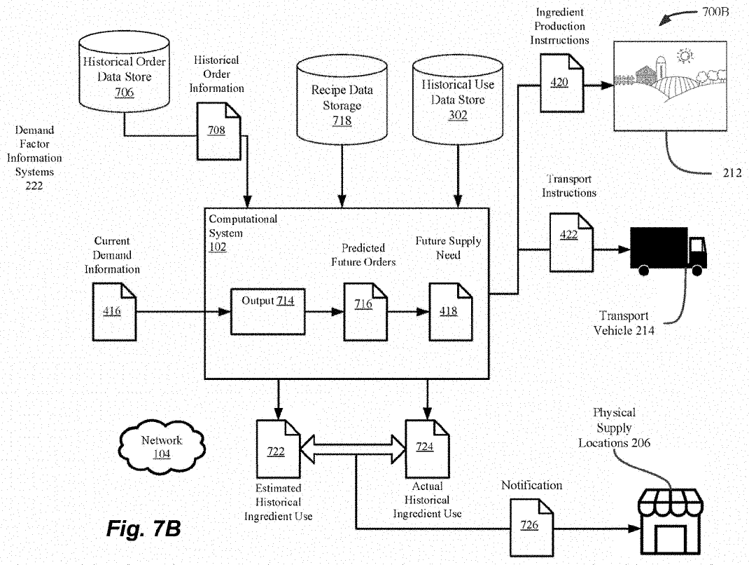

FIG. 7A shows an environment 700A in which the machine learning system 106 is trained at a first time to predict a number of instances of future orders of respective ones of the food items 204 predicted to be received during a defined period of time in the future for at least a service area. The environment 700A may be a sub environment of the environment 100. Consumers 702 may communicate with food item ordering systems 704 or physical supply locations 206 to order instances of food items 204. The food item ordering system 704 are processor-based systems storing instructions that, as a result of execution by processors of the ordering system 704, cause performance of one or more operations described herein. The executable instructions may comprise instructions for presenting a user interface which consumers 702 or workers at the physical supply locations 206 may interact with to place orders for food items 204. The user interface may be presentable via an internet browser or may be included in an application or program stored on a computing device of the consumer 702 (e.g., tablet computer or smartphone). The food item ordering systems 704 may include a communication interface for communicating over the network 104 with consumers 702, physical supply locations 206, and/or delivery vehicles 208. For instance, the food item ordering systems 704 may receive an order placed by a consumer 702 via the user interface and send a communication to a physical supply location 206 in the service area for the consumer 702 to fulfill the order for the food item 204. In some implementations, where the delivery vehicle 208 is an automated production vehicle equipped to prepare one or more food items 204 using robotics and automated equipment, the food item ordering systems 704 may send a communication over the network 104 to the delivery vehicle 208 instructing the automated systems thereof to prepare the food item 204 and deliver the prepared food item 204 to a customer specified location 218.

The food item ordering systems 704 and the physical supply locations 206 may send order information to a historical order data store 706 regarding instances of orders placed for food items 204 by consumers 702 for one or more service areas. The historical order data store 706 may store order information for instances of orders placed for food items 204 for one or more service areas and may be part of or connected to the historical information data store 230 discussed herein. The order information provided to the historical order data store 706 may include information specifying types of food items 204 included in the orders, date and time at which the respective orders were placed, the location where the food item 204 ordered is to be picked up or delivered, information about the customer 702 placing the order (e.g., customer number, address, interests). The order information provided may have a certain format (e.g., delimiter separating instances of information), dimensionality (e.g., number of entry fields), and/or labels indicating a type of food item 204 ordered, time/date field corresponding to the food item 204 order, location of delivery/pick-up, etc.

The computational system 102 may obtain historical order information 708 stored in the historical order data store 706 for training the machine learning system 106. The historical order information 708 obtained by the computational system 102 may be representative of a plurality of instances of orders for the one or more prepared food items 204 for the service area. The historical order information 708 may comprise information regarding orders for one or more types of food items 204 placed by consumers 702 for fulfillment within a service area for a defined period of time. For example, obtaining the historical order information 708 obtained may include obtaining historical order information specifying a total number of instances of orders for the for one or more prepared food items 204 either placed or fulfilled during a defined period of time in the past for at least the service area. Obtaining the historical order information 708 may include obtaining information that, for each respective type of prepared food item 204 of a number of types of prepared food items 204, specifies a respective total number of instances of orders for the respective type of prepared food item 204 either placed or fulfilled during the defined period of time in the past for at least the service area. The historical order information 708 may have classifiers associated with indications of numbers of instances of respective types of food items 204. The historical order information 708 may be a training set comprising a set of inputs each corresponding to an order placed within the service area and specifying an amount of food items 204 in each order in association with a classifier for the type of food item 204. Each of the set of inputs of the training set may be associated with information identifying the time and date at which the order is placed, and may additionally specify other information specific to the consumer 702, the method of ordering, the manner of fulfillment (e.g., delivery, pick-up), etc.

For each respective type of food item 204 for which an instance of an order was either placed or fulfilled during the defined period of time in the past for at least the service area, the computational system 102 may determine which of one or more ingredients 202 for the one or more prepared food items 204 are used in the respective type of prepared food item 204. The computational system 102 may further determine total amounts of the determined one or more ingredients 202 that are used in the respective type of prepared food item 204. In some implementations, a recipe data store may store information regarding recipes for preparing respective ones of the food items 204, the recipe information specifying types, amounts, and preparations (e.g., sliced, diced, minced) for ingredients 202 used in preparation of each food item 204.

The computational system 102 may obtain demand factor information 412 for training the machine learning system 106. The demand factor information 412 may include economic indicator information, event or activity information, and/or other information representing one or more factors attributed to affecting, predicting or being related to demand for the food items 204 in the service area. The demand factor information 412 obtained may correspond to one or more defined periods of time and service areas for the historical order information 708. As one example, for a historical use entry in the historical order information 708. corresponding to a time T1 and service area A1, demand factor information 412 for a time period including or before the time T1 for the service area A1 may be included in or associated with the historical food item order entry. The machine learning system 106 can therefore be trained to correlate new demand factor information with a number of instances of future orders for food items 204 that are predicted to be received during a defined period of time in the future for the service area. The machine learning system 106 is trained to predict, or otherwise produce an output 714 useable to predict, a number of instances of future orders of respective ones of the food items 204 that are predicted to be received during a future time period for a service area. The training of the machine learning system 106 is achieved by processing the food item order training data 710 comprising historical order information 708 and demand factor information 412. The computing system 102 may train the machine learning system 106 using one or more machine learning models provided or specified by the computing system 102, as described above with respect to FIG. 4A. Examples of such models include decision tree learning systems, support vector machine systems, artificial neural network systems, clustering systems, and Bayesian network system models.

As one example of training, the machine learning system 106 may be trained using a training set Si containing historical food item order information 708 and demand factor information 412 for a specific service area A1 and a defined period of time T1. The machine learning system 106 may be trained to optimize the accuracy and precision of predicting a number of instances of future orders for respective ones of one or more prepared food items 204 received for the service area A1 during the defined period of time T1. The machine learning system 106 may initially set weights and biases for parameters of a machine learning model to predetermined or random values. Such parameters correspond to events, economic indicators, dates, times, weather conditions, or other demand factors attributed to affecting, predicting or being related to the demand for prepared food items 204, as described herein. Via optimization methods (e.g., gradient descent algorithms), the machine learning system 106 may optimize the machine learning model by iteratively reducing error in weights and biases for the parameters using test cases included in the food item order training data 710, such as test cases for the historical order information 708. After the initial training of the machine learning system 106 to predict a number of instances of future orders for respective ones of the food items 204, the machine learning system 106 may receive further training using updated historical order information 708 and updated demand factor information 412. The accuracy and precision of the predicted number of instances of orders for food items 204 may therefore be further improved or adjusted over time according to changing demand factors for the service area.

As a result of being trained, the machine learning system 106 may predict, or generate an output 714 useable to predict, a number of instances of orders for food items 204 for at least the service area. FIG. 7B shows an environment 700B in which, at a second time after the first time of environment 700A, a number of instances of future orders 716 for respective ones of the one or more prepared food items 204 is predicted to be received during a defined period of time in the future for at least the service area via the machine learning system 106 at a second point in time after the first point in time depicted and described with respect to FIG. 7A. The number of instances of future orders for food items 204 is predicted by the computational system 102 using current demand information 416 obtained from one or more sources of demand factor information, such as the sources of event data 138 or sources of economic indicator data 140 described above. The current demand information 416 represents one or more demand factors attributed to affecting, predicting or being related to demand for one or more food items 204 for the service area. The current demand information 416 may be indicative of demand for one or more of the food items 204 in the service area based at least in part on current or recent conditions related to the service area. The factors attributed to affecting, predicting, or being related to demand for the one or more food items 204 include one or more of: a particular time of day, a particular time of week, a particular time of month, a particular time of year; a particular day of week, a particular day of month, a particular day of year, a particular week of month, particular week of year, a particular month of year, a particular event, a particular holiday, a concert, a festival, a particular recurring event, a particular recurring sporting event, a particular recurring community event, a particular season, one or more economic indicators, retail sales, employment and labor market statistics, current stage of economic cycle, personal income, demographics, home prices and/or sales, Gross Domestic Product (GDP), Money Supply (M2), Consumer Price Index (CPI), Producer Price Index (PPI) and Consumer Confidence Survey, one or more factors specific to the service area, or one or more factors attributed to affecting or predicting demand specifically in the service area. Training the machine learning system 106 to generate predicted future orders 716 for a particular service area is beneficial at least because a set of demand factors that affect or are useful in predictions for one service area may not be as accurate or precise as a second set of demand factors for another service area. In other words, a trained machine learning system 106 for one service area may not be as effective at predicting future supply need 418 for another service area at least because certain demand factors may affect some service areas more than others. Accordingly, training machine learning systems 106 for specific service areas, as described herein, allows for more accurate and precise prediction of a number of instances of future orders for food items 204.

The computational system 102, via the trained machine learning system 106, may predict a future supply need 418 of ingredients 202 for the service area using the predicted future orders 716 for food items 204. In particular, based on the number of instances of predicted orders for respective ones of the food items 204, the computational system 102 may determine a respective total number of instances of orders for the respective type of prepared food items 204 either placed or fulfilled during the defined period of time for the service area. The computational system 102 may obtain recipe information from a recipe data store 718 storing information specifying the types and amounts of ingredients 202 sufficient to produce each instance of food item 204. The computational system 102 may determine the future supply need 418 for ingredients 202 of respective food items 204 by, for each food item 204 predicted, multiplying the amounts of each ingredient 202 specified in the recipe information by the number of instances food items 204 predicted to be ordered. The future supply need 418 is useable to predict amounts of the ingredients 202 that will be needed to fulfill orders for food items 204 at a defined time in the future for the services area. Based on the future supply need 418, the computational system 102 may send ingredient production instructions 420 specifying instructions for, e.g., planting, growing, and harvesting types and amounts of ingredients 202, as described above with respect to FIG. 4B. The computational system 102 may also send transport instructions 422 specifying instructions for transporting and preparing ingredients 202 to service areas based on the future supply need 418 predicted, also discussed above with respect to FIG. 4B.

The computational system 102 may also perform one or more actions based on a comparison of estimated past usage of ingredients 202 to estimated past usage of ingredients 202. The computational system 102 may obtain, from the historical use data store 302 described with respect to FIG. 3, for example, historical order information 708 representative of historical orders for one or more prepared food items 204 for a defined period of time in the past. Based on the historical order information 708, the computational system 102 may generate estimated historical ingredient use information 722 representative of amounts of estimated use of the ingredients 202 for the defined period of time in the past. The estimated use information 722 may be generated, for instance, by multiplying amounts of respective ingredients 202 specified in recipes for producing the food items 204 by the number of orders for food items 204 in the period of time in the past. The estimated use information 722 may specify estimated ingredient 202 usage on a food item 204 ordered basis or a total estimated amount of ingredient 202 used for all the food item 204 orders in the defined period of time in the past. The estimated use information 722 may specify use for individual ingredient using entities 406 in the service area, such as a single store or automated production delivery vehicle, or for a plurality of entities 406 in the service area. The computational system 102 may obtain, from the historical use data store 302, actual historical use information 724 specifying amounts of respective ingredients 202 recorded as being used by one or more ingredient using entities 406 for the defined period of time in the past.

The computational system 102 may compare the estimated historical ingredient use 722 with the actual historical ingredient use 724 to determine whether there is a variance therebetween. A variance is an amount, for respective ingredients 202, that the actual historical ingredient use 724 differs from the historical ingredient use 722 for the period of time in the past and for the same ingredient using entities 406. The computational system 102 may, for the respective ingredients 202, compare the actual historical ingredient use 724 with the estimated historical ingredient use 722 to determine the variance therebetween—for example, by subtracting the estimated historical ingredient use 722 from the actual historical ingredient use 724. If the variance exceeds a defined threshold value for the ingredient 202 for a corresponding period of time, the computational system 102 may determine that there is an indication of significant divergence in usage for the ingredient 202. As one example, the computational system 102 may evaluate whether the estimated historical ingredient use 722 exceeds the actual historical use 724 and, as a result of determining that the estimated historical ingredient use 722 exceeds the actual historical use 724 by a threshold amount, determine that a possible significant divergence in ingredient 202 usage has occurred. This may reflect a condition that the usage of ingredients 202 is less than specified, potentially resulting in food items 204 that do not meet consumer expectations. As another example, the computational system 102 may evaluate whether the actual historical ingredient use 724 exceeds the estimated historical use 722 and, as a result of determining that the actual historical ingredient use 724 exceeds the estimated historical use 722 by a threshold amount, determine that a possible significant divergence in ingredient 202 usage has occurred. This reflects a condition wherein excessive amounts of ingredient 202 is used to prepare the food item 204, potentially resulting in diminished profits, excessive cost, or stressing production of the ingredients 202. The defined threshold difference amounts may be values stored in memory for respective ones one or more of the ingredients 202 that define thresholds for a period of time that, if actual use of an ingredient 202 exceeds estimated use of the ingredient 202 by an amount greater or equal to the value, cause the computational system 102 to determine that a significant divergence has occurred for usage of the ingredient 202. For example, for a defined threshold of 0.5 gallons in a single day for tomato sauce, if the estimated historical ingredient use 722 for tomato sauce for a defined period of time in the past is 5 gallons, but the actual ingredient use 724 is 6 gallons, the computational system 102 may determine that a variance has occurred.

The computing system 102 may predict the future supply need 418 of one or more ingredients 202 based on the variance determined for one or more entities preparing the food items 204. Predicting the future supply need 418 based on the variance may be for a time period after the defined time period in the past corresponding to the estimated and historical ingredient use. The machine learning system 106 may be trained using the variance between the actual historical ingredient use 724 and the estimated historical ingredient use 722. Taking into account the variance between estimated historical ingredient use 722 and actual historical ingredient use 724 may help the machine learning system 106 to more accurately predict future supply need 418 for the one or more ingredients 202 for the service area.

In response to determining a significant divergence in ingredient 202 usage in preparing the food items 204 based on the comparison, the computational system 102 may perform one or more actions. One action performed by the computing system 102 may be to communicate an indication that possible significant divergence from the recipes for the one or more prepared food items 204 has occurred during the past period of time. The indication may be sent to corresponding preparers of food items 204, such as physical supply locations 206, notifying the entity to the possibility that amounts of ingredient 202 used to prepare the food items 204 exceed amounts specified in recipes for the food items 204, or that ingredient 202 is otherwise being wasted. For instance, the computing system 102 may generate a notification 726 listing a set of ingredients 202 and indicating usage for ingredients 202, if any, that exceeds estimated historical usage.

Predicting the number of instances of future orders for food items 204 predicted to be received during a period of time in the future for the service area may include operating the trained machine learning system 106 to predict the predicted number of instances of future orders for respective ones of the one or more prepared food items 204 based on input that includes current information that represents the one or more various factors attributed to affecting, predicting or being related to demand for the one or more prepared food items 204. As an illustration, the trained machine learning system 106 or output 714 provided by the machine learning system 106 as a result of training may receive current demand information 416 representing events, economic indicators, information regarding date/time, demographics, or other information representing one or more factors attributed to affecting or predicting demand specifically in the service area. Based on the current demand information 416, the trained machine learning system 106 or output 714 may process the current demand information 416 to predict, for the service area, the number of instances of orders for one or more food items 204 at a defined period of time in the future, such as a particular date or week in the future. Predicting may include generating values indicative of the predicted number of instances of future orders for respective ones of the one or more prepared food items 204 predicted to be received during the defined period of time in the future for the service area based on the current demand information 416 that represents the one or more various factors attributed to affecting, predicting or being related to demand for the one or more prepared food items 204. As described above, the values for the predicted future orders of food items 204. Based on the predicted future orders 716 and/or the future supply need 418, the computational system 102 may provide ingredient production instructions 420 instructing the ingredient producers 212, inter alia, on amounts and types of the one or more ingredients 202 to plant, grow, and harvest, as described above with respect to FIGS. 4B and 6. Moreover, the computing system 102 may provide transport instructions 422 regarding ingredients 202 to be loaded onto the transport vehicles 214, routes the transport vehicles 214 are to take to deliver the ingredients 202, and how the ingredients 202 should be processed in route, as also described above with respect to FIGS. 4B and 6.

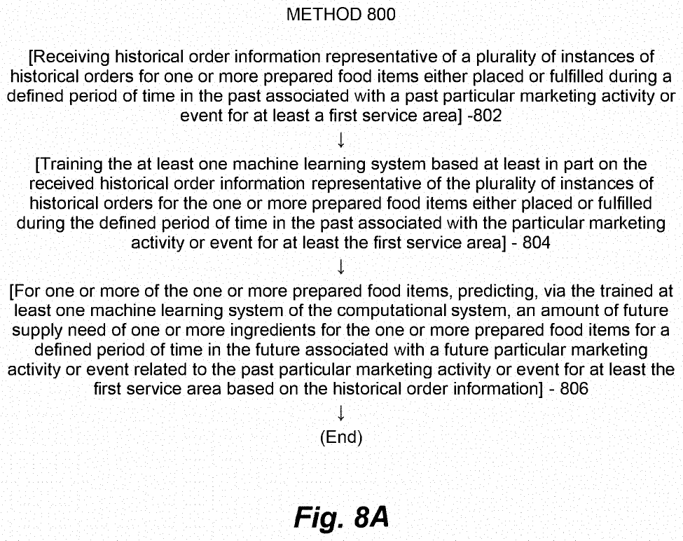

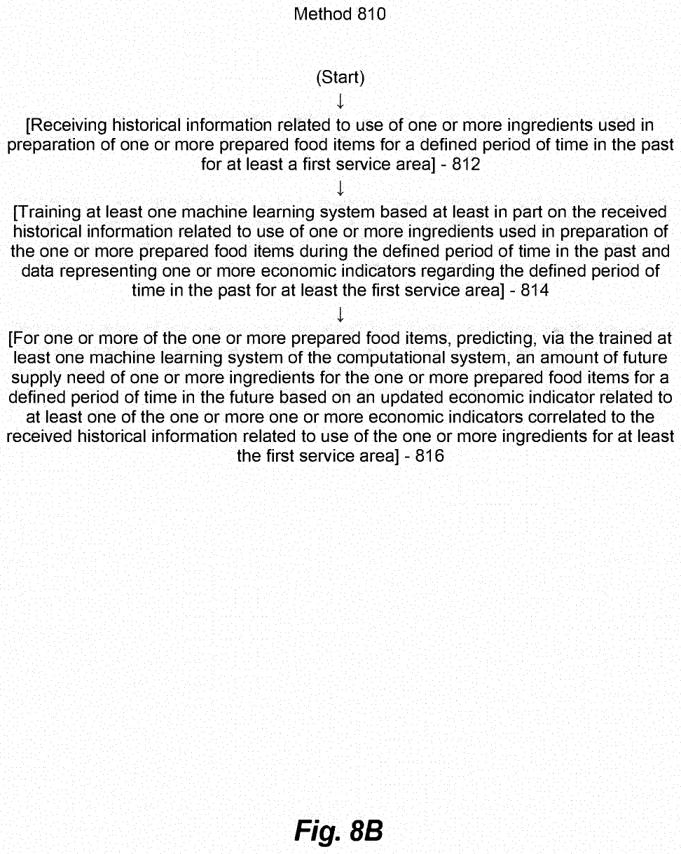

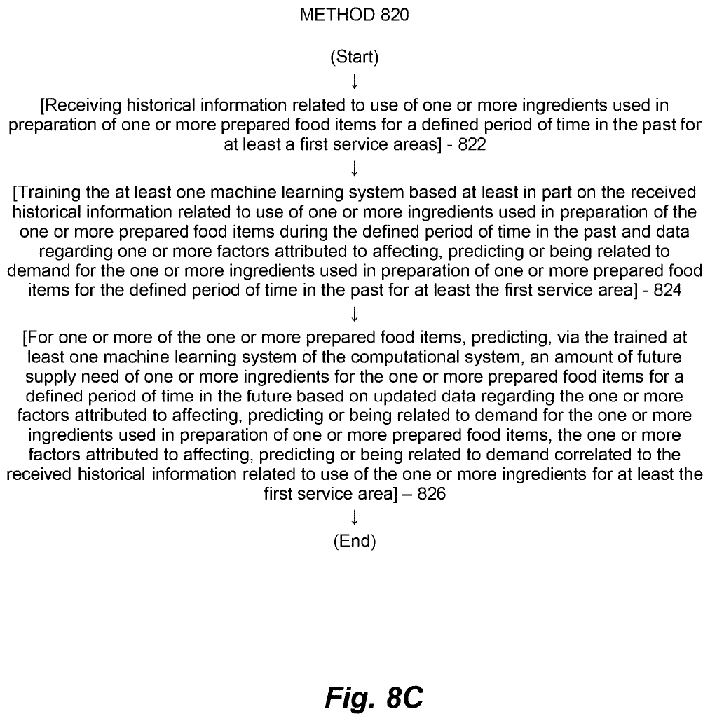

The methods discussed below in FIGS. 8A-19 may be performed as a part of or in association with the methods 500 and 600 described herein, along with other methods described below. The methods may be performed by one or more appropriate entities described herein, such as the computational system 102 and/or the machine learning system 106. Performance of the methods described may also involve aspects the environment 700 described above with respect to FIGS. 7A and 7B.

FIG. 8A illustrates a method 800 for predicting an amount of future supply need of one or more ingredients for one or more prepared food items for a defined period of time in the future associated with a future particular event. At 802, the method performs receiving historical order information representative of a plurality of instances of historical orders for one or more prepared food items either placed or fulfilled during a defined period of time in the past associated with a past particular event for at least a first service area.

At 804, the method performs training the at least one machine learning system based at least in part on the received historical order information representative of the plurality of instances of historical orders for the one or more prepared food items either placed or fulfilled during the defined period of time in the past associated with the particular r event for at least the first service area.

At 806, the method performs, for one or more of the one or more prepared food items, predicting, via the trained at least one machine learning system of the computational system, an amount of future supply need of one or more ingredients for the one or more prepared food items for a defined period of time in the future associated with a future particular event related to the past particular marketing activity or event for at least the first service area based on the historical order information.

FIG. 8B illustrates a method 810 for predicting supply need for ingredients based on economic indicators. At 812, the method 810 performs receiving historical information related to use of one or more ingredients used in preparation of one or more prepared food items for a defined period of time in the past for at least a first service area.

At 814, the method 810 performs training at least one machine learning system based at least in part on the received historical information related to use of one or more ingredients used in preparation of the one or more prepared food items during the defined period of time in the past and data representing one or more economic indicators regarding the defined period of time in the past for at least the first service area.

At 816, the method 810 performs, for one or more of the one or more prepared food items, predicting, via the trained at least one machine learning system of the computational system, an amount of future supply need of one or more ingredients for the one or more prepared food items for a defined period of time in the future based on an updated economic indicator related to at least one of the one or more one or more economic indicators correlated to the received historical information related to use of the one or more ingredients for at least the first service area.

FIG. 8C is a method 820 for predicting demand for ingredients using machine learning. At 822, the method 820 performs receiving historical information related to use of one or more ingredients used in preparation of one or more prepared food items for a defined period of time in the past for at least a first service area.

At 824, the method 820 performs training the at least one machine learning system based at least in part on the received historical information related to use of one or more ingredients used in preparation of the one or more prepared food items during the defined period of time in the past and data regarding one or more factors attributed to affecting, predicting or being related to demand for the one or more ingredients used in preparation of one or more prepared food items for the defined period of time in the past for at least the first service area. At 826, the method 820 performs, for one or more of the one or more prepared food items, predicting, via the trained at least one machine learning system of the computational system, an amount of future supply need of one or more ingredients for the one or more prepared food items for a defined period of time in the future based on updated data regarding the one or more factors attributed to affecting, predicting or being related to demand for the one or more ingredients used in preparation of one or more prepared food items, the one or more factors attributed to affecting, predicting or being related to demand correlated to the received historical information related to use of the one or more ingredients for at least the first service area.

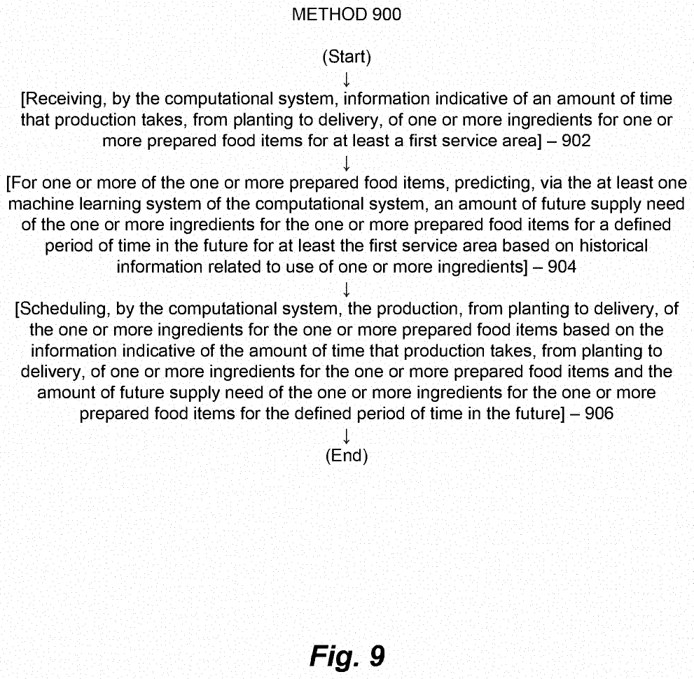

FIG. 9 is a method 900 for scheduling the production, from planting to delivery, of one or more ingredients for one or more prepared food items according to another embodiment. At 902, the method 900 performs receiving information indicative of an amount of time that production takes, from planting to delivery, of one or more ingredients for one or more prepared food items for at least a first service area.

At 904, the method 900 performs, for one or more of the one or more prepared food items, predicting, via at least one machine learning system of the computational system, an amount of future supply need of the one or more ingredients for the one or more prepared food items for a defined period of time in the future for at least the first service area based on historical information related to use of one or more ingredient.

At 906, the method 900 performs scheduling the production, from planting to delivery, of the one or more ingredients for the one or more prepared food items based on the information indicative of the amount of time that production takes, from planting to delivery, of one or more ingredients for the one or more prepared food items and the amount of future supply need of the one or more ingredients for the one or more prepared food items for the defined period of time in the future.

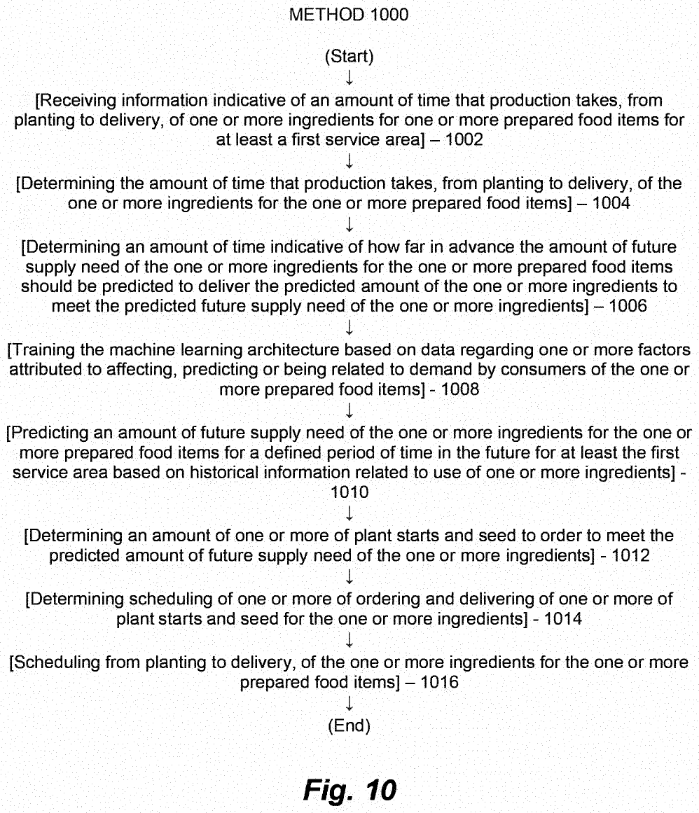

FIG. 10 shows a method 1000 for scheduling the production, from planting to delivery, of the one or more ingredients 202 for the one or more prepared food items 204 according to one or more implementations. Various operations of the method 1000 may be performed in a different sequence than illustrated in or described with respect to FIG. 10—for example, training the machine learning system 106 may be performed as an initial step instead of another operation. The method 1000 begins by receiving 1002 information indicative of an amount of time that production takes, from planting to delivery, of one or more ingredients 202 for one or more prepared food items 204 for at least a service area. The information received in 1002 may comprise information received from different sources, and may comprise information indicative of an amount of time that individual operations in production take including planting, growing, harvesting, post-harvest operations, loading, transit, processing, delivery, and cooking. Instances of information may be specific to individual types of ingredients 202. Receiving 1002 the information may include, for example, receiving information indicative of an amount of time that planting and growing takes of one or more ingredients 202. Receiving the information may include receiving information indicative of an amount of time that harvesting takes of one or more ingredients 202, and/or information indicative of an amount of time that loading of the ingredients 202 or delivery of the ingredients 202 takes. The information may comprise separate information respectively regarding planting, growing, harvesting, delivery, etc.

At 1004, the computational system 102 determines an amount of time that production takes, from planting to delivery, of the one or more ingredients 202 for the one or more prepared food items 204. Determining the amount of time that production takes may be based on the information received in 1002. For instance, the information may indicate that, for a specific ingredient 202, planting the ingredient 202 takes a time period T1, growing takes a time period T2, harvesting takes a time T3, etc. The information may be dependent on various factors related to temperature, weather, soil, humidity, etc.—the information may, for example, indicate that for certain temperatures and certain levels of humidity, the amount of time an ingredient 202 takes to grow may vary. The computational system 102 may determine an amount of time that production takes by identifying appropriate conditions in the information received 1002 and aggregating the amounts of time for each stage of production.

At 1006, the computational system 102 may determine an amount of time indicative of how far in advance a future supply need 418 should be predicted to deliver the one or more ingredients 202 in time to meet a predicted future supply need 418 of the one or more ingredients 202. The determination of how far in advance the future supply need 418 should be predicted may be based at least in part on the information indicative of the amount of time that production takes of the one or more ingredients 202. The determination of the amount of time indicative of how far in advance the future supply need 418 should be predicted may, for example, be at least the amount of time for which production of the one or more ingredients 202 is determined as taking. This allows the prediction of future supply need 418 at a time far enough in advance that an appropriate amount of the ingredients 202 can be produced in time to meet the future supply demand 418. Determining 1004 the amount of time indicative of how far in advance the amount of future supply need 418 should be predicted, in some implementations, includes determining the amount of time production will take based on one or more controlled factors related to growth of one or more plants that supply the ingredients. A controlled factor related to growth is one that can be selectively controlled by or at an ingredient producer 212. A growing environment of the ingredient producer 212 may be equipped with various environmental control systems operable to control factors affecting growth of one or more ingredients 202. Such controlled factors include amount of oxygen, amount of carbon dioxide, amount of water, type of watering system, amount of nutrients, concentration of nutrients, nutrient pH level, how nutrients are delivered, amount of light intensity, spectrum of light; intervals of light, amount of humidity, amount of fertilizers, temperature, and amount of ventilation. The amount of time indicative of how far in advance may be based on how quickly ingredient 202 can be grown based on the environmental control systems possessed by the ingredient producer 212 and how much control factors can accelerate or otherwise affect growth. In some implementations, determining 1006 how far in advance the amount of future supply need 418 should be predicted includes determining the amount of time production will take based on one or more uncontrolled factors.

The machine learning system 106 is trained 1008 to predict a future supply need 418 of one or more of the ingredients 202 of the prepared food items 204, as described elsewhere herein. The machine learning system 106 may be trained based on data regarding one or more factors attributed to affecting, predicting or being related to demand for the one or more ingredients used in preparation of one or more prepared food items and/or historical ingredient use information 402. Such training may involve one or more of supervised machine learning, semi-supervised machine learning, unsupervised machine learning, recognizing underlying patterns in data, identifying latent variables, and performing machine learning optimization processes, as described above with respect to FIG. 10 and elsewhere herein. Training the machine learning system 106 may include correlating historical information related to amounts of time that harvesting has taken of plants that supply one or more ingredients 202 for one or more prepared food items for at least the service area with the demand factor information 412 representative of one or more factors attributed to affecting, predicting or being related to amounts of time that harvesting takes of the plants that supply one or more ingredients 202 for one or more prepared food items for at least the service area.

Next, at 1010, the method 1000 comprises for one or more of the one or more prepared food items 204, predicting, via the at least one machine learning system 106, an amount of future supply need 418 of the one or more ingredients 202 for the one or more prepared food items for the service area. Such prediction may be based on data representative of more factors attributed to affecting, predicting or being related to demand for the one or more ingredients 202 used in preparation of one or more prepared food items 204. Such data may be current demand factor data for which the computational system 102 is able, via the trained machine learning system 106, to predict future supply need at a defined point in the future. Predicting the amount of future supply need 418 may be for a defined period of time in the future based on one or more of generating a posterior probability distribution based on the historical ingredient use information 402, generating a prior probability distribution based on the historical ingredient use information 402 and demand factor information 412, and performing a classification of one or more pieces of the historical use information 402.

At 1012, the computational system 102 determines an amount of one or more of plant starts and/or seed to order to meet the predicted amount of future supply need 418 of the one or more ingredients 202 for the one or more prepared food items 204 for the defined period of time in the future. Plant starts, as referred to herein, correspond to seedlings or young plants, typically between two to six weeks old that are sold in nursery pots or some similar container to another entity for growing the plant to maturity. Determining the amount of seed and/or plant starts may be based on information indicative of an amount of each ingredient 202 that should be yielded per seed or plant start.

At 1014, the computational system 102 schedules one or more of ordering and delivering of one or more of plant starts and seed for the one or more ingredients 202 based on the information indicative of the amount of time that production takes, from planting to delivery, of the one or more ingredients 202 for the one or more prepared food items 204 to meet the predicted amount of future supply need 418. The seeds and/or plant starts may be scheduled based on an amount of time sufficient to plant, grow, and harvest the plants resulting from the seeds or plant starts in time to meet the future supply need 418. Scheduling may include identifying a source for supplying the seeds and/plant starts, and determining a date on which an order is to be generated and sent, by the computational system 102, to an appropriate supplier to provide a specified amount of seeds. Scheduling may include storing, in memory, a set of instructions that as a result of execution cause the computing system to send an order, on the scheduled date, for the amount of seeds and/or plant starts determined to the supplier identified.

The method 1000 includes scheduling 1016 from planting to delivery, of the one or more ingredients 202 for the one or more prepared food items 204. Scheduling includes identifying dates on which specific events related to the one or more ingredients 202 should occur and storing, in memory, data that indicates the dates. The computing system 102, for the dates specified in memory, may provide a communication to an ingredient provider 212 computing device causing a notification to be presented instructing performance of a task. For instance, the notification may instruct an appropriate farmer for the ingredient provider 212 to plant a specified amount of seeds for a particular ingredient 202 on a certain date. Scheduling may include storing data specifying dates and events for one or more of the ingredients, the events including one or more of: planting seeds and/or plant starts for one or more ingredients 202; harvesting one or more ingredients, postharvest processes to be performed on one or more ingredients 202; loading one or more ingredients 202 onto transport vehicles 214; estimated arrival to a service area; offloading of one or more ingredients 202, and other events related to the ingredients 202 described herein. Scheduling 1016 may include determining amounts of the seeds or plant starts to be planted, amounts of crops to be harvested, amounts of crops for post-harvest processing, amounts of the ingredients 202 to be pre-processed, amounts of the ingredients 202 to be delivered.

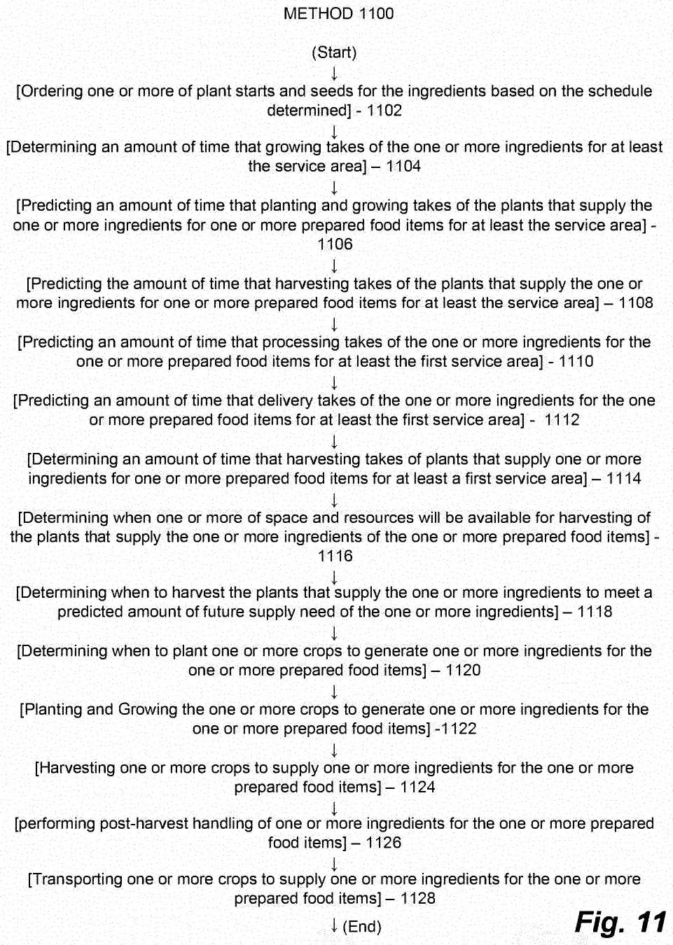

FIG. 11 shows a method 1100 of growing and transporting one or more ingredients 202 to fulfill a predicted future supply need 418 according to one or more embodiments. The processes described with respect to the method 1100 may be parts of the method 800 or other methods described herein. The processes in method 1100 may also be performed in addition to the method 800 or other methods described herein. The method 1100 begins by ordering 1102 amounts of one or more plant starts or seeds to order to meet the predicted future supply need 418 for the one or more ingredients at a defined time in the future. Ordering 1102 may be performed as a result of the determination of scheduling 814 performed in the method 800.

Next, the method 1100 proceeds by determining 1104 an amount of time that growing takes of the one or more ingredients 202 for the service area to meet the future supply need 418 at the future point in time. Determination 1104 of the amount of time may be based on the information received in 802 and may be indicative of an amount of time that production takes.

At 1106, the method 1100 comprises predicting 1106 an amount of time that planting and growing takes of one or more ingredients 202 for one or more prepared food items 204 for the service area. Predicting 1106 may be based on historical information indicating amounts of time that planting or growing of crops supplying the ingredients 202 has taken at times in the past, as well as data representative of factors affecting or relating to planting and growing, such as environmental conditions, soil conditions, manpower used to plant and/or grow, etc.

At 1108, the method includes predicting, via the trained machine learning system 106, the amount of time that harvesting takes of the plants that supply the one or more ingredients for one or more prepared food items for the service area. Predicting may include providing information to the trained machine learning system 106 indicating one or more of an amount of seed or plant starts for respective ingredients 202 planted manpower and equipment available for harvesting, types of equipment available, date projected for harvesting, etc.

The method 1100 may include predicting 1110 an amount of time that processing takes of the one or more ingredients 202 for the one or more prepared food items 204 for the service area. Predicting 1110 the amount of time processing takes may be based on historical information indicating amounts of time that processing of the ingredients 202 has taken at time(s) in the past and data regarding one or more factors representative of conditions affecting or relating to processing, such as the amount of ingredient 202 to be processed, equipment and manpower available for processing, or other such factors.

The method may include predicting 1112, via the trained machine learning system 106, an amount of time that delivery takes of the one or more ingredients 202 for the one or more prepared food items 204 for the service area. Predicting 1112 the amount of time that delivery takes may be based on historical information regarding actual time taken for delivery and data representative of one or more factors affecting or relating to delivery or travel in or to the service area. Such factors affecting or relating to delivery may include weather, events, time of day, day of week, traffic conditions, season, day of year, etc.

The method 1100 may comprise determining 1114 an amount of time that harvesting takes of plants that supply one or more ingredients 202 for one or more prepared food items 204 for the service area. The amount of time that harvesting takes may be determined 1114 by the computational system 102 based on the predicted amount of time harvesting takes of the plants that supply the one or more ingredients 202 for the one or more prepared food items 204 for the service area. The determination 1114 of the amount of time that harvesting takes may be based on the predicted amount of future supply need 418. The determination 1114 of the amount of time harvesting takes may include, for each ingredient 202 of the one or more ingredients 202 determined, receiving information indicative of different amounts of time that harvesting takes to harvest corresponding different amounts of plants that supply the ingredients 202. The determination 1114 may include determining an amount of time that harvesting takes of plants that supply the ingredient 202 to meet the predicted amount of future supply need 418 of the ingredient 202 based on the information indicative of different amounts of time that harvesting takes to harvest corresponding different amounts of plants that supply the ingredient 202.

The process 1100 may further include determining 1116 when space and resources will be available for harvesting of the plants that supply the one or more ingredients 202 of the one or more prepared food items 204 based on a harvesting schedule of other plants for one or more other ingredients 202 of the one or more ingredients to meet a predicted amount of future supply need 418 of the one or more other ingredients 202. The computational system 102 may evaluate how long it will take for workers and equipment to harvest plants for other ingredients 202 according to a set or tentative harvesting schedule for harvesting ingredients 202.

Via the trained machine learning system 106, the process may include determining 1118 when to harvest the plants that supply the one or more ingredients 202. The determination 1118 of when to harvest the plants may be based on one or more of harvesting techniques to be used for the plants that supply the one or more ingredients 202; one or more farming techniques to be used for the plants that supply the one or more ingredients 202; which of the plants that supply the one or more ingredients 202 are to be farmed indoors; which of the plants that supply the one or more ingredients 202 are to be farmed by hydroponics; which of the plants that supply the one or more ingredients 202 are to be farmed by aeroponics; space available to farm the plants that supply the one or more ingredients 202; space available to harvest the plants that supply the one or more ingredients 202; equipment to be used to harvest the plants that supply the one or more ingredients 202; resources available to farm the plants that supply the one or more ingredients 202; space available to harvest the plants that supply the one or more ingredients 202; resources to be used to harvest the plants that supply the one or more ingredients 202; equipment to be used to farm the plants that supply the one or more ingredients 202; equipment to be used to harvest the plants that supply the one or more ingredients 202; growth rates of the plants that supply the one or more ingredients 202; a season during which the plants that supply the one or more ingredients 202 are to be grown; variables that affect harvesting time of the plants that supply the one or more ingredients 202; and variables that affect growth of the plants that supply the one or more ingredients 202. Determining 1118 when to harvest the plants may further be based on one or more controlled factors related to growth of the plants that supply the one or more ingredients 202, as described above with respect to Figure and elsewhere. Determining 1118 when to harvest the plants may further be based on one or more uncontrolled factors related to growth of the plants that supply the one or more ingredients 202, as described above with respect to FIG. 8 and elsewhere. Determining 1118 when to harvest the plants that supply the one or more ingredients 202 may be based on the prediction 1106 of the amount of time that planting takes of crops for supplying the one or more ingredients 202, the prediction 1106 of the amount of time growing takes of the crops supplying the one or more ingredients 202, or other predictions.

The method 1100 may include determining 1120 when to plant one or more of plant starts and seed for the one or more ingredients 202 to meet the predicted amount of future supply need 418 of the one or more ingredients 202 for the one or more prepared food items 204 for the defined period of time in the future. Determining 1120 may be based on the determined 1114 amount of time that harvesting takes of the one or more ingredients 202 for the one or more prepared food items 204 for the service area. Determining 1120 when to plant may be based on a determination of an amount of time that planting and growing takes of one or more ingredients for the service area.

Once the seeds and/or plant starts are received, the method 1100 proceeds in planting and growing 1122 one or more crops to generate one or more ingredients 202 for the one or more prepared food items 204. Planting and growing 1122 may be performed according to a schedule determined in 816 of the method 800. The date at which seeds or plant starts are planted at an ingredient producer 212, which ingredients 202 are planted, and amounts of seeds or plant starts may be performed according to the schedule, which is determined to meet the future supply need 418 described above.

The method may further include harvesting 1124 the one or more crops to supply the one or more ingredients 202 at the time determined in 1118 and as described elsewhere herein. Then the method may include performing postharvest handling 1126 of the harvested ingredients 202 as described herein. Finally, the one or more crops may be transported 1128 to one or more destinations, which may include loading, in-transit processing, and delivery of the ingredients 202.

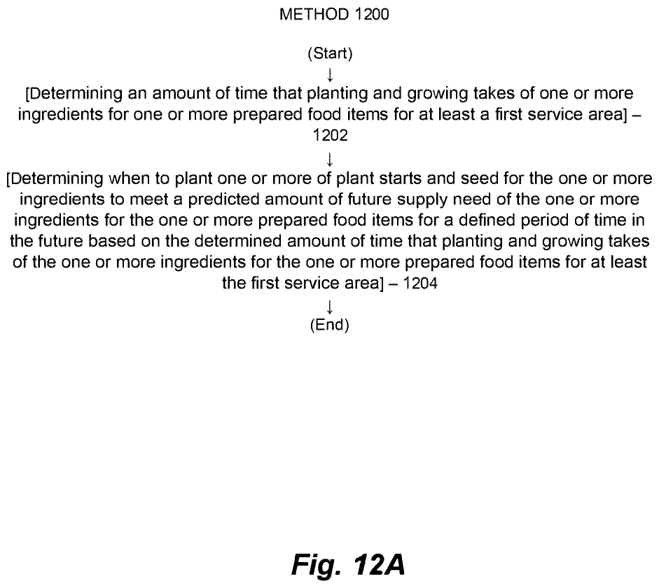

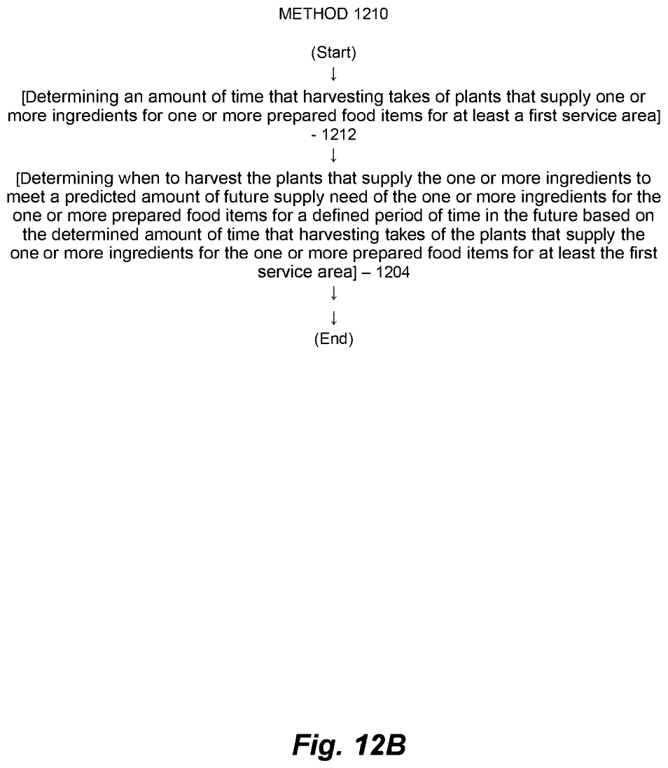

FIG. 12A is a method 1200 of determining when to plant one or more of plant starts and seed for the one or more ingredients to meet a predicted amount of future supply need. At 1202, the method 1200 performs determining an amount of time that planting and growing takes of one or more ingredients for one or more prepared food items for at least a first service area.

At 1204, the method 1200 performs determining when to plant one or more of plant starts and seed for the one or more ingredients to meet a predicted amount of future supply need of the one or more ingredients for the one or more prepared food items for a defined period of time in the future based on the determined amount of time that planting and growing takes of the one or more ingredients for the one or more prepared food items for at least the first service area.

FIG. 12B is a method 1210 for determining when to harvest plants that supply the one or more ingredients to meet a predicted amount of future supply need. At 1212, the method 1210 performs determining an amount of time that harvesting takes of plants that supply one or more ingredients for one or more prepared food items for at least a first service area.

At 1214, the method 1210 performs determining when to harvest the plants that supply the one or more ingredients to meet a predicted amount of future supply need of the one or more ingredients for the one or more prepared food items for a defined period of time in the future based on the determined amount of time that harvesting takes of the plants that supply the one or more ingredients for the one or more prepared food items for at least the first service area.

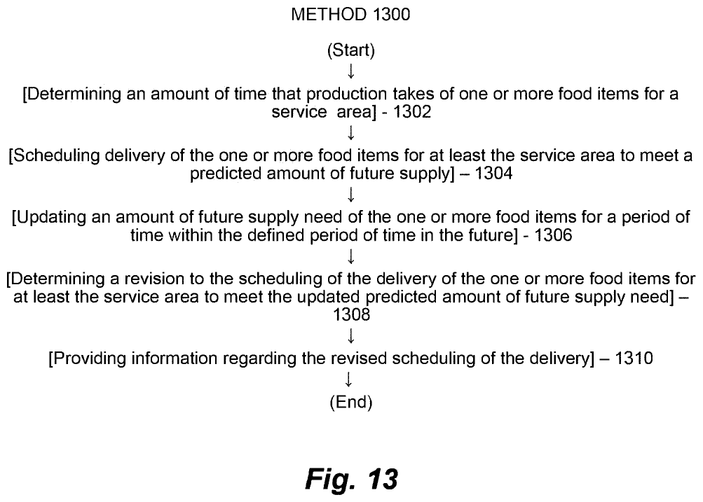

FIG. 13 shows a method 1300 of scheduling and revising a schedule of delivery of one or more food items 204 to meet an updated predicted amount of future supply need 418 according to one or more implementations. The method comprises determining 1302 an amount of time that production takes of one or more food items 204 for the service area. Determining 1302 may include determining an amount of time that it takes to assemble amounts of ingredients 202 into uncooked food items 204 according to recipes provided from a recipe data store, and determining an amount of time that cooking takes for one or more food items 204 while in-transit to a destination.

At 1304, the method 1300 includes scheduling delivery of one or more food items 204 to meet a predicted amount of future supply need of food items 204 at a time in the future. The future supply need may be predicted based on demand factor information, as described herein. Then, at 1306, the amount of future supply need may be updated for the time in the future based on updated information, such as updated demand factor information (e.g., event information, economic indicators). To meet the updated predicted amount of future supply need of the food items 204, the method 1300 includes determining 1308 a revision to the scheduling of the delivery of the one or more food items 1308. The revision may be determined by the computational system 102 based on the updated predicted amount of future supply need. Finally, the method 1300 includes providing 1310 information regarding the revised schedule of delivery. The information may be provided over, e.g., the network 104 to the delivery vehicles 214 or the physical supply entities 206.

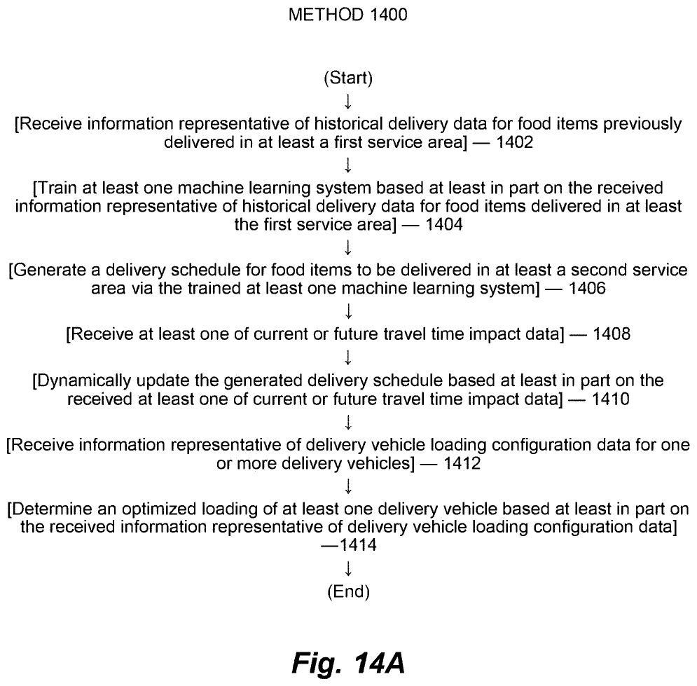

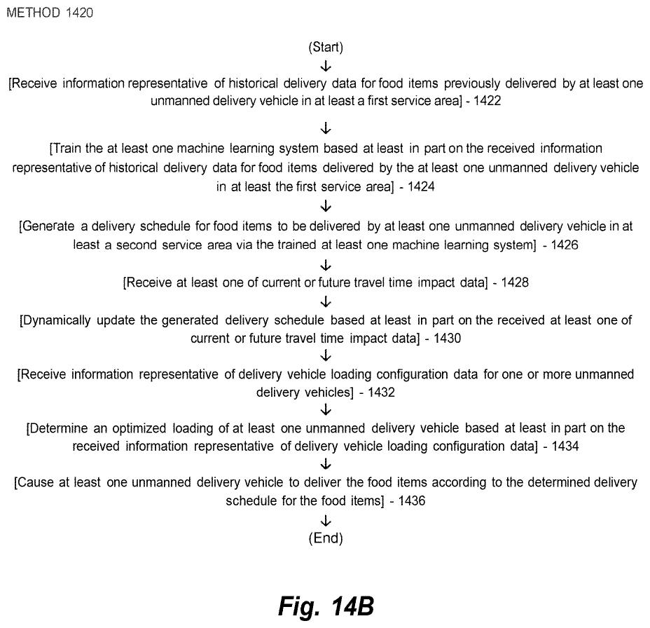

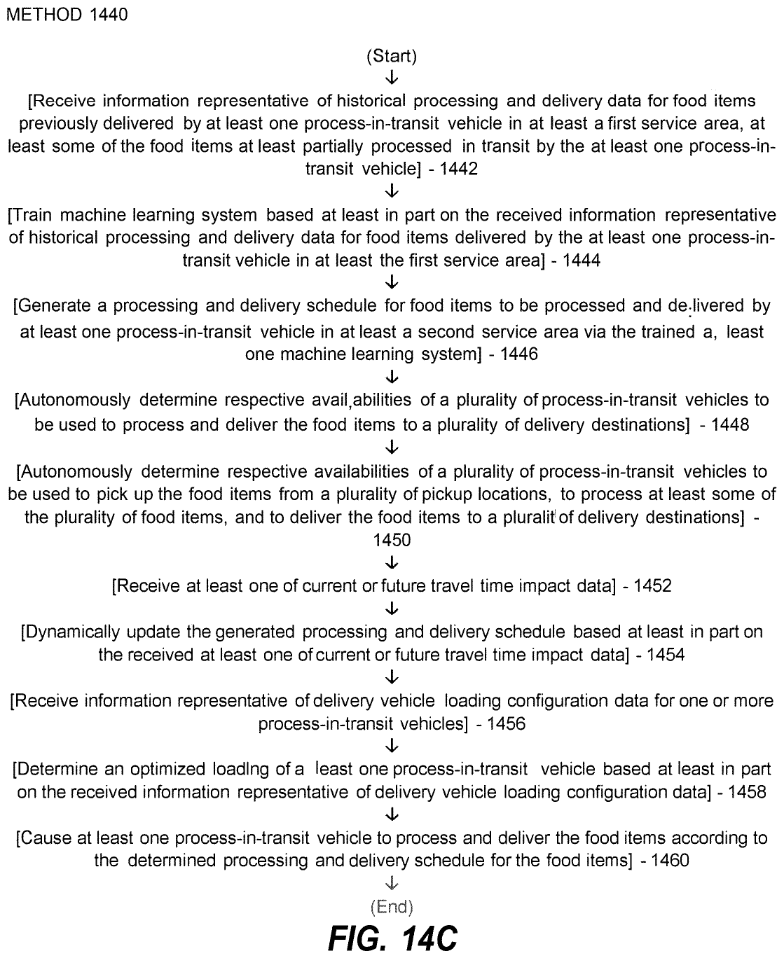

FIG. 14A shows a method 1400 of generating and updating a delivery schedule for one or more food items to meet short notice predictions of supply need according to one or more implementations. The method 1400 comprises receiving 1402 information representative of historical delivery data for food items previously delivered in at least a first service area. The historical delivery data received in 1402 may comprise delivery destination data indicative of a plurality of delivery destinations for the food items, pickup location data indicative of a plurality of pickup locations for the food items. The historical delivery data may be provided by the delivery vehicle 208 via the network 104 or provided from an entity associated with the delivery vehicle, such as a physical supply location 206 or ordering system 210. The historical delivery data for food items received in 1402 may include information representative of historical delivery data for at least one of prepared food items or ingredients for prepared food items.

At 1404, one or more machine learning system 106 are trained based at least in part on the received information representative of historical delivery data for food items delivered in at least the first service area. Training 1404 the one or more machine learning system 106 may include training at least one of a decision tree learning system, an artificial neural network system, a support vector machine system, a clustering system, or a Bayesian network system. The one or more machine learning system 106 may be trained 1404 according to techniques described in U.S. Provisional Patent Application No. 62/680,427.

The method 1400 further comprises generating 1406 a delivery schedule for food items to be delivered in at least a second service area via the trained at least one machine learning system 106. The delivery schedule may be generated in 1406 based at least in part on data received in 1402, such as historical travel time data described below. The method 1400 may include receiving 1408 at least one of current travel time impact data or future travel time impact data. Travel time impact data received in 1408 may comprise current or future traffic data regarding traffic in a service area. Traffic data may include data indicating traffic volume (e.g., number of motor vehicles), time delay for traffic, and indications of traffic congestion levels. Travel time impact data received in 1408 may comprise current of future weather data for a service area, such as temperature, meteorological forecasts, and chance of precipitation. The travel time impact data received in 1408 may also include current or future road construction data for a service area indicating current construction projects, road closures, traffic pattern modifications, and planned construction projects.

Generating 1406 the delivery schedule may include optimizing at least one route for at least one delivery vehicle 208 to travel to the plurality of delivery destinations, optimizing at least one route for at least one delivery vehicle 208 to travel to the plurality of pickup locations for obtaining food items 204 and/or ingredients 202, and/or optimizing at least one route for at least one delivery vehicle 208 to travel among the plurality of pickup locations and the plurality of delivery destinations. The delivery schedule generated may be based at least in part on the perishability of at least one of the food items 204, based at least in part on in what state the food items 204 are storable (e.g., frozen, liquid, temperature conditions, humidity conditions), and/or based at least in part on whether the food items are refrigerated when the food items 204 are located in a pickup location, a delivery destination, or a delivery vehicle 208. The delivery schedule generated in 1406 may also be for food items 204 that require processing based at least in part on in what state the food items 204 are storable before processing, for food items 204 that require processing based at least in part on in what state the food items 204 are storable after processing, for the food items 204 based at least in part on in what state food items 204 are storable before delivery, and/or for the food items 204 based at least in part on in what state food items 204 are storable after delivery. The delivery schedule generated may also be based at least in part on predicted perishability of food items 204 due to current or predicted weather conditions, storage conditions, or transport conditions related to the transporting vehicle.

At 1410, the method 1400 includes dynamically updating the delivery schedule generated in 1406 based at least in part on the current or future travel time impact data received in 1408. Dynamically updating 1410 the generated delivery schedule may include regrouping and/or reassigning delivery of orders for food items 204 to different delivery vehicles 208, modifying delivery routes 220, the order in which food items are delivered to different destinations. In situations where the delivery vehicles 208 are automated food production vehicles that prepare and/or cook food items 204 or ingredients 202 thereof, dynamically updating the delivery schedule may include adjusting a schedule for preparing and/or cooking the food items 204 or ingredients thereof based at least in part on the current or future travel time impact data.

The method 1400 may further include receiving 1412, by the computational system 102, information representative of delivery vehicle loading configuration data for one or more delivery vehicles 208. The delivery vehicle loading configuration data for a delivery vehicle 208 may indicate a configuration of equipment (e.g., ovens, heating devices robotics, food item storage) for automatically preparing and cooking food items or the ingredients thereof. For instance, the delivery vehicle loading configuration data may indicate a size, shape, and/or capabilities of a set of ovens in the delivery vehicle for cooking food items 204 in route to a delivery destination. In 1414, the method 1400 comprises determining, by the computational system 102, an optimized loading of at least one delivery vehicle based at least in part on the received information representative of delivery vehicle loading configuration data. Determining 1414 an optimized loading may include determining an optimized loading of at least one delivery vehicle 208 for a plurality of different locations along a route of the delivery vehicle 208, and the plurality of different locations comprise a plurality of delivery destinations, a plurality of pickup locations, or at least one pickup location and at least one delivery destination.

FIG. 14B shows a method 1420 of autonomous delivery of food items 204 based on a predicted supply need according to one or more implementations. The method 1420 begins by receiving 1422 information representative of historical delivery data for food items 204 previously delivered by at least one unmanned delivery vehicle, such as delivery vehicles 208, in at least a first service area. The historical delivery data may be data for at least one of prepared food items 204 or ingredients 202 for prepared food items 204. Receiving 1422 the information representative of historical delivery data may include receiving historical order data and historical transport data. The historical order data may comprise at least information associated with a plurality of historical orders for food items 204. The historical transport data may comprise at least information associated with a plurality of historical transports of the food items 204 to delivery destinations (e.g., customer delivery locations 208) via at least one delivery vehicle 208 that is unmanned. The historical transport data may include process-in-transit data, traffic data, weather data, road construction data, vehicle availability data, vehicle loading characteristics data, delivery route data, and/or delivery destination data. The process-in-transit data may include data representative of whether particular food items 204 can be processed in transit, an amount of time required to process particular food items 204 in transit, or a type of vehicle (e.g., configuration of equipment for cooking or preparing food items 204 and/or ingredients 202 thereof) required to process particular food items 204 in transit. Historical order data may include ingredients list data specifying ingredients 202 and amounts of respective ingredients 202 sufficient to prepare food items 204, perishability data, or storage requirements data regarding conditions for storing food items 204 and/or ingredients 202 thereof. The historical delivery data received may include historical travel time impact data and historical travel time data, which comprises at least one of traffic data, weather data, and road construction data. The historical delivery data may include delivery destination data indicative of a plurality of delivery destinations for the food items 204 and/or pickup location data indicative of a plurality of pickup locations for the food items 204.

The method 1420 further comprises training 1424 at least one machine learning system 106 based at least in part on the information representative of historical delivery data for food items 204 delivered by the at least one unmanned delivery vehicle 208 in at least the first service area. Training 1424 may comprise training at least one of a decision tree learning system, an artificial neural network system, a support vector machine system, a clustering system, or a Bayesian network system. The at least one machine learning system 106 may be trained 1424 according to techniques described in U.S. Provisional Patent Application No. 62/680,427, and as described herein.

Next, the method 1420 proceeds by generating 1426, by the computational system 102, a delivery schedule for food items to be delivered by at least one unmanned delivery vehicle 208 in at least a second service area via the trained at least one machine learning system 106. The delivery schedule generated is executable by at least one unmanned delivery vehicle 208 to deliver the food items 204. The delivery schedule may be for a defined period of time in the future. The generated delivery schedule may be for food items 204 to be delivered in the second service area, which at least partially overlaps with the first service area. Generating the delivery schedule for food items 305 may comprise optimizing at least one route for at least one unmanned delivery vehicle 208 to travel to a plurality of delivery destinations in at least the second service area to deliver food items 204, and may further comprise optimizing at least one route for at least one unmanned delivery vehicle 208 to travel to a plurality of pickup locations to pick up food items 204 and/or ingredients 202 thereof. Generating 1426 the delivery schedule may include optimizing at least one route for at least one unmanned delivery vehicle to travel among the plurality of pickup locations and the plurality of delivery destinations. The delivery schedule may be generated in 1426 may be based at least in part on the perishability of at least one of the food items 204, generated based at least in part on in what state the food items 204 are storable, and/or generated based at least in part on whether the food items 204 are refrigerated when the food items 204 are located in a pickup location, a delivery destination, or an unmanned delivery vehicle 208. For food items 204 refrigerated when the food items 204 are located in a pickup location, a delivery destination, or an unmanned delivery vehicle 208, the delivery schedule may be generated for food items 204 that require processing based at least in part on in what state the food items 204 are storable before processing or in what state the food items 204 are storable after processing. For the food items 204 refrigerated in such locations, the delivery schedule may be based at least in part on in what state food items 204 are storable before delivery or after delivery. In some implementations, the delivery schedule for food items 204 may be generated based at least in part on predicted perishability of the food items 204 due to weather conditions, storage conditions of a storage location, and/or transport conditions of a vehicle transporting the food items 204.

The method 1420 may further include receiving 1428 at least one of current or future travel time impact data. The current or future travel time impact data may respectively include current or future traffic data, current or future weather data, and/or current or future road construction data. Next, the method 1420 proceeds to dynamically update the generated delivery schedule based at least in part on the current or future travel time impact data received in 1428. Dynamically updating 1430 may refer to updating, in real-time, the generated delivery schedule before travelling to pick up or deliver food items 204 and/or ingredients 202, during loading of the unmanned delivery vehicle 208. In some implementations, dynamically updating 1430 may be performed while the unmanned delivery vehicle 208 is in route to another destination (e.g., pickup location, delivery destination) based on the travel time impact data received. As a result, the routes and/or scheduled delivery of the food items 204 may be updated while the unmanned delivery vehicle 208 is in transit.

The method 1420 may further comprise receiving 1432 information representative of delivery vehicle loading configuration data for one or more unmanned delivery vehicles 208. The unmanned delivery vehicle loading configuration data for an unmanned delivery vehicle 208 may indicate a configuration of equipment (e.g., ovens, heating devices robotics, food item storage) for automatically preparing and cooking food items 204 or the ingredients 202 thereof. For instance, the delivery vehicle loading configuration data may indicate a size, shape, and/or capabilities of a set of ovens in the delivery vehicle 208 for cooking food items 204 in route to a delivery destination. In 1434, the method 1420 includes determining an optimized loading of at least one unmanned delivery vehicle based at least in part on the received information representative of delivery vehicle loading configuration data. Determining 1434 may include determining an optimized loading of at least one unmanned delivery vehicle 208 for a plurality of different locations along a route of the unmanned delivery vehicle 208. The plurality of different locations may comprise a plurality of delivery destinations, a plurality of pickup locations, or at least one pickup location and at least one delivery destination.

The method 1420 concludes by causing 1436 at least one unmanned delivery vehicle 208 to deliver the food items according to the determined delivery schedule for the food items 204. For instance, the computational system 102 may cause at least one unmanned aerial vehicle to deliver one or more food items 204 and/or causing at least one unmanned ground vehicle to deliver one or more food items 204. In some implementations, the at least one delivery vehicle 208 may include an autonomously operated unmanned delivery vehicle such that the computational system 102 causes at least one autonomously operated unmanned delivery vehicle to deliver the food items 204. In some implementations, the at least one unmanned delivery vehicle 208 may a remote-controlled unmanned delivery vehicle to deliver the food items 204 such that the computational system 102 causes the at least one remote-controlled unmanned delivery vehicle to deliver the food items 204. The at least one autonomously operated unmanned delivery vehicle may, in some implementations, include at least one human rider therein that does not operate the movement of the unmanned delivery vehicle. Causing the at least one unmanned delivery vehicle 208 to deliver the food items 204 may comprise providing positional information to at least one autonomously operated unmanned delivery vehicle 208—for example, by causing a communication interface to transmit the positional information to be received by the unmanned delivery vehicle over a wireless communication interface.

FIG. 14C shows a method 1440 of scheduling delivery for food items 204 based on processing ingredients 202 in-transit according to one or more implementations. The method 1440 begins by receiving 1442, by the computational system 102, information representative of historical processing and delivery data for food items 204 previously delivered by at least one process-in-transit vehicle in at least a first service area. The received information in 1442 is for process-in-transit vehicles, which have equipment to cook and/or prepare food items 204 and/or ingredients 202 during transit. The information received in 1442 is for instances in which at least some of the food items 204 were at least partially processed in transit by the at least one process-in-transit vehicle. The information received in 1442 may include information indicating which of the food items 204 are capable of being at least partially processed in a process-in-transit vehicle during transit. Receiving 1442 the information may comprise receiving historical travel time impact data, historical order data including at least information associated with a plurality of historical orders for food items 204, historical processing data including at least information associated with in-transit processing of at least some of the food items 204, and/or historical transport data including at least information associated with a plurality of historical transports of the food items 204 to delivery destinations via at least one process-in-transit vehicle. Historical transport data may also comprise at least one of traffic data, weather data, road construction data, vehicle availability data, vehicle loading characteristics data, delivery route data, and/or delivery destination data. The information received at 1442 may further include historical travel time impact data comprising traffic data, weather data, and/or road construction data.

Receiving 1442 may include receiving information that indicates respective historical processing times required to process at least some of the food items 204 determined as capable of being at least partially processed during transit. The information received in 1442 may also include information that indicates processing equipment required to process at least some of the food items 204 and/or processing labor required to process at least some of the food items 204. The information received may further comprise information that indicates respective historical travel times required to deliver at least some of the food items 204 to delivery destinations. Receiving 1442 the information may further include receiving information that indicates overlapping processing and travel times for at least some of the food items 204. The information received at 1442 may include delivery destination data indicative of a plurality of delivery destinations for the food items 204 and/or pickup location data indicative of a plurality of pickup locations for the food items 204 or ingredients 202 thereof.

Next, the method 1440 proceeds by training 1444 at least one machine learning system 106 based at least in part on the information received at 1442 representative of historical processing and delivery data for food items 204 delivered by the at least one process-in-transit vehicle in at least the first service area. Training 1444 may include training at least one of a decision tree learning system, an artificial neural network system, a support vector machine system, a clustering system, or a Bayesian network system. The at least one machine learning system 106 may be trained 1444 according to techniques described in U.S. Provisional Patent Application No. 62/680,427, and as described herein.

The method 1440 includes generating 1446 a processing and delivery schedule for food items 204 to be processed and delivered by at least one process-in-transit vehicle 208 in at least a second service area via the at least one machine learning system 106 trained at 1444. The processing and delivery schedule generated at 1446 is executable by at least one process-in-transit vehicle to process and deliver the food items 204. The processing and delivery schedule for the food items 204 to be processed and delivered in at least the second service area, which at least partially overlaps with the first service area. The processing and delivery schedule may be generated based on information received at 1442—for instance, the processing and delivery schedule may be generated based at least in part on historical travel time impact data. Generating 1446 the processing and delivery schedule may include optimizing at least one route for at least one process-in-transit vehicle to travel to the plurality of delivery destinations, optimizing at least one route for at least one process-in-transit vehicle to travel to the plurality of pickup locations, or generating the processing and delivery schedule for food items comprises optimizing at least one route for at least one process-in-transit vehicle to travel among the plurality of pickup locations and the plurality of delivery destinations. The processing and delivery schedule generated at 1446 may be for food items 204 that require processing based at least in part on what state the food items 204 are storable in before processing or after processing, or based at least in part on what state food items are storable in before delivery or after delivery.

The method 1440 may also include autonomously determining 1448 respective availabilities of a plurality of process-in-transit vehicles to be used to process and deliver the food items 204 to a plurality of delivery destinations. The method 1440 may further include autonomously determining 1450 respective availabilities of a plurality of process-in-transit vehicles to be used to pick up the food items 204 from a plurality of pickup locations, to process at least some of the plurality of food items 204, and to deliver the processed food items 204 to a plurality of delivery destinations.

The method 1440 may also comprise receiving 1452, by the computational system 102, at least one of current or future travel time impact data. Receiving 1452 the at least one of current or future travel time impact data may comprise receiving at least one of current or future traffic data, current or future weather data, or current or future road construction data. Then, the method 1440 may include dynamically updating 1454, by the computational system 102, the generated delivery schedule based at least in part on the current or future travel time impact data received in 1454. Dynamically updating 1454 may refer to updating, in real-time, the generated delivery schedule before travelling to pick up or deliver food items 204 and/or ingredients 202, during loading of the delivery vehicle 208. In some implementations, dynamically updating 1454 may be performed while the delivery vehicle 208 is in route to another destination (e.g., pickup location, delivery destination) based on the travel time impact data received. As a result, the routes and/or scheduled delivery of the food items 204 may be updated while the delivery vehicle 208 is in transit.

The method 1440 may include receiving 1456, by the computational system 102, information representative of delivery vehicle loading configuration data for one or more process-in-transit vehicles. The delivery vehicle loading configuration data for an process-in-transit delivery vehicle 208 may indicate a configuration of equipment (e.g., appliances, ovens, heating devices robotics, food item storage) for automatically preparing and cooking food items 204 or the ingredients 202 thereof. For instance, the delivery vehicle loading configuration data may indicate a size, shape, and/or capabilities of a set of ovens in the delivery vehicle 208 for cooking food items 204 in route to a delivery destination. In 1458, the method 1440 includes determining an optimized loading of at least one process-in-transit delivery vehicle based at least in part on the received information representative of delivery vehicle loading configuration data. Determining 1458 may include determining an optimized loading of at least one process-in-transit delivery vehicle 208 for a plurality of different locations along a route of the process-in-transit delivery vehicle 208. The plurality of different locations may comprise a plurality of delivery destinations, a plurality of pickup locations, or at least one pickup location and at least one delivery destination.

The method 1440 concludes by causing 1460, by the computational system, at least one process-in-transit vehicle to process and deliver the food items 204 according to the determined processing and delivery schedule for the food items 204. Causing 1460 the at least one process-in-transit vehicle to process and deliver the food items 204 may include causing at least one unmanned process-in-transit vehicle to process and deliver the food items 204 and/or causing at least one human operated process-in-transit vehicle to process and deliver the food items 204. Causing 1460 the at least one process-in-transit vehicle to process and deliver the food items 204 may comprise causing at least one autonomously operated process-in-transit vehicle to process and deliver the food items 204, and/or causing at least one remote-controlled process-in-transit vehicle to process and deliver the food items 204. An autonomously operated process-in-transit vehicle processing and delivering the food items 204 may include at least one human rider therein that does not operate the movement of the process-in-transit vehicle.

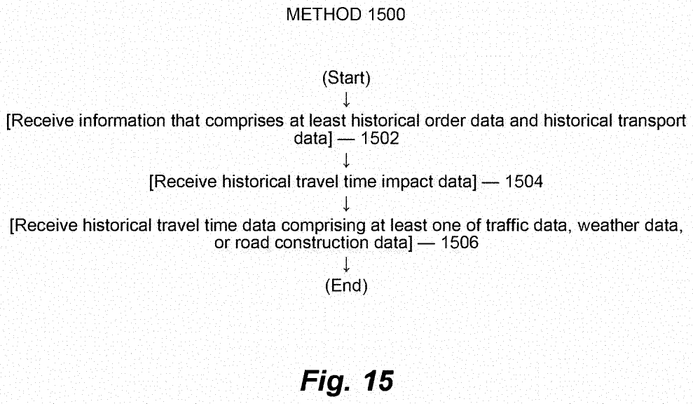

FIG. 15 shows a method 1500 of receiving information representative of historical delivery data for food items previously delivered in at least a first service area. The method 1500 may be performed, in part or in whole, as part of receiving 1402 described above with respect to the method 1400. The method 1500 comprises receiving 1502 information that comprises at least one of historical order data and historical transport data. Historical order data is data comprising at least information associated with a plurality of historical orders for food items 204, and the historical transport data is data comprising at least information associated with a plurality of historical transports of the food items to delivery destinations (e.g., customer delivery locations 218). The historical transport data, for instance, may comprise at least one of process-in-transit data, traffic data, weather data, road construction data, vehicle availability data, vehicle loading characteristics data, delivery route data, or delivery destination data. Process-in-transit data may include data representative of whether particular food items 204 can be processed in transit, an amount of time required to process particular food items 204 in transit, or a type of vehicle (e.g., automated processing delivery vehicle) required to process particular food items 204 in transit. The historical order data received in 1502 may comprise at least one of ingredients list data, perishability data, or storage requirements data. The ingredients list data may specify types and/or amounts of ingredients 202 sufficient to prepare respective ones of the food items 204. The perishability data may specify amounts of time for which the ingredients 202 and/or food items 204 are acceptable for use, or times and/or dates at which the ingredients 202 and/or food items 204 are no longer acceptable for use. Storage requirements data may specify minimum and/or maximum conditions (e.g., temperature, humidity, space) acceptable for storing specific ones of the ingredients 202 and/or food items 204. The method 1500 may include receiving 1504 information representative of historical travel time impact data. The method 1500 may further include receiving 1506 historical travel time data, which may comprise at least one of traffic data, weather data, or road construction data.

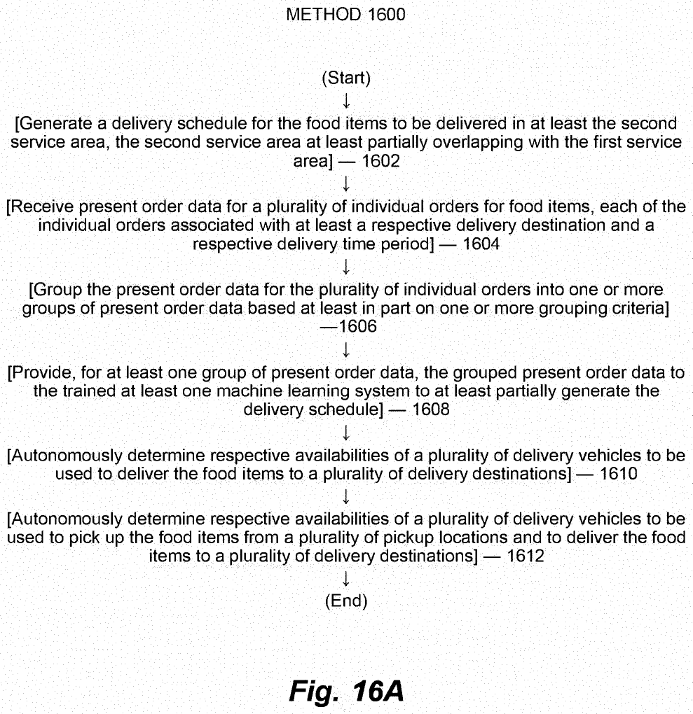

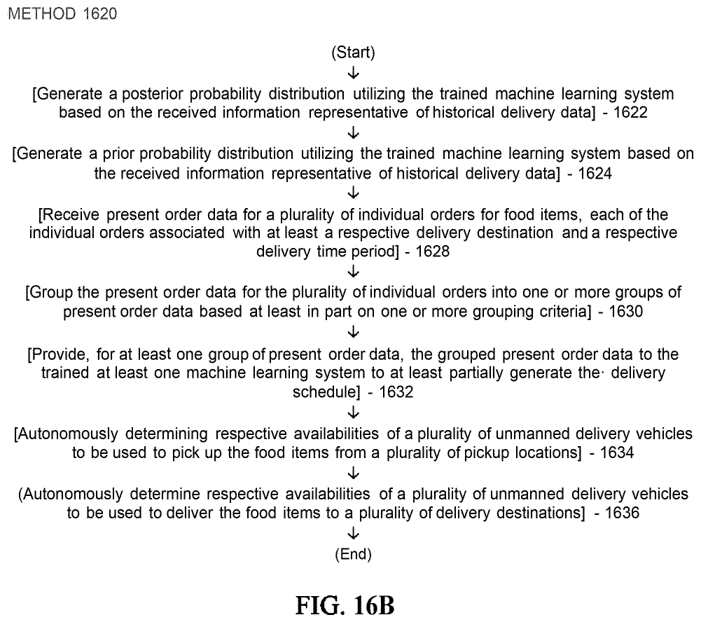

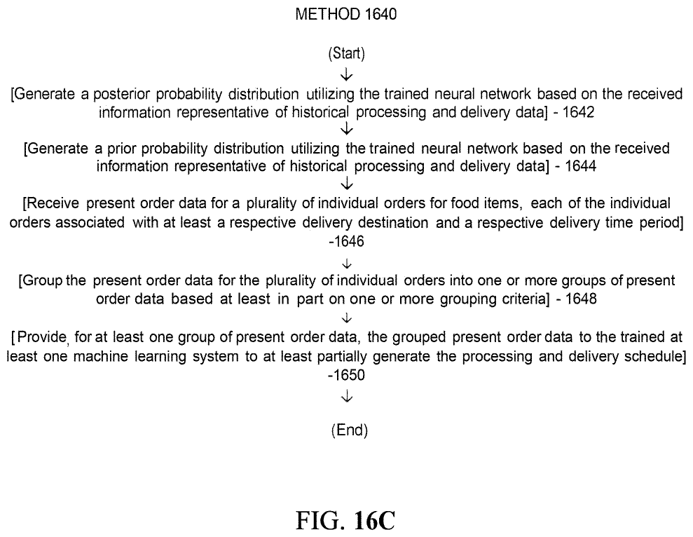

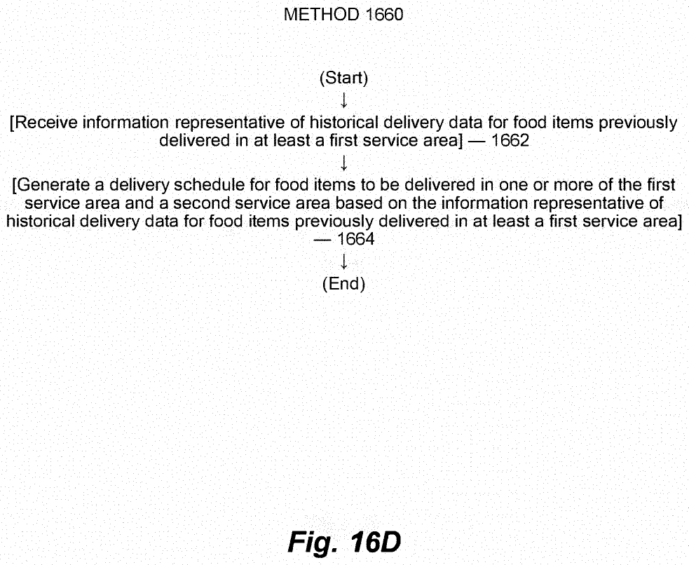

FIG. 16A shows a method 1600 of generating a delivery schedule for the food items 204. The method 1600 may be performed, in part or in whole, as part of generating 1406 a delivery schedule for the food items described above with respect to the method 1400. The method 1600 comprises generating 1602 a delivery schedule for the food items to be delivered in at least the second service area, the second service area at least partially overlapping with the first service area. The second service area, for instance, may include a geographical region that is included in the first service area.

The method 1600 may also include receiving 1604 present order data for a plurality of individual orders for food items 204. Each of the individual orders for food items 204 in 1604 may be associated with at least a respective delivery destination, such as the customer delivery location 218, and a respective delivery time period in which the respective food items 204 should be delivered. Next, the method 1600 proceeds by grouping 1606 the present order data for the plurality of individual orders into one or more groups of present order data based at least in part on one or more grouping criteria. Grouping the present order data may include grouping individual orders together based at least in part on a similarity of delivery time periods for the individual orders, and/or grouping individual orders together based at least in part on a similarity of ingredients 202 for the individual orders.

Then, the method 1600 includes providing 1608, for at least one group of present order data, the grouped present order data to the trained at least one machine learning system 106 to at least partially generate the delivery schedule. The method 1600 may comprise autonomously determining 1610 respective availabilities of a plurality of delivery vehicles 208 to be used to deliver the food items 204 to a plurality of delivery destinations, such as customer delivery locations 218. The method may also comprise autonomously determining 1612 respective availabilities of a plurality of delivery vehicles 208 to be used to pick up the food items 204 from a plurality of pickup locations, such as physical sale locations 206 or a location at least partially preparing and/or cooking the food items 204, and to deliver the food items 204 to a plurality of delivery destinations.

FIG. 16B shows a method 1620 of generating a delivery schedule for food items 204 to be delivered by at least one unmanned delivery vehicle in at least one second service area via the at least one machine learning system 106 trained in 504. The method 1620 may include generating 1622 a posterior probability distribution utilizing the trained machine learning system 106 based on the information representative of historical delivery data received in 502. The method 1620 may further include generating 1624 a prior probability distribution utilizing the trained machine learning system 106 based on the received information representative of historical delivery data.

The method 1620 may comprise receiving 1628, by the computational system 102, present order data for a plurality of individual orders for food items 204, each of the individual orders associated with at least a respective delivery destination and a respective delivery time period for the respective food items 204. The method 1620 may further comprise grouping the present order data for the plurality of individual orders into one or more groups of present order data based at least in part on one or more grouping criteria. Grouping 1630 may include grouping individual orders together based at least in part on a similarity of delivery time periods for the individual orders for food items 204 and/or grouping individual orders together based at least in part on a similarity of ingredients 202 for the individual orders for food items 204. Next, the method may comprise providing 1632, for at least one group of present order data, the grouped present order data to the trained at least one machine learning system 106 to at least partially generate the delivery schedule.

At 1634, the method 1620 may include autonomously determining respective availabilities of a plurality of unmanned delivery vehicles 208 to be used to deliver the food items 204 to a plurality of delivery destinations. The method 1620 may also include determining 1636 respective availabilities of a plurality of unmanned delivery vehicles 208 to be used to deliver the food items to a plurality of delivery destinations. The availability of the unmanned delivery vehicles 208 for delivery and/or pickup may be determined by referencing one or more schedules stored in memory for the corresponding unmanned delivery vehicles 208.

FIG. 16C shows a method 1640 of generating a processing and delivery schedule for food items 204 to be processed and delivered by at least one process-in-transit vehicle 208 in at least a second service area via the at least one machine learning system 106. The method 1640 may be performed by the computational system 102 in concert or via the trained machine learning system 106. The method 1640 may be performed at least as part of generating 1436 the processing and delivery schedule described above with respect to method 1430. The method 1640 includes generating 1642 a posterior probability distribution utilizing the trained machine learning system 106 based on the received information representative of historical processing and delivery data. The method 1640 may further include generating 1644 a prior probability distribution utilizing the trained machine learning system 106 based on the received information representative of historical processing and delivery data.

The method 1640 may comprise receiving 1646, by the computational system 102, present order data for a plurality of individual orders for food items 204, each of the individual orders associated with at least a respective delivery destination and a respective delivery time period. The method 1640 may also comprise grouping 1648, by the computational system 102, the present order data for the plurality of individual orders into one or more groups of present order data based at least in part on one or more grouping criteria. Grouping 1648 may be performed based at least in part on a similarity of delivery time periods for the individual orders, a similarity of ingredients 202 for the individual orders, and/or a similarity of processing requirements for the individual orders. Then, the method 1640 may comprise providing 1650, for at least one group of present order data, by the computational system 102, the grouped present order data to the trained at least one machine learning system 106 to at least partially generate the processing and delivery schedule.

FIG. 16D is a method of generating a delivery schedule for the food items according to another embodiment. The method 1660 may be performed as a part of or in association with the other methods described herein. The method 1660 may be performed by one or more appropriate entities described herein, such as the computational system 102. Performance of the method 1660 described may also involve aspects the environment 400A and 400B described above with respect to FIGS. 4A and 4B. At 1662, the method 1660 may comprise receiving information representative of historical delivery data for food items previously delivered in at least a first service area. At 1664, the method 1660 may comprise generating a delivery schedule for food items to be delivered in one or more of the first service area and a second service area based on the information representative of historical delivery data for food items previously delivered in at least a first service area.

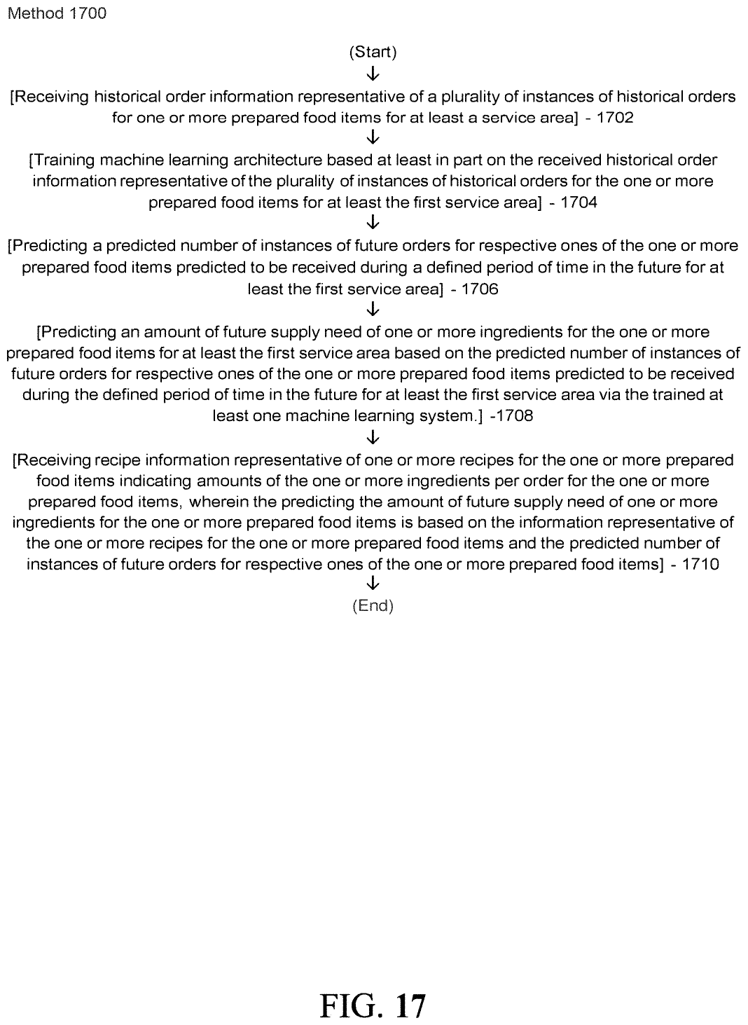

FIG. 17 shows a method 1700 of predicting a number of instances of future orders for respective ones of the one or more prepared food items 204 predicted to be received during a defined period of time in the future for at least the service area, according to one or more implementations. At 1702, the method 1700 begins by receiving historical order information 708 representative of a plurality of instances of historical orders for one or more prepared food items 204 for at least a service area. The historical order information 708 may be received or otherwise obtained, for instance, over the network 104 by the computational system 102. Receiving the historical order information 708 may include receiving information that specifies total number of instances of orders for the one or more prepared food items 204 either placed or fulfilled during a defined period of time in the past for at least the service area. Receiving the historical order information may include receiving information that, for each respective type of prepared food item 204 of a number of types of prepared food items 204, specifies a respective total number of instances of orders for the respective type of prepared food item 204 either placed or fulfilled during the defined period of time in the past for at least the service area. The received historical order information 708 may be information representative of orders received in or for fulfillment in a defined period of time in the past. The historical order information 708 may be specific to a service area in which fulfillment of the orders for food items 204 is at least partially fulfilled.

At 1704, the method 1700 may comprise training the at least one machine learning system 106 based at least in part on the received historical order information 708. The machine learning system 106 may be trained by the computational system 102 according to one or more models for supervised machine learning, one or more models for unsupervised machine learning, or one or more models for semi-supervised machine learning. In some implementations, regression machine learning models may be used to train the machine learning system 106 to provide a numerical value based on new data. In some implementations, classification machine learning models may be used to train the machine learning system to provide a classification (e.g., binary classification, multi-modal classification) based on new data. The machine learning system 106 may be trained according to one or more of a decision tree learning system, an artificial neural network system, a support vector machine system, a clustering system, and a Bayesian network system, by way of non-limiting example. Training the machine learning system 106 may include generating a new set of executable instructions or modifying an existing set of instructions, e.g., of the computational system 102 or the machine learning system 106. Training 1704 the machine learning system 106 may include training using historical information that further represents one or more various factors attributed to affecting, predicting or being related to demand for the prepared food items 204. The historical information may correspond to demand factor information stored in the demand information data store 224 as described herein. The historical information may include information regarding, for example, a particular time of day, a particular time of week, a particular time of month, a particular time of year; a particular day of week, a particular day of month, a particular day of year, a particular week of month, particular week of year, a particular month of year, a particular event, a particular holiday, a concert, a festival, a particular recurring event, a particular recurring sporting event, a particular recurring community event, a particular season, one or more economic indicators, retail sales, employment and labor market statistics, current stage of economic cycle, personal income, demographics, home prices and/or sales, Gross Domestic Product (GDP), Money Supply (M2), Consumer Price Index (CPI), Producer Price Index (PPI) and Consumer Confidence Survey, one or more factors specific to the service area, one or more factors attributed to affecting or predicting demand specifically in the service area. Such historical information may be correlated with the information representative of historical order information 708 representative of the instances of historical orders for one or more prepared food items 204 for the service area. For instance, information regarding orders for food items 204 placed in a single day in the past for fulfillment in the service area may be associated in memory with information regarding a sporting event or concert that also occurred that day around the time the orders were placed for fulfillment in the service area. As a result, the machine learning system 106 may be trained to predict a number of instances of future orders for respective ones of the one or more prepared food items 204 predicted to be received during a defined period of time in the future for at least the service area.

At 1706, a number of instances of future orders for respective ones of the one or more food items 204 is predicted via the machine learning system 106 for the service area. Predicting future orders for respective ones of the food items 204 involves receiving, as input, current information, such as the current demand information 416 described herein, indicative of one or more conditions in, around, or pertaining to a particular service area. The current information may be information representing various factors attributed to affecting, predicting, or being related to demand for prepared food items 204 in the service area. Such information may represent factors including, for example, one or more of a particular time of day, a particular time of week, a particular time of month, a particular time of year; a particular day of week, a particular day of month, a particular day of year, a particular week of month, particular week of year, a particular month of year, a particular event, a particular holiday, a concert, a festival, a particular recurring event, a particular recurring sporting event, a particular recurring community event, a particular season, one or more economic indicators, retail sales, employment and labor market statistics, current stage of economic cycle, personal income, demographics, home prices and/or sales, Gross Domestic Product (GDP), Money Supply (M2), Consumer Price Index (CPI), Producer Price Index (PPI) and Consumer Confidence Survey, one or more factors specific to the service area, one or more factors attributed to affecting or predicting demand specifically in the service area. Based on the current information (e.g., representing one or more of the demand factors in the service area), the computing system 102 or the machine learning system 106 predicts a number of instances of future orders for respective ones of the food items 204 predicted to be received during a defined period of time. For example, using current demand information, the computing system 102 may generate a set of values corresponding to numbers of orders for food items 204 that are predicted to be received at a future defined time period. The computing system 102 may also receive, as input, a defined period of time in the future for which a prediction is to be made.

The method 1700 may further comprise predicting 1708 an amount of future supply need 418 of one or more ingredients 202 for the one or more prepared food items 204 for at least the service area based on the predicted number of instances of future orders for respective ones of the one or more prepared food items 204 predicted to be received during the defined period of time in the future for at least the service area via the trained machine learning system 106. Predicting the future supply need 418 may include obtaining or receiving 1710 recipe information representative of one or more recipes for the one or more prepared food items 204. Such recipe information may be obtained from the recipe data storage 718 indicate amounts of the one or more ingredients 202 per order for the one or more prepared food items 204. The recipe information may be used in predicting the future supply need 418 for the one or more prepared food items 204. For instance, the computational system 102 may calculate, for each of the type of food item 204, the number of instances of orders for the respective food items 204 by amounts of the respective ingredients 202 indicated in the recipe information to obtain amounts of each ingredient 202 sufficient to fulfill the predicted number of instances of future orders for food items 204. Then, the computational system 102 may aggregate, for each ingredient 202, the amounts calculated as being sufficient to fulfill the predicted future orders for the food items 204 evaluated.

The amount of future supply need 418 may be predicted for a defined time in the future that is associated with a condition related to a past condition for the service area based on the historical order information 708. In some implementations, for example, the amount of future supply need 418 may be predicted for a future event (e.g., marketing activity or public or private event) related to a past particular event for the service area based on the historical order information 708. In particular, the method 1700 may include receiving historical order information 708 for a defined period of time in the past that is associated with a past event for the service area. The past particular event may correspond to one or more of a particular time of day, a particular time of week, a particular time of month, a particular time of year; a particular day of week, a particular day of month, a particular day of year, a particular week of month, particular week of year, a particular month of year, a particular holiday, a concert, a festival, a sporting event, a particular community event, a particular season, an event specific to the service area, a marketing activity specific to one or more particular menu items, an introduction of a new menu item, a marketing activity regarding a promotional sale, or a marketing activity regarding a promotional event. The past particular event may be one that is recurring event, such as a holiday occurring on a particular day every year or a sporting event that occurs once weekly between certain calendar days of the year. In such implementations, the historical order information 708 received may be representative of a plurality of instances of historical orders for one or more prepared food items 204 either placed or fulfilled during a defined period of time in the past associated with the past particular marketing activity or event for at least the service area that is a geographic region comprising a plurality of food services establishments supplied by a logistics provider or commissary.

Also in such implementations, training 1704 the machine learning system 106 may be based on the on the received historical order information 708 representative of the plurality of instances of historical orders for the one or more prepared food items 204 either placed or fulfilled during the defined period of time in the past associated with the particular marketing activity or event for at least the service area. For instance, the historical order information 708 used to training the machine learning system 106 may be for orders placed or fulfilled during a sporting event in the past, or over a period of time, such as an entire season for a particular sport. The historical information used to train 1704 the machine learning system 106 may include information representing additional factors attributed to affecting, predicting or being related to demand for the one or more prepared food items. The additional factors may be economic indicators, government policy, weather, or other factors.

In such implementations, predicting 1706 the future supply need 418 may be for a defined period of time in the future associated with a future particular event that is related to the past particular marketing event. For instance, the computing system 102 may (via the trained machine learning system 106) predict the future supply need 418 for a future time at which a festival is scheduled to occur wherein the machine learning system 106 was trained using historical order information 708 for a defined past period of time in which a festival occurred. The event may be the same or a similar event, such as the same or similar festival previously occurring in the service area. Training the machine learning system 106 based on historical order information 708 for past time periods having certain conditions or characteristics (e.g., recurring festival, sporting events for a particular team located in the service area) enables the accurate and precise prediction of future supply need 418 for future time periods having similar conditions or events, and thus facilitates a short supply chain in which there is a close correlation between the amount of ingredient 202 supplied and the amount of ingredient 202 consumed in connection with the conditions or characteristics. As a result, appropriate amounts of the ingredients 202 are planted, grown, and harvested at the appropriate time so that those amounts can be transported from the farm and delivered to the service area to meet the supply need for the marketing event or activity.

As another example according to some implementations, an amount of future supply need 418 of one or more ingredients 202 may be predicted for a defined period of time in the future based on an updated economic indicator related to at least one of the one or more one or more economic indicators correlated to received historical information related to use of the one or more ingredients 202 for the service area. In particular, the method 1700 may include training 1704 the machine learning system 106 using data representing one or more economic indicators regarding the defined period of time in the past for at least the service area. The data may represent one or more economic indicators regarding one or more of retail sales associated with the defined period of time in the past, employment and labor market statistics associated with the defined period of time in the past, stage of economic cycle associated with the defined period of time in the past, personal income associated with the defined period of time in the past, home sales and/or prices increasing or decreasing, Gross Domestic Product (GDP) associated with the defined period of time in the past, Money Supply (M2) associated with the defined period of time in the past, Consumer Price Index (CPI) associated with the defined period of time in the past, Producer Price Index (PPI) associated with the defined period of time in the past and Consumer Confidence Survey results associated with the defined period of time in the past. Training may include correlating the historical information related to use of the one or more ingredients 202 with one or more of the economic indicators—for example, training data provided to the machine learning system 106 may include historical ingredient use information correlated with employment statistics for the service area during the same time period. Correlation may correspond to the association of different types of information in the training data, such as an association in memory or a logical association of similar temporal and spatial relationship of two different types of information in the training data. Training 1704 may include providing training data including historical information that further represents one or more various additional factors attributed to affecting, predicting or being related to demand for the one or more prepared food items 204.

Training 1704 may, in some implementations, include performing supervised machine learning based on the received historical ingredient use information 402 related to use of one or more ingredients and the data representing one or more economic indicators. As one example, instances of historical ingredient use information 402 and data representing one or more economic indicators are respectively labeled, e.g., with alphanumeric strings. The machine learning system 106 may be trained to generate a model correlating labeled data representing one or more economic indicators with corresponding labeled data representing historical ingredient use information 402. The machine learning system 106 may then receive data including labeled data representing one or more economic indicators for which corresponding known labelled data representing historical ingredient use information 402 is used to refine or correct the model. Supervised machine learning algorithms used in such training may include logistic regression models, decision tree learning models, and support vector machine models.

Training 1704 may, in some implementations, include performing unsupervised machine learning based on the received historical ingredient use information 402 and the data representing one or more economic indicators. In unsupervised learning, the machine learning system 106 may receive unlabeled historical ingredient use information 402 and the data representing one or more economic indicators from which the machine learning system 106 may synthesize a structure, rules, algorithm, etc. for determining a future supply need 418 given the data representing one or more economic indicators as input. Such training may involve recognizing underlying patterns indicating correlations between the received historical ingredient use information 402 and the data representing one or more economic indicators. For instance, the machine learning system 106 may be trained to recognize patterns, such as logical associations or statistical likelihoods, that a value for a historical ingredient use information 402 will occur given a value for data representing one or more economic indicators, or vice versa. Methods for training the machine learning system 106 using unsupervised learning include clustering models (e.g., k-means clustering, probabilistic clustering, hierarchical clustering), Bayesian network systems, artificial neural networks, self-organizing maps, etc.

In some implementations, training 1704 may include performing semi-supervised machine learning based on the received historical ingredient use information 402 and the data representing one or more economic indicators. In such semi-supervised learning, the input provided to train the machine learning system 106 may comprise both labeled and unlabeled data. Training comprises, in some implementations, recognizing underlying patterns indicating correlations between the received historical ingredient use information 402 and the data representing one or more economic indicators. Training the machine learning system 106 may be involve training to identify latent variables that indicate how the data representing one or more economic indicators is related to the historical ingredient use information 402. For instance a statistical model may be implemented to relate a set of observable variables (i.e., variables that can be directly measured) to a set of unobserved variables that are not yet identified. Such latent variable identification may involve statistical analysis performed as part of the training process that identify latent factors or characteristics likely to affect the use of ingredients 202, as well as implementing models (e.g., expectation-maximization algorithm) for finding the maximum likelihood of estimates of parameters useable in generating predictive information.

Machine learning optimization processes may be performed as part of the training 1704 to refine, modify, or correct the model or output generated as a result of training the machine learning system 106 by, e.g., reducing error between successive iterations of the model or output. Predicting 1708 an amount of future supply need 418 of one or more ingredients may be based on generating a posterior probability distribution utilizing the trained machine learning system 106 based on the received historical ingredient use information 402 and data representative of updated economic indicators, generating a prior probability distribution utilizing the trained machine learning system 106 based on the received historical ingredient use information 402 and data representative of an updated economic indicator, and/or performing a classification of one or more pieces of the historical ingredient use information 402 utilizing the trained machine learning system 106.

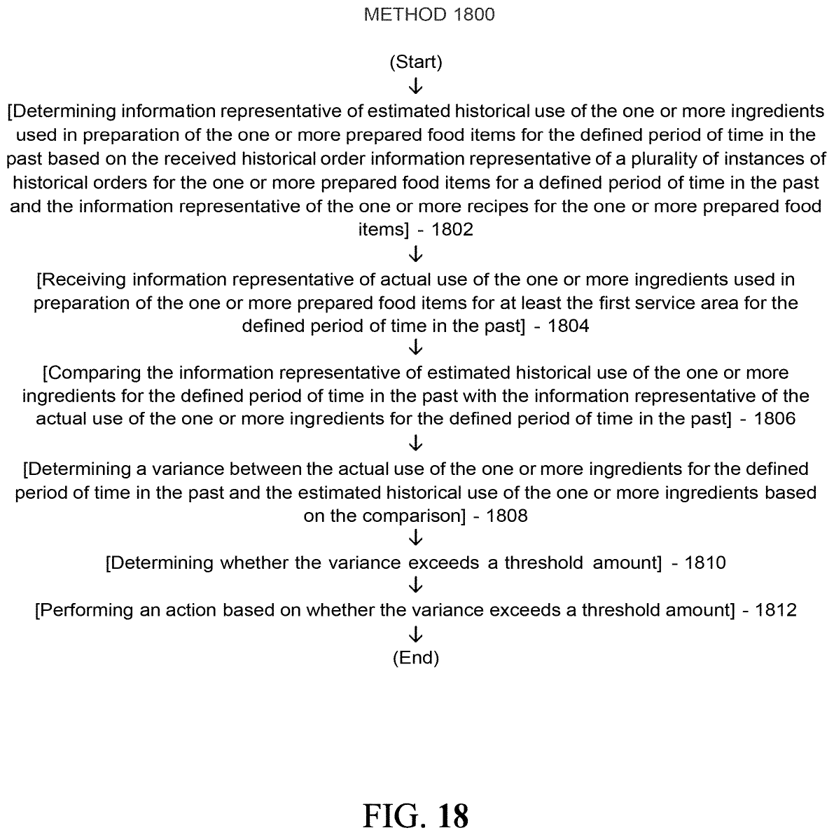

FIG. 18 shows a method 1800 involving determining a variance between an estimated historical ingredient usage and actual historical ingredient usage according to one or more implementations. The method 1800 may be performed as a part of, in addition to, the other methods described herein. Description of the method 1800 involves aspects of at least the environment 700 described above with respect to FIGS. 7A and 7B.

The method 1800 begins by determining 1802 information representative of estimated historical use of the one or more ingredients 202 used in preparation of the one or more prepared food items 204 for a defined period of time in the past. Determining 1802 may involve using the historical order information 708 representative of a plurality of instances of historical orders for the one or more prepared food items 204 for the defined period of time in the past and recipe information for the one or more prepared food items 204. For example, the estimated historical use 722 of the one or more ingredients 202 may be determined by at least multiplying, for each food item 204 evaluated for the defined period of time in the service area, the amount of ingredient 202 specified in the recipe information for each order unit of the food item 204 being evaluated by the number of instances of food items 204 indicated as being ordered in the historical order information 708. The estimated historical use 722 may include numeric values representative of the estimated use of a set of ingredients 202, and may include classifiers indicating the type of ingredient 202 to which each value corresponds.

At 1804, the method 1800 involves receiving information representative of the actual use of the one or more ingredients 202 used in preparation of the one or more prepared food items 204 for at least the service area for the defined period of time in the past. Such information corresponds to the actual historical ingredient use 724 described above and may be obtained from the historical use data store 302 described herein. The actual historical ingredient use 724 may include numeric values representative of the actual use of a set of ingredients 202, as reported or otherwise determined from the ingredient using entities (e.g., physical supply entities 206) and may include classifiers indicating the type of ingredient 202 to which each value corresponds. The actual historical ingredient use 724 may be based on information representative of instances of orders for one or more food items 204 either placed or fulfilled for the one or more ingredients 202 for use during the defined period of time in the past.

Next, the method 1800 involves comparing 1806 the estimated 20 historical ingredient use information 722 with the actual historical ingredient use information 724. For instance, a value in the estimated historical ingredient use information 724 corresponding to one of the ingredients 202 may be the compared to a corresponding value in the actual historical ingredient use information 722, for the defined period of time in the past. The method 1800 further involves determining 1808, based at least on a result of the comparison 1806, a variance between the actual use of the one or more ingredients 202 for the defined period of time in the past and the estimated historical use of the one or more ingredients 202. The variance may indicate a numerical difference between the values, for individual ones of the ingredients 202, indicated in the estimated historical ingredient use information 722 and the actual historical ingredient use information 724. Determining 1808 the variance may include, in some instances, a determination that the actual use of the one or more ingredients 202 for the defined period of time in the past exceeds the estimated historical use of the one or more ingredients 202 for the defined period of time in the past over the threshold amount. In other instances, determining 1808 may result in a determination that the estimated historical use of the one or more ingredients 202 for the defined period of time in the past exceeds the actual use of the one or more ingredients 202 for the defined period of time in the past.

The method 1800 then proceeds to determine 1810 whether the variance exceeds a threshold amount. The threshold amount is a numerical value for an ingredient 202 that, if exceeded, indicates anomalous or abnormal actual usage of the ingredient 202 relative to the estimated usage. There may be a different threshold value for different ingredients 202 taking into account different units of measurement of the ingredients (e.g., quantity versus volume) or different acceptable levels of usage. Moreover, there may be different thresholds based on a determination of whether the actual ingredient usage exceeds the estimated ingredient usage or vice versa. The threshold value or threshold values may be stored in data storage accessible by the computational system 102 and may be set by an authorized entity (e.g., supervisor) for the service area.

Based on a determination that the variance exceeds the threshold amount, the method 1800 may further involve performing 1812 one or more actions. The action performed may be based on whether the actual use of the one or more ingredients 202 exceeds the estimated use of the ingredients 202 for one or more food items 204 or, conversely, whether the estimated use of the one or more ingredients 202 exceeds the actual use of the ingredients 202 for one or more food items 204. The action may include communicating an indication regarding the condition determined or predicting a future supply need. As one example, based on a determination that actual use exceeds historical use, performing 1812 the action may include communicating an indication that possible waste of ingredients 202 has occurred over the defined period of time in the past. As another example, based on a determination that actual use exceeds historical use, performing 1812 the action may include a communication indicating that possible significant divergence from the one or more recipes for the one or more prepared food items 204 has occurred over the defined period of time in the past. As yet a further example, based on a determination that estimated use exceeds actual use, performing 1812 the action may include communicating an indication of possible significant divergence from the one or more recipes for the one or more prepared food items 204 has occurred over the defined period of time in the past. These respective communications may be sent to the corresponding entity to which the variance is attributed, such as the physical sale location 206, or an appropriate entity charged with supervising ingredient efficiency or quality in connection with production of the food items 204, such as a supervisor. Performing the action may include, based on a determination that the variance exceeds a threshold amount, predicting an amount of future supply need 418 of one or more ingredients 202 for the one or more prepared food items 204 for at least the service area for a defined period of time following the defined period of time in the past, as described herein.

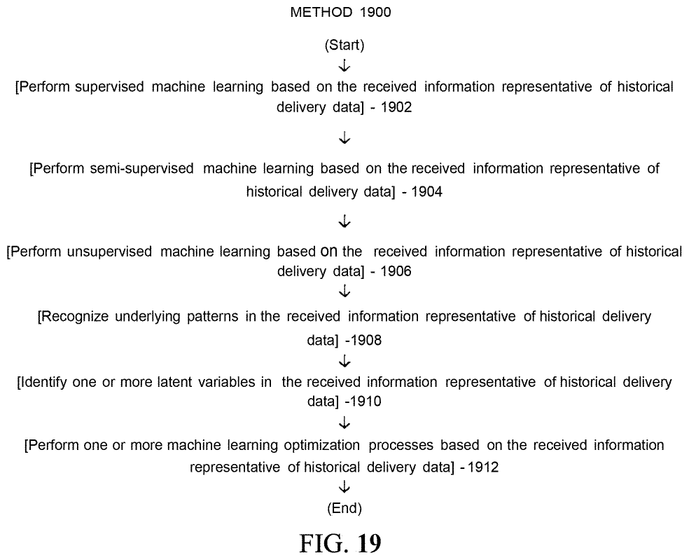

FIG. 19 shows a method 1900 of training at least one machine learning system 106 according to one or more implementations. The method 1900 is performed as part of training the at least one machine learning system 106 described. The method 1900 may include performing 1902 supervised machine learning based on the information representative of historical delivery data received in operation 1402 in FIG. 14A, for example. The method 1900 may also include performing 1904 semi-supervised machine learning based on the information representative of historical delivery data. The method 1900 may further include performing 1906 unsupervised machine learning based on the information representative of historical delivery data. The method 1900 may comprise training the machine learning system 106 to recognize 1908 underlying patterns in the information representative of historical delivery data, identify 1910 one or more latent variables in the information representative of historical delivery data, and/or perform 1912 one or more machine learning optimization processes based on the information representative of historical delivery data. Training at least one machine learning system 106 according to the method 1900 may include some or all of the operations described with respect to the method 1900. Training may also include other methods, operations, or techniques described herein.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. The headings and Abstract of the Disclosure provided herein are for convenience only and do not interpret the scope or meaning of the embodiments.

As used herein the terms “food item” and “food product” refer to any item or product intended for human consumption. One of ordinary skill in the culinary arts and food preparation will readily appreciate the broad applicability of the systems, methods, and apparatuses described herein across any number of prepared food items or products, including cooked and uncooked food items or products, and ingredients or components of food items and products. In some instances, well-known structures associated with computing systems including client and server computing systems, machine learnings, machine learning systems, as well as networks, including various types of telecommunications networks, have not been shown or described in detail to avoid unnecessarily obscuring descriptions of the embodiments. Examples of food items, as referred to herein, include entrees, pizzas, appetizers, hors d'oeuvre, antipasti, deserts, candy, confectionary items, pastries, side dishes, soups, pasta, salads, salad bar items, sandwiches, a particular course of a multi-course meal, breakfast items, brunch items, lunch items, happy hour menu items, dinner items, late night menu items, main course items, beverages, alcohol, wine, beer, liquor, cocktails, soft drinks, coffee, tea, buffet items, combination meals, vegetarian dishes, meat dishes, fish dishes, chicken dishes, pork dishes, roasts, gluten free dishes, organic dishes, vegan dishes, animal product dishes, dietary needs dishes, special order items, menu items, off-menu items, substitution items, customized menu items, customized meals, catered items, build-your-own pizzas, build-your-own menu items, build-your-own meals, take-out items, promotional items, specials, coupon items and pre-packaged items.

As used herein the term “vehicle” refers to any car, truck, van, or other vehicle useful in preparing a food item and/or for distribution to a customer. The size and shape of the vehicle may depend in part on licensing requirements of the locality in which the vehicle is intended to operate. In some instances, the size and shape of the vehicle may depend on the street layout and the surrounding environment of the locality in which the vehicle is intended to operate. For example, small, tight city streets may require a vehicle that is comparatively shorter and/or narrower than a vehicle that can safely and conveniently navigate larger, suburban thoroughfares.

As used herein the term “service area” refers to a physical area in which food items are provided or made available to consumers. The physical area is defined as a region in which physical sale locations (e.g., stores, vending machines, kiosks) are located and delivery vehicles provide or make available food items. The region may be defined, for example, by physical boundaries (e.g., streets, rivers); postal codes; provincial, county, or local government organization; or combinations thereof. The service area is a geographic region comprising a plurality of food services establishments supplied by a logistics provider or commissary. A service area represents an area serviced or defined by one or more of logistics suppliers, processors, trucking companies, shipping companies, wholesalers, resellers, supply chains managers, producers, farms, agricultural cooperatives, plantations, agricultural areas, markets, sales regions, distributors, retailers, importers, exporters, restaurants, restaurant chains, commissaries, grocery stores, co-ops, farmers markets, snack stands, concession stands, food trucks, food carts, vending kiosks, locker kiosks, hot dog carts, pop-up restaurants, supper clubs, temporary restaurants, venues, festivals, concerts, neighborhoods, boroughs, camps, community centers, cities, towns, counties, states, commonwealths, provinces, parishes, municipalities, districts, regions, countries and governments.

The order of operations described above with respect to each of the above methods may be adjusted such that some operations may be performed in a different order with respect to other operations than described above. In some implementations, the methods or certain steps within the methods may be performed without performing machine learning or implanting artificial intelligence.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation of a computational system that implements at least one machine learning system to facilitate logistics, the method comprising:
receiving, by the computational system, historical order information representative of a plurality of instances of historical orders for one or more prepared food items either placed or fulfilled during a defined period of time in the past associated with a past particular event for at least a first service area;
training the at least one machine learning system based at least in part on the received historical order information representative of the plurality of instances of historical orders for the one or more prepared food items either placed or fulfilled during the defined period of time in the past associated with the particular event for at least the first service area; and
for one or more of the one or more prepared food items, predicting, via the trained at least one machine learning system of the computational system, an amount of future supply need of one or more ingredients for the one or more prepared food items for a defined period of time in the future associated with a future particular event related to the past particular event for at least the first service area based on the historical order information.

2. The method of claim 1 further comprising receiving, by the computational system, information representative of one or more recipes for the one or more prepared food items indicating amounts of the one or more ingredients per order for the one or more prepared food items, wherein the predicting the amount of future supply need of one or more ingredients for the one or more prepared food items includes predicting the amount of future supply need of one or more ingredients for the one or more prepared food items based on the information representative of the one or more recipes for the one or more prepared food items and a predicted number of instances of future orders for respective ones of the one or more prepared food items.

3. The method of claim 2 further comprising:
determining, by the computational system, information representative of estimated historical use of the one or more ingredients used in preparation of the one or more prepared food items for the defined period of time in the past based on the received historical order information representative of a plurality of instances of historical orders for the one or more prepared food items for the defined period of time in the past and the information representative of the one or more recipes for the one or more prepared food items;
receiving, by the computational system, information representative of actual use of the one or more ingredients used in preparation of the one or more prepared food items for at least the first service area for the defined period of time in the past;
comparing, by the computational system, the information representative of estimated historical use of the one or more ingredients for the defined period of time in the past with the information representative of the actual use of the one or more ingredients for the defined period of time in the past;
determining, by the computational system, a variance between the actual use of the one or more ingredients for the defined period of time in the past and the estimated historical use of the one or more ingredients based on the comparison; and
performing an action, by the computational system, based on whether the variance exceeds a threshold amount.

4. The method of claim 3 wherein the performing an action based on whether the variance exceeds a threshold amount includes:
determining, by the computational system, that the actual use of the one or more ingredients for the defined period of time in the past exceeds the estimated historical use of the one or more ingredients for the defined period of time in the past over the threshold amount; and
communicating, by the computational system, an indication that possible waste of ingredients has occurred over the defined period of time in the past based on the determination that the actual use of the one or more ingredients for the defined period of time in the past exceeds the estimated historical use of the one or more ingredients for the defined period of time in the past over the threshold amount.

5. The method of claim 3 wherein the performing an action based on whether the variance exceeds a threshold amount includes:
determining, by the computational system, that the actual use of the one or more ingredients for the defined period of time in the past exceeds the estimated historical use of the one or more ingredients for the defined period of time in the past over the threshold amount; and
communicating, by the computational system, an indication of possible significant divergence from the one or more recipes for the one or more prepared food items has occurred over the defined period of time in the past based on the determination that the actual use of the one or more ingredients for the defined period of time in the past exceeds the estimated historical use of the one or more ingredients for the defined period of time in the past over the threshold amount.

6. The method of claim 3 wherein the performing an action based on whether the variance exceeds a threshold amount includes:
determining, by the computational system, that the estimated historical use of the one or more ingredients for the defined period of time in the past exceeds the actual use of the one or more ingredients for the defined period of time in the past over the threshold amount; and
communicating, by the computational system, an indication of possible significant divergence from the one or more recipes for the one or more prepared food items has occurred over the defined period of time in the past based on the determination that the estimated historical use of the one or more ingredients for the defined period of time in the past exceeds the actual use of the one or more ingredients for the defined period of time in the past over the threshold amount.

7. The method of claim 1 further comprising planting or harvesting one or more crops to generate one or more ingredients for the one or more prepared food items based on the predicted amount of future supply need of the one or more ingredients for the one or more prepared food items for the defined period of time in the future associated with the future particular event for at least the first service area.

8. The method of claim 1 further comprising loading one or more vehicles with one or more ingredients for the one or more prepared food items based on the predicted amount of future supply need of the one or more ingredients for the one or more prepared food items for the defined period of time in the future associated with the future particular event for at least the first service area.

9. The method of claim 1 further comprising determining by the computational system, one or more delivery routes of one or more vehicles loaded with one or more ingredients for the one or more prepared food items based on the predicted amount of future supply need of the one or more ingredients for the one or more prepared food items for the defined period of time in the future associated with the future particular event for at least the first service area.

10. The method of claim 1 further comprising:
pre-processing one or more ingredients for the one or more prepared food items based on the predicted amount of future supply need of the one or more ingredients for the one or more prepared food items for the defined period of time in the future associated with the future particular event for at least the first service area; and
delivering the pre-processed one or more ingredients to one or more locations providing the one or more prepared food items in the first service area based on the predicted amount of future supply need of the one or more ingredients for the one or more prepared food items for the defined period of time in the future associated with the future particular event for at least the first service area.

11. The method of claim 1 further comprising pre-processing one or more ingredients for the one or more prepared food items while in-transit to one or more locations providing the one or more prepared food items in the first service area based on the predicted amount of future supply need of the one or more ingredients for the one or more prepared food items for the defined period of time in the future associated with the future particular event for at least the first service area.

12. A computational system that implements at least one machine learning system to facilitate logistics, the system comprising one or more processors and memory storing a set of instructions that, as a result of execution by the one or more processors, cause the system to:
receive historical order information representative of a plurality of instances of historical orders for one or more prepared food items either placed or fulfilled during a defined period of time in the past associated with a past particular event for at least a first service area;
train the at least one machine learning system based at least in part on:
the received historical order information representative of the plurality of instances of historical orders for the one or more prepared food items either placed or fulfilled during the defined period of time in the past associated with the particular event for at least the first service area; and
data representing one or more economic indicators regarding the defined period of time in the past for at least the first service area;
for one or more of the one or more prepared food items, predict, via the trained at least one machine learning system of the computational system, an amount of future supply need of one or more ingredients for the one or more prepared food items for a defined period of time in the future associated with a future particular event related to the past particular event for at least the first service area based on the historical order information; and.
scheduling, by the computational system, the production, from planting to delivery, of the one or more ingredients for the one or more prepared food items based on information indicative of the amount of time that production takes, from planting to delivery, of one or more ingredients for the one or more prepared food items and the amount of future supply need of the one or more ingredients for the one or more prepared food items for the defined period of time in the future.

13. (canceled)

14. A method of operation of a computational system that implements at least one machine learning system to facilitate logistics, the method comprising:
receiving, by the computational system, historical information related to use of one or more ingredients used in preparation of one or more prepared food items for a defined period of time in the past for at least a first service area;
training the at least one machine learning system based at least in part on the received historical information related to use of one or more ingredients used in preparation of the one or more prepared food items during the defined period of time in the past and data representing one or more economic indicators regarding the defined period of time in the past for at least the first service area; and
for one or more of the one or more prepared food items, predicting, via the trained at least one machine learning system of the computational system, an amount of future supply need of one or more ingredients for the one or more prepared food items for a defined period of time in the future based on an updated economic indicator related to at least one of the one or more one or more economic indicators correlated to the received historical information related to use of the one or more ingredients for at least the first service area.

15. The method of claim 14 wherein the predicting the amount of future supply need includes:
predicting, via the trained at least one machine learning system of the computational system, a number of instances of future orders for respective ones of the one or more prepared food items to be received during the defined period of time in the future based on an updated economic indicator related to the at least one of the one or more one or more economic indicators, the at least one of the one or more one or more economic indicators correlated to the received historical information related to use of the one or more ingredients for at least the first service area; and
predicting an amount of future supply need of one or more ingredients for the one or more prepared food items for the defined period of time in the future based on the predicted number of instances of future orders for respective ones of the one or more prepared food items.

16. The method of claim 14 wherein the training the at least one machine learning system includes at least one of:
performing supervised machine learning based on the received historical information related to use of one or more ingredients and the data representing one or more economic indicators;
performing semi-supervised machine learning based on the received historical information related to use of one or more ingredients and the data representing one or more economic indicators;
performing unsupervised machine learning based on the received historical information related to use of one or more ingredients and the data representing one or more economic indicators;
recognizing underlying patterns in the received historical information related to use of one or more ingredients and the data representing one or more economic indicators, the underlying patterns indicating correlations between the received historical information related to use of one or more ingredients and the data representing one or more economic indicators;
identifying one or more latent variables that indicate how the data representing one or more economic indicators is related to the received historical information related to use of one or more ingredients; and
performing one or more machine learning optimization processes based on the received historical information related to use of one or more ingredients and the data representing one or more economic indicators.

17. The method of claim 14 wherein the predicting the amount of future supply need of one or more ingredients for the one or more prepared food items includes predicting the amount of future supply need of one or more ingredients for the one or more prepared food items for a defined period of time in the future based on at least one of:
generating a posterior probability distribution utilizing the trained at least one machine learning system based on the received historical information related to use of one or more ingredients and the updated economic indicator;
generating a prior probability distribution utilizing the trained machine learning system based on the received historical information related to use of one or more ingredients and the updated economic indicator; and
performing a classification of one or more pieces of the historical information related to use of the one or more ingredients utilizing the trained machine learning system.

18. A method of operation of a computational system that implements at least one machine learning system to facilitate logistics, the method comprising:
receiving, by the computational system, information indicative of an amount of time that production takes, from planting to delivery, of one or more ingredients for one or more prepared food items for at least a first service area;
for one or more of the one or more prepared food items, predicting, via the at least one machine learning system of the computational system, an amount of future supply need of the one or more ingredients for the one or more prepared food items for a defined period of time in the future for at least the first service area based on historical information related to use of one or more ingredients; and
scheduling, by the computational system, the production, from planting to delivery, of the one or more ingredients for the one or more prepared food items based on the information indicative of the amount of time that production takes, from planting to delivery, of one or more ingredients for the one or more prepared food items and the amount of future supply need of the one or more ingredients for the one or more prepared food items for the defined period of time in the future.

19. The method of claim 18 further comprising determining, by the computational system, the amount of time that production takes, from planting to delivery, of the one or more ingredients for the one or more prepared food items.

20. The method of claim 18 further comprising determining, by the computational system, an amount of time indicative of how far in advance the amount of future supply need of the one or more ingredients for the one or more prepared food items should be predicted to deliver the predicted amount of the one or more ingredients to meet the predicted future supply need of the one or more ingredients based on the amount of time that production takes, from planting to delivery, of the one or more ingredients for one or more prepared food items, wherein the predicting the amount of future supply need of the one or more ingredients is performed at a time based on the determined amount of time indicative of how far in advance the amount of future supply need of the one or more ingredients for the one or more prepared food items should be predicted.

21. The method of claim 20 wherein the determining the amount of time indicative of how far in advance the amount of future supply need of the one or more ingredients should be predicted includes determining the amount of time production takes based on one or more controlled factors related to growth of one or more plants that supply the one or more ingredients, the one or more controlled factors related to one or more of: amount of oxygen, amount of carbon dioxide, amount of water, type of watering system, amount of nutrients, concentration of nutrients, nutrient pH level, how nutrients are delivered, amount of light intensity, spectrum of light; intervals of light, amount of humidity, amount of fertilizers, temperature, and amount of ventilation.

22-52. (canceled)
